(19) United States
(12) Patent Application Publication
(10) Pub. No.: US 2016/0232603 A1
(43) Pub. Date: Aug. 11, 2016

(54) RATIONING RULES AND BIDDING FORMATS FOR AN EFFICIENT AUCTION DESIGN

(71) Applicants: Pär O. Holmberg, Uppsala (SE); Lawrence M. Ausubel, Washington, DC (US); David M. Newbery, Cambridge (GB); Daniel Ralph, Cambridge (GB)

(72) Inventors: Pär O. Holmberg, Uppsala (SE); Lawrence M. Ausubel, Washington, DC (US); David M. Newbery, Cambridge (GB); Daniel Ralph, Cambridge (GB)

(21) Appl. No.: 14/619,065

(22) Filed: Feb. 10, 2015

(51) Int. Cl. G06Q 30/08

(52) U.S. Cl. CPC G06Q 30/08

(57) ABSTRACT

One aspect of our invention is a new class of rationing rules with disproportionate rationing that motivates bidders to submit more competitive bids. A second aspect of our invention is that competitiveness of bids can be further improved if the rationing rule is different for different price levels. A third aspect is that a bidding format that controls the shape of bids can improve competitiveness of bids, especially when combined with a suitable rationing rule. A fourth aspect is that competitiveness of bids can be further improved if the bidding format and/or rationing rule is automatically updated with regard to new auction relevant information before the auction starts or during the auction process. A fifth aspect is that perceived fairness can be improved if the rationing rule considers the size of bidders. Several aspects of our invention can be combined in an exemplary design. Some aspects of our invention can also be applied to single-object auctions. Aspects of our invention can be implemented in computer systems.

### CROSS-REFERENCE TO RELATED APPLICATIONS

This application claims the benefit of the following provisional patent applications: “Rationing rule, bidding format and system for an efficient auction design” (Application No. 61/938,223; filed Feb. 11, 2014), “Rationing rules, bidding formats and systems for an efficient auction design” (Application No. 61/984,113; filed Apr. 25, 2014).

### BACKGROUND

In the background we give examples of various types of auctions and exchanges that aspects of our invention could be applied to. We also introduce terminology that is relevant when describing aspects of our invention.

An auction is the process of trading a good or goods in accordance with a set of trading rules. The auction is conducted by an auctioneer. A “bidder” is a buyer and/or seller, different from the auctioneer, that is interested in buying and/or selling good(s) traded in the auction. A “bid” is an instruction submitted by a bidder of how much it wants to trade under different circumstances. The bid normally indicates transaction price(s) acceptable to the bidder and often transaction quantity(s) acceptable to the bidder at specified transaction prices. More specifically, an auction is a process where one or more bidders inform the auctioneer of their willingness to buy or sell a good or goods by making bids, and where an auctioneer then allocates the traded good or goods according to some rule that takes the bids into account.

Normally an auction would have a bidding format (which regulates when and what type of bids can be submitted), an allocation rule (which determines which bids are accepted), and a pricing rule (which determines transaction prices for accepted bids). An order-driven market is an example of an exchange that normally has all of these three properties.

In this specification and claims we use the term auction in a general sense; it applies to any trading mechanism where at least one bidder makes bids and where trading is regulated by at least one of the following rules: bidding format, allocation rule and pricing rule. In particular, unless otherwise stated, the term auction includes all trading mechanisms that we discuss in this specification, related auctions, exchanges and trading platforms.

As in economics, we use the term “good” in a general sense in this specification; it could be anything (including services, financial instruments etc.) that provides utility or value to some potential buyer. Goods can be tangible or intangible. Examples of tangible goods traded in auctions are art, property, houses, animals and land. Examples of intangible goods are instruments, such as securities, currencies, intellectual property, insurance contracts, hybrid instruments (e.g. warrants and convertible bonds), derivatives, gambling contracts and emission permits. Auctions are important in e-commerce and business to business markets. The public sector and industry often procure services, subcontracting, machinery, components, material and construction projects in auctions. The auctioneer sells one or more goods and bidders submit bids to buy in sales auctions; also called forward auctions or buyer bidding auction. The auctioneer buys one or more goods and bidders submit bids to sell in procurement auctions, also called reverse auctions or supplier bidding auctions. Procurement auctions and sales auctions are one-sided, i.e. bids are coming from either sellers or buyers, not both. In double auctions, such as stock exchanges, derivative exchanges and commodity exchanges, both buyers and sellers are bidders that submit bids to the auction. Further background on double auctions is for example provided by Nymyer in U.S. Pat. No. 3,581,072 and by Molloy in U.S. Pat. No. 7,792,723. The latter focuses on a synthetic double auction that connects sales and procurement auctions by the actions of bidders. “A survey of the world's top stock exchanges' trading mechanisms and suggestions to the Shanghai Stock Exchange” by Gu (2005) provides details of how double auctions can be arranged.

To keep the presentation general we often use the terms “trade” or “transact” instead of “sell” or “buy”. A single-object auction trades an indivisible good, such as a piece of art or a house. A divisible-good auction trades a divisible, homogenous (or fungible) good. Similarly, a multi-unit auction trades a number of units of a good, such as a commodity, financial contract or security (including treasury and corporate bond, bill, note and stock). In the specification and claims, we use a general definition of the multi-unit auction, which encompasses all auctions that trades a plurality of units of at least one good or fractions of at least one good. Thus divisible-good auctions are included in our definition of a multi-unit auction. Sometimes a plurality of heterogeneous (differentiated) goods is traded in the same auction, and bidders bid to buy or sell combinations (packages) of such goods. Such auctions are called combinatorial or package auctions. Combinatorial auctions can for example be used to allocate rights for entry capacity, exit capacity and transmission capacity in gas pipeline systems or electric power networks. Other examples are communication licenses, telecommunications spectrum, financial instruments, transportation routes, network routes, communication routes, tickets for different seats or occasions, landing and takeoff slots at airports, commodities with different qualities, or sponsored search slots on the web. Combinatorial auctions of the latter type are sometimes called position auctions. Power exchanges often clear a large geographical area and several delivery periods at the same time. Thus power exchanges are combinatorial auctions in that electricity in one location at one point of time is a different good to electricity in another location and/or at another point of time. Goods could be regarded as being heterogeneous even if they only have minor differences, such as terms of payment, quality of the good, currency of payment, delivery times, location of the good, transport cost etc. But sometimes an auction could also treat goods with minor differences as being homogenous. This is for example the case in zonal electricity markets, where electricity production inside a large region is treated as being homogenous. A detailed background of combinatorial auctions and more detailed examples of such auctions are provided in the following patents: U.S. Pat. No. 8,447,662 by Ausubel; U.S. Pat. No. 8,335,738 by Ausubel, Cramton and Milgrom; U.S. Pat. No. 6,026,383 by Ausubel; U.S. Pat. No. 7,792,723 by Molloy; U.S. Pat. No. 6,272,473 by Sandholm; U.S. Pat. No. 7,010,511 by Kinney et al.

To keep our discussion as general as possible in the specification, we use the term “item” to denote a good or a package of different goods. In the latter case, an item would represent a particular mix of goods. For each type of mix with the same percentage of each good we define a unique item with a quantity that has been normalized to one. An item could for example be a package consisting of two apples, three pears, one banana and half a coconut. A package consisting of four apples, six pears, two bananas and one coconut would then correspond to two units of this particular item. In some auctions with heterogeneous goods, one may want to define a quantity index with a weight for each good. An item would then be any package with the quantity index one.

We allow the number of units to be a non-integer number. In our presentation, we also use the terms “quantity” and “volume”. Both of these terms have essentially the same meaning as “number of units” in our presentation.

As in the auction literature, we use the term “single object” or “single item” to denote an indivisible good, which cannot be divided between bidders. In single object auctions, each bid normally consists of a single bid price. But in multi-unit auctions each bid often consists of a transaction schedule with price-quantity pairs, where the bid quantity of a price-quantity pair informs the auctioneer of how many units of an item the bidder is willing to trade at the bid price of the price-quantity pair. The price is normally a unit price (price per unit of an item). Normally the price would be expressed in some monetary unit (currency unit), such as dollar, euro, pound, peso, or rupee, or in terms of a currency index. The price could also be expressed in a digital currency or virtual currency, such as bitcoin or an in-game currency, or another medium of exchange, such as gold, other commodities or a financial instrument. Sometimes we use the term “bid” to denote a subset of the price-quantity pairs in a transaction schedule. A bid could also be a buy or sell order in a financial exchange, or other information that expresses the preferences of the bidder for an item or items in terms of prices and/or quantities. We use the term “bid” both for sellers and buyers. Sometimes we also use “bid” as a verb instead of writing “make a bid” or “submit a bid”.

Some financial exchanges have liquidity providers, such as market makers, dealers or specialists, which often submit both buy and sell bids to an exchange or double auction. A liquidity provider could be considered to be one of the bidders. Sometimes there are liquidity providers that are approved by the exchange and that have special deals with the exchange. Such designated liquidity providers could for example be granted various informational and trade execution advantages, but also obligations. As an example, specialists are responsible for conducting the opening auctions in the New York stock exchange. Depending on the type of deal with the exchange, such a designated liquidity provider can either be regarded as a bidder or being part of the auctioneer in our specification and claims. Thus an auctioneer could potentially consist of a plurality of agents that help with the operation of the auction. Some or all of the agents that help with the operation of the auction could be automatic processes. Similarly, a corporation (such as a business entity or company) may have several employees or other representatives that are authorized to submit bids independently in the name of the same corporation. In such cases, a corporation could be considered to have a plurality of bidders, but normally bids submitted in the name of the same corporation are considered to be submitted by the same bidder in this specification. In case a broker submits a bid to an auction on behalf of a client, we would normally consider the broker to be the bidder in the auction, but depending on the rules of the auction it may sometimes be more appropriate to designate the client as the bidder. We use the general term “trader” to include both “bidder” and “auctioneer”, in case the auctioneer is trying to sell a good (e.g. in a sales auction) or buy a good (e.g. in a procurement auction). We do not rule out that the term “bidders” (plural form) could represent a single bidder (singular). Similarly, “traders” could sometimes represent a single bidder and “traders” could sometimes represent a single auctioneer.

### Bidding Rounds

In standard sealed-bid auctions, also called static auctions, bidders in one single bidding round—independently submit bids to the auctioneer, who then determines the auction outcome. Static auctions offer the advantage of speed in the operation of the auction. This arrangement is often used in auctions that are repeated frequently or when one or more related items are traded continuously, so that bidders can fairly accurately predict the clearing price of the auction. This is for example the case for power exchanges, treasury security auctions and frequent batch auctions that normally are static auctions, but there are exceptions.

In ascending-hid auctions, hid prices start at or near a suggested opening bid, which is a favorable price for bidders, and then the bid price gets less attractive to bidders, i.e. further away from the opening bid, as the number of bidding round increases. Thus, bidders tend to drop out of an ascending-bid auction or reduce their hid quantities as the number of bidding rounds increases. Bid prices are ascending in an ascending-bid sales auction, but bid prices would be descending in a corresponding procurement auction. The popular English auction is an open outcry ascending bid auction, which is often used to trade single objects.

Ascending bid auctions and similar formats offer the advantage that the auctioneer can choose to give some feedback to bidders about competitors' bids, which helps bidders to better evaluate the value or cost of traded (one or more) items and to predict the clearing price. This price discovery process tends to result in more socially efficient auction outcomes, i.e. a more optimal allocation of traded one or more units among the auctioneer and bidders. Thus one or more units sold to bidders are to a larger extent assigned to bidders that value them most, and one or more units bought from bidders are to a larger extent bought from bidders that have the lowest cost of providing them. However, as discussed by Klemperer (2004) in his book “Auctions: Theory and Practice”, feedback about competitors' bids can also increase the risk for collusion among bidders, which could result in less efficient auction outcomes. Moreover, financial markets move fast and should preferably be cleared in an instant. In such cases there is less time for ascending bid auctions.

An ascending-bid auction is one example of a dynamic auction. There are also other dynamic auctions, where bidders iteratively submit bids until no more bids are forthcoming or until no more bids are accepted by the auctioneer. Another example of a dynamic auction is an exchange with continuous bidding, where new bids are continuously received and cleared. A dynamic auction could take a break, for example during lunch, overnight, during the week-end, or during a holiday or holidays. A dynamic auction could end before the break, and bidders that want to keep uncleared bids active may have to resubmit them in a new auction after the break, or the auction could just take a pause and then continue after the break. Some exchanges with continuous bidding opens and/or closes with an auction, where submitted bids clear at one point of time. In financial markets, such auctions are often referred to as call markets. U.S. Pat. No. 7,792,723 by Molloy discusses advantages and disadvantages with sealed bids and dynamic auctions in greater detail. Frequent batch auctions and continuous trading are compared and discussed further in “The High-Frequency Trading Arms Race: Frequent Batch Auctions as a Market Design Response” by Budish, Cramton and Shim (2013).

In a dynamic auction with a discrete bidding round structure, each bidder is often given the opportunity to submit a bid during a predetermined time interval for each round. But in a dynamic auction with continuous bidding, such as in an open outcry auction or a financial exchange, one could say that a bidding round ends as soon as the first bid has been submitted during the round (all bidders are normally welcome to make bids in the next round). The auction is normally cleared after the final bidding round. But in some cases, such as in some financial exchanges and other cases discussed in U.S. Pat. No. 6,026,383 by Ausubel, the auctioneer may also want to clear or partly clear an auction, even if the auction will continue with additional bidding rounds afterwards. Exchanges with continuous bidding normally try to clear every time a new bid is submitted. We do not rule out that a dynamic auction with continuous bidding can receive a plurality of (two or more) bids during the same bidding round. This could for example occur if a plurality of bids were submitted simultaneously (exactly or almost exactly at the same time) to the auction. Some auctions with continuous trading could be regarded as auctions with a discrete bidding round structure, for which the time interval per bidding period is very short, less than a couple of seconds. U.S. Pat. No. 8,335,738 by Ausubel, Cramton and Milgrom discusses advantages and disadvantages with using a discrete bidding round structure and continuous bidding in dynamic auctions.

An auctioneer may also run a sequence of similar auctions, which are cleared at different points of time. When it makes sense from the context in this specification and claims, we consider such auctions to be part of the same auction process provided that they trade the same type of item(s), except that transaction, settlement and/or delivery could occur at different points of time.

Normally, bidders can choose bid prices themselves from a set of permissible prices. In this case we say that bidders explicitly choose bid prices. But in some dynamic auctions, such as clock auctions, the auctioneer (or an auction computer) presents a unit price for an item that it is ready to receive bids for. The presented unit price is sometimes referred to as the standing price or current price. In this case, it is sufficient for each bidder to communicate a quantity for the unit price presented by the auctioneer if the price applies to multiple units, or just indicate that it is willing or not willing to trade at that price if the price applies to a single object. Still even if the bid price is actually presented by the auctioneer, each bid from a bidder is still valid for a specific bid price. Unless otherwise stated, this specification and our claims will mostly disregard whether a bid price is implicitly (as in clock auctions) or explicitly chosen by the bidder. A detailed background of clock auctions and examples of such auctions are provided in the following patents: U.S. Pat. No. 8,447,662 by Ausubel; U.S. Pat. No. 6,026,383 by Ausubel; U.S. Pat. No. 7,899,734 by Ausubel, Cramton and Jones; U.S. Pat. No. 8,335,738 by Ausubel, Cramton and Milgrom. FIG. 4 of U.S. Pat. No. 7,899,734 presents a detailed description of a clock auction trading multiple items, where a computer presents a list of prices for the items for each round, first in step 104 and then in step 114 for the following rounds. In each round, bidders submit bid quantities for the presented prices in step 108. Clock auctions are normally organized as ascending bid auctions.

To speed up the auction, clock auctions sometimes allow for “intra-round bids”, where, normally after getting feedback on the progress of the auction, bidders simultaneously and independently submit bids to the auctioneer often in a narrow price range with a starting price and ending price decided by the auctioneer. All intra-round bids for that price range are normally submitted in the same round. Bid prices in clock auctions are normally implicit, but bid prices of intra-round bids are normally explicitly chosen by bidders. FIG. 8a of U.S. Pat. No. 7,899,734 illustrates in detail how a bidder could submit intra-round bids. The auction will then continue with a new round if the auctioneer was not able to, or did not want to, clear the market in that price range. The next round would normally be a round where bidders can submit bid quantities at a standing price presented by the auctioneer or a new round with intra-round bids.

Another way to speed up the process of a dynamic auction is to use an automatic bidding feature, proxy bidding. A bidder then submits sealed bids or other information on its preferences to a proxy agent. Similar to U.S. Pat. No. 8,335,738 (by Ausubel, Cramton and Milgrom) we refer to such information as “flexible bid information”. Flexible bid information may include contingent bids that instructs the proxy agent on how to change a bid or bids when new information arrives, such as information on competitors' bids. Bids can also be contingent on the quality of a good, as discussed in U.S. Pat. No. 7,792,723 by Molloy, or contingent on something else. As for eBay, flexible bid information can include a limit price, such that the bidder is willing to trade at the specified limit price or at prices that are better from the bidders' perspective; a buyer normally prefers bid prices below the limit price and a seller normally prefers bid prices above the limit price. In case the proxy agent is bidding on behalf of a buyer, it will iteratively increase its bid price in small steps in an eBay auction until the limit price has been reached or until no competitor bids higher. As discussed in U.S. Pat. No. 8,335,738 by Ausubel, Cramton and Milgrom, bidders are sometimes allowed to up-date flexible bid information after one or more bidding rounds in a dynamic auction. The proxy agent uses the flexible bid information and new information that arrives, such as information about competitors' bids, to automatically bid on behalf of the bidder in a dynamic auction. Auctions with proxy bidding are discussed in greater detail in U.S. Pat. No. 8,335,738 by Ausubel, Cramton and Milgrom. A proxy agent could be an automatic trading agent, such as the one discussed in U.S. Pat. No. 8,725,621 by Marynowski et al. The proxy agent is normally an automatic machine or process, but it can be human as in U.S. Pat. No. 6,449,601 by Friedland and Kruse. In financial markets, a (proxy) agent that submits bids on behalf of a client is often referred to as a broker or commission trader. Depending on the context, the term bidder can represent a proxy bidder or a bidder that submits flexible bid information to a proxy bidder. In our specification, the term “bid” would normally include a bid submitted by a proxy agent, unless otherwise stated. There are also circumstances where flexible bid information, or parts of it—such as limit prices and contingent bids—can be regarded as bids.

U.S. Pat. No. 8,335,738 by Ausubel, Cramton and Milgrom uses the term “phase” to separate bidding rounds where bidding rules are significantly different. The U.S. Pat. No. 8,335,738, for example separates between a phase of non-proxy bidding and a phase with proxy bidding. This distinction is not necessary when discussing most aspects of our invention. Often aspects of our invention could be applied to a particular bidding round, a subset of bidding rounds, or all bidding rounds in an auction.

### The Bidding Format

The bidding format of the auction regulates the bidding process in detail. The following five aspects are examples of details that are often regulated by the bidding format.

First, bidders are often restricted to (explicitly or implicitly) choosing unit prices from a list of permissible price levels. A price level could for example be an integer number (e.g. 7, 17 and 1100), a decimal number (e.g. 10.25, 7.0 and 120.237) or a fractional number (e.g. 2/7, 7/4 and 118/14). Note that a fractional number can be converted to a decimal number. In this specification and claims we will treat fractional numbers as decimal numbers. FIG. 1 provides a graphical illustration of a permissible price level. When bidding on a house or flat, it could for example be required that bids must be in even thousands of dollars. The permissible bid price that is best from a bidder's perspective (and often worst from the auctioneer's perspective) is normally referred to as a reserve (or reservation) price. Hence, the highest permissible bid price for sellers is a reservation price for sellers and the lowest permissible bid price for buyers is a reserve price for buyers. If there are cases where the highest permissible unit price is not defined (including restrictions in the auction software), then we can define it to equal a very high number, such as 100 trillion dollars, or even positive infinity. If there are cases where the lowest unit price is not defined, then we can define it to equal zero, or if more appropriate, a very negative number such as negative 100 trillion dollars, or even negative infinity. In an ascending bid auction, the reserve price is often referred to as a suggested opening bid. The absolute difference (the absolute value of the difference) between two adjacent permissible price levels for the same item is referred to as a tick-size (or minimum price increment) for that item. Thus the tick-size is normally the smallest amount by which the bid price can change. FIG. 1 presents an example of a tick-size. The smallest price range that includes all permissible price levels for a specific item or package is referred to as the allowed price range for that item. As mentioned before, bidders do not explicitly choose bid prices (except for intra-round bids) in clock auctions and similar auctions. Still they make such choices implicitly, so our tick-size discussion applies to such auctions as well; unit prices that are or can be presented by the auctioneer are normally regarded as permissible prices in our discussion.

Second, in multi-unit and combinatorial auctions, bidders often choose quantities in their bids from a list of permissible quantity levels. A quantity level could for example be an integer number (e.g. 7, 17 and 1100) or a decimal number (e.g. 10.25, 7.0 and 120.237). The bidding format could for example require that quantities must be in even hundreds or thousands of units. This is graphically illustrated in FIG. 2. In combinatorial auctions, the permissible quantity levels may be different for different items. The absolute difference between two adjacent permissible quantity levels for an item is referred to as a quantity multiple, lot size or minimum quantity increment. It depends on the clearing mechanism of the auction, but normally the lot-size is also the smallest amount by which the transacted quantity can change. FIG. 2 presents an example of a lot-size. Normally there would be an upper bound on the quantity that can be chosen in a bid. But often it would be a non-restrictive number, for example that a bidder cannot choose a bid quantity for an item that is higher than the number of units of that item that are available in the auction. However, some auctions have upper bounds on the quantity that are intentionally restrictive. For example, US treasury security auctions have the 35% rule, which prevents anyone to buy more than 35% of the auctioneer's supply. One purpose with this purchase constraint is to prevent an auction participant from cornering the market of treasury securities. Spectrum auctions by the Federal Communications Commission (FCC) have had similar quantity restrictions. Upper bounds on the quantity are also used in some wholesale electricity markets where bids to sell can only be submitted for production capacity that has been registered at the auction in advance. If there are cases where the maximum quantity constraint is not defined by the bidding format (including restrictions in the auction software), then we can define it to equal a very large number, such as 100 trillion units, or even positive infinity.

Third, bids in multi-unit auctions are often required to be monotonic. This means that a bidder is not allowed to submit bids that indicate that the bidder is willing to trade less at a unit price closer to the reservation price; bidders cannot offer to sell more as the price decreases or offer to buy more as the price increases. In clock auctions and multi-round auctions, such rules are often referred to as activity rules. In such auctions activity rules are particularly important, as they force bidders to be active early in the auction when the price is near the reservation price. Without activity rules bidders may refrain from submitting serious bids until near the very end of the auction, defeating the purpose of a dynamic auction. Activity rules can be quite complicated in combinatorial auctions, as they trade multiple items of different types, and bidders may want to switch between items as the prices change. U.S. Pat. No. 7,899,734 by Ausubel, Cramton and Jones introduces an activity rule in step 110 of FIG. 4, which requires that a buyer must not increase its total bid quantity for related items when prices increases in the next round. As discussed by Ausubel and Cramton (2011), another way to deal with monotonicity for multiple items is to introduce a quantity index and then require that the quantity index is monotonic. In the literature on combinatorial auctions, the quantity index is often referred to as eligibility. Each item (which could be a package of goods) is assigned a number of eligibility points, which corresponds to a weight in the quantity index. For each bidding round, a bidder's eligibility for an item is given by the bidder's bid quantity for that item multiplied by the assigned eligibility points of that item. A bidder's total eligibility is given by the bidder's total eligibility for all items. Some activity rules of ascending-bid clock auctions then require that a bidder's total eligibility must not increase from one round to the next, when prices becomes less attractive. The U.S. Pat. No. 8,447,662 by Ausubel discusses more complicated activity rules that take into account differences in the items and sometimes also bidders' preferences for the items that are revealed during the progress of a dynamic auction. Ausubel and Cramton (2011) discuss activity rules that takes both revealed preference and eligibility into account.

Fourth, each bidder can normally place several bids or price-quantity pairs in multi-unit auctions, but the maximum number of bids or price-quantity pairs per bidder and item is often restricted by the bidding format. Such a constraint is often introduced for administrative purposes, in order to simplify the management of bids.

Fifth, in some auctions, bidders have financial constraints that have been registered at the auction beforehand that prevents them from making bids that, if accepted, would correspond to expenditures beyond their financial limit. This is to make sure that all bidders can make good on their promises. U.S. Pat. No. 8,447,662 by Ausubel discusses such constraints in the context of clock auctions.

Constraints in the bidding format and other details of the auction design are not necessarily announced. In case of computer implemented auction designs, some details could be “hidden” in the software. For example, the highest and lowest allowed prices, respectively, and other permissible prices are sometimes not explicitly announced by the auction, but in practice the auction software would normally anyway implicitly introduce bounds on those numbers, such as the maximum number of digits or the maximum number of decimal places that a bidder can use when choosing bid prices. Similarly, the set of permissible quantities may be due to restrictions in the number of digits and decimal places in the used software. The maximum number of price-quantity pairs per bidder could also be introduced due to a restriction in the used software.

Financial exchanges with continuous trading sometimes use large tick-sizes to increase the market depth (the volume of active (good) orders). This for example means that a seller can quickly get an order (bid) accepted if it is submitted at a lower price compared to active sell orders, which have not yet been executed. This is one aspect of liquidity. On the other hand large tick-sizes increase the bid-ask spread (the difference between the lowest price at which a seller is prepared to sell and the highest price at which a buyer is prepared to buy for active orders). This increases transaction costs, which worsen another aspect of liquidity. To balance these two aspects of liquidity some stock exchanges have a higher tick-size for stocks that are traded at a high price. The tick-size is normally the same for an instrument at one point in time, but it can be updated with respect to the history of the instrument's market price and historical transacted quantities. Similarly, lot-sizes could be updated with respect to historical market prices and historical transacted quantities. As an example, the role of the tick-size on the Tokyo exchange and how it depends on the stock-price is discussed by Lehmann and Modest (1994). Before the decimalization reform, U.S. equity markets often had the tick-size one-sixteenth of a dollar (6.25 cents). After U.S. equity markets completed their decimalization in 2001, the tick size was normally set to 1 cent in these markets.

The Canadian spectrum dynamic sales auction with discrete bidding rounds for the 2300 MHz and 3500 MHz bands is another example where chosen tick-sizes are larger when the estimated value of the traded good is larger. In the first bidding rounds of the auction, tick-sizes were set to $150/eligibility point rounded up to nearest two significant digits. The eligibility points were approximately proportionate to the population covered by the license, which in its turn was roughly proportionate to the value of the license. In the first bidding rounds of the auction, the bidding format in addition required bid increments to be at least 15% (rounded up to nearest two significant digits) of the standing bid in the previous bidding round. However, the minimum increment was lowered to allow for greater bid precision as the bid price increased in later rounds and got closer to the expected clearing price.

The Canadian auction above is an exception for auctions where bidders explicitly choose their bid prices. For administrative purposes ticks-sizes normally have just one non-zero digit; often the number 1. Examples of typical tick-sizes are $100, $1, $0.1 and $0.01. Other tick-sizes that are used are halves, quarters, eights etc. of the currency unit. With a two-significant-digit-number we mean a number (possibly a decimal number) with any number of zeros but no more than two non-zero digits, and if there are two non-zero digits, then they have to be consecutive. Thus we would say that 0.0007, 0.02500 and 9.1 are two-significant-digit-numbers, but 707, 1.004 and 7.77 are not. Similarly, with a three-significant-digit-number we mean a number (possibly a decimal number) with any number of zeros but no more than three non-zero digits. In addition, if a three-significant-digit-number has three non-zero digits, then the non-zero digits have to be consecutive. In case a three-significant-digit-number has two non-zero digits, then they can be separated by at most one zero digit.

DEFINITION: We say that a tick-size is administratively motivated if it can be calculated from a three-significant-digit-number that is divided by one of the numbers in the list 1, 2, 4, 8. Any other tick-size is said not to be administratively motivated.

Similarly,

DEFINITION: We say that a lot size is administratively motivated if it can be calculated from a two-significant-digit-number that is divided by one of the numbers in the list 1, 2, 4, 8, 16. Otherwise, the lot-size is not administratively motivated.

DEFINITION: A bidding format is said to be administratively motivated if both tick-sizes and lot-sizes are administratively motivated. Otherwise, the bidding format is not administratively motivated.

Auctioneers often have some imperfect prior knowledge of bidders' willingness to buy or sell an item before the auction has opened. Sometimes auction designers try to use this imperfect information to set the reservation price optimally, e.g. in order to maximize the auctioneer's expected revenue or to maximize expected social welfare. This is a standard problem for single object auctions that for example is discussed in the mentioned book “Auctions: Theory and Practice” by Klemperer (2004). The scientific publication by Esther David et al. (2007) and two scientific publications by Zhen Li and Ching-Chung Kuo (2011; 2013) go one step further. They show how prior (imperfect) information of bidders' willingness to buy a single object can be used to set a fixed number of permissible price levels (not only the reservation price) optimally for an auctioneer. In these three scientific publications, the permissible price levels are set before the single object sales auction starts.

A scientific paper, “Supply function equilibria: Step functions and continuous representations” by Holmberg et al. (2013) evaluates a multi-unit auction with constant tick-sizes. Tick-sizes are allowed to be non-constant in some of the mathematical proofs, in order to make it less technically challenging to accomplish the proofs.

DEFINITION: Tick-sizes are non-constant if the absolute difference between two adjacent permissible price levels differs from the absolute difference between two other adjacent permissible price levels for the same item.

Bids and their Properties

In auctions trading multiple units, each seller would normally submit a supply schedule, a list of price-quantity pairs, which shows how many units the seller would be willing to supply at different prices. Similarly, a buyer would normally submit a demand schedule, which shows how many units a buyer is willing to purchase at different prices. A list of price-quantity pairs could be empty, e.g. in case a bidder is not interested in trading. We also allow a list of price-quantity pairs to consist of just one price-quantity pair. We use the more general term transaction schedule to represent either a supply schedule or a demand schedule. A bidder might be active both as a seller and buyer in a double auction. In our discussion, bids of such a bidder would normally be sorted into a separate transaction schedule (a supply schedule) representing its willingness to sell and a separate transaction schedule (a demand schedule) representing its willingness to buy.

The quantity of a price-quantity pair in a transaction schedule is referred to as a bid quantity. The price of a price-quantity pair is referred to as a bid price. The bid quantity of a price-quantity pair would normally represent the total quantity that a bidder wants to trade at the bid price of the price-quantity pair. This also includes the quantity, which the bidder would be willing to transact at worse prices; for a seller it is normally better with a higher price and for a buyer it is normally better with a lower price.

The price-quantity pairs of a transaction schedule could be submitted in the same bidding round or in different bidding rounds. The former would be the case in a static multi-unit auction, which are often used in electricity markets and security auctions of the treasury.

The latter case corresponds to a dynamic multi-unit auction. In dynamic auctions, a submitted bid is active when it is ready to be cleared (executed). It would no longer be active if it has been accepted in full. Normally a bid would also be inactivated when an auction closes. A bid might be partly accepted. In some dynamic auctions, such as financial exchanges, the unaccepted part of the bid could continue to be active. In some dynamic auctions, a bidder has the possibility to alter or cancel bids and/or to indicate a time period during which the bid is active. This is for example often the case in financial exchanges. Day orders in financial markets are valid for the trading day. Good-until orders are active (good) until a date specified by the bidder Immediate-or-cancel orders (fill-or-kill orders) are active only when presented to the market. Good-after orders are active after some specified date. Note that these orders would no longer be active after they have been accepted, which could happen before the expiration date. Some financial markets allow for various order types where bids are only activated (triggered) under special circumstances. Stop orders and market-if-touched orders are activated when the market price reaches a specified level. After these orders have been activated they are often treated as regular orders. Tick-sensitive orders are contingent on the direction of the market price. One type of a tick-sensitive order would for example only be active when the market price is increasing. In some exchanges and auctions, a bidder can choose to partly or completely display an active order to other bidders, or to hide it from them. Some exchanges do not display any active orders. Sometimes such exchanges are referred to as dark pools. This is an advantage for institutional investors and others who want to anonymously trade large quantities without leaking information to the market. Block orders are orders with unusually large bid quantities, such as more than 10,000 stocks, or that correspond to an usually high market value. These and other order types are discussed in more detail by Gu (2005) and in the book “Trading and Exchanges” by Harris (2003).

A transaction schedule in our discussion would normally refer to an active transaction schedule, corresponding to active bid(s). In case a transaction schedule has partly expired or been partly cleared or withdrawn, or if the bidder has submitted or activated new bids, then bid quantities and bid prices of the revised active transaction schedule would be updated to reflect this.

For presentational convenience, we will henceforth assume that price-quantity-pairs in a bidder's transaction schedule are sorted with respect to the bid prices. But of course our specification also applies to cases with unsorted bids that can be sorted in this way. Normally it is assumed that a bidder wants to change its transacted quantity at the bid price of a price-quantity pair and that it wants to keep the transacted quantity fixed (unchanged) at prices strictly between two neighbouring bid prices. Even if bids are not submitted exactly in this way by bidders, they can anyway often be transformed into such an equivalent list of price-quantity pairs, and our discussion would apply to such cases as well. For example, when considering clock auctions, we can normally choose the list of price-quantity pairs in the transaction schedule of a bidder such that each price-quantity pair of the bidder would consist of an implicit bid price, where the bidder indicated that it wanted to change its transacted quantity, and a bid quantity associated with this implicit bid price. In clock auctions, bidders normally state minimum quantities that they are willing to transact at the standing price. But in static multi-unit auctions and financial exchanges, the bid quantity of a price-quantity pair is often the maximum quantity that the bidder wants to transact at the corresponding bid price. As an example, assume that a bidder submits the following four price-quantity pairs as supply schedule and that bid quantities correspond to maximum quantities that the bidder wants to transact at the corresponding bid price:

10 units at $100 per unit

8 units at $80 per unit

6 units at $60 per unit

0 units at $0 per unit

Assuming that $0 is the minimum price and that $200 is the reservation price, this would then imply that the bidder wants to sell 10 units at prices/unit of $100-$200, 8 units at prices/unit of $80-$100, 6 units at prices/unit of $60-$80 and 0 units at prices/unit of $0-$60. This relationship is illustrated graphically in FIG. 3. We refer to such relationships as a supply curve. We say that the supply curve is stepped, when it has a stepped shape as in FIG. 3. In case of a sales auction, we can also use a supply curve to represent the supply of the auctioneer. Normally, the supply of the auctioneer in a multi-unit sales auction would be constant above the reservation price and zero below the reservation price, but the auctioneer's supply curve is more complicated in some sales auctions. As is well-known from the economic literature, supply curves from all traders can be summed (horizontally) into an aggregated supply curve. If there is only one trader that is interested in selling units, then the aggregate supply curve would be equal to the supply curve of that trader, which could be the auctioneer.

Now, consider another example where we assume that a bidder instead submits the following four price-quantity pairs as bids to buy.

10 units at $0/unit

8 units at $80/unit

6 units at $100/unit

0 units at $200/unit

Also in this example, we first assume that the bid quantity is the maximum quantity at the corresponding bid price. Assuming that $0 is the reservation price and that $200 is the maximum price, this would then imply that the bidder wants to buy 10 units at $0, 8 units at prices/unit of $0-$80, 6 units at prices/unit of $80-$100 and 0 units at prices/unit of $100-$200. This relationship is illustrated graphically in FIG. 10. We refer to such relationships as a demand curve. In case of a procurement auction, we can also use a demand curve to represent the demand of the auctioneer. Normally, the demand of the auctioneer in a multi-unit procurement auction would be constant below the reservation price and zero above the reservation price, but the auctioneer's demand curve is more complicated in some procurement auctions. Analogous to supply curves, traders' demand curves can be summed into an aggregated demand curve. If there is only one trader that is interested in buying units, then the aggregate demand curve would be equal to the demand curve of that trader, which could be the auctioneer.

We let the more general terms ‘bid curve’ or ‘transaction curve’ denote either a ‘supply curve’ or ‘demand curve’. In another auction design, where the bid quantity of a price-quantity pair instead represents the minimum quantity that the bidder wants to transact at the corresponding bid price, then the price-quantity pairs of a demand schedule in the example above would be interpreted as follows: the bidder wants to buy 10 units at prices/unit of $0-$80, 8 units at prices/unit of $80-$100, 6 units at prices/unit of $100-$200 and 0 units at $200.

The difference between the maximum and minimum quantity that a bidder wants to transact at a bid price is, in our specification and claims, referred to as the bidder's quantity increment at that bid price. In some auctions, the auctioneer sometimes discontinuously increases the amount that it is willing to trade at a price as the price gets further away from the reservation price. These changes are referred to as quantity increments of the auctioneer in our specification.

In financial exchanges and related auctions, a bidder often submits a list of limit orders, which could be submitted independently at different points of time. We refer to a limit order from a seller as a sell bid and a limit order from a buyer as a buy bid. The bid prices in a list of limit orders would correspond to the bid prices in the list of price-quantity pairs discussed above. However, the quantity part of a limit order would correspond to the quantity increment at the corresponding bid price. A bidder might be active both as a seller and buyer in a financial exchange or another double auction. In our discussion, limit orders of such a bidder would normally be sorted into a separate list of limit orders with sell bids and another list of limit orders with buy bids.

The four price-quantity pairs of the supply schedule in the example above would correspond to three limit orders with 6 units being offered at the limit price $60/unit, 2 (additional) units being offered at the limit price $80/unit and 2 (additional) units being offered at the limit price $100/unit. A quantity increment at a bid price is given by the maximum quantity that a bidder wants to transact at that price minus the minimum quantity that the bidder wants to transact at that price. Thus, it is straightforward to transform a list of limit orders into an equivalent list of price-quantity pairs of a stepped bid curve, and vice versa. For pedagogical reasons, we sometimes find it easier to use the limit order representation and sometimes the price-quantity pair representation in the specification. Regardless of which representation that we use in the specification it also applies to a transformed version of the other equivalent representation.

In this specification and in our claims, a bid price of a price-quantity pair in a transaction schedule is normally a price where the bidder wants to change the transacted quantity. A bid quantity of a price-quantity pair is normally a quantity, or one of the quantities (such as a maximum or minimum quantity), that the bidder wants to transact at the corresponding bid price. A bid curve is not necessarily stepped; a bid price could also indicate some other breakpoint in the bid curve of a bidder. In some auctions, such as the wholesale electricity markets in France (PowerNext) and the Nordic countries (Nord Pool), the price-quantity pairs of a bidder's bids are not connected by steps, as for stepped bid curves, but by linear lines forming a piece-wise linear bid curve.

Irrespective of the shape of a bid curve, it would normally be the case that bid prices and bid quantities of the price-quantity pairs must be chosen from permissible price and quantity levels. The same would normally be the case for limit orders. In that case, the quantity increment of a limit order would normally have to be chosen from permissible quantity levels. Often bidders can submit bids, such that a bid curve gets a stepped shape, even if a stepped shape is not required by the bidding format. Our discussion and aspects of our invention that applies to auctions that require stepped bid curves, also applies to occasions in other auctions where bidders voluntarily choose to make stepped bid curves.

DEFINITION: We say that a bidding round is a multi-bid round if a bidder is allowed to submit a plurality (two or more) of bids with different bid prices or a plurality of price-quantity pairs with different bid prices for units of an item in the same bidding round. We also say that auctions with continuous trading, such as most financial exchanges, have multi-bid rounds, as long as there is at least one bidder that can submit a plurality of bids with different bid prices for units of an item at essentially the same time, within minutes and sometimes without any bid of another bidder being submitted in the same time frame.

The multi-bid round criterion would normally be satisfied for multi-unit or combinatorial auctions that only have one bidding round. A bidding round with intra-round bidding in a dynamic auction would normally also satisfy the multi-bid round criterium. Call markets and frequent batch auctions would normally also satisfy the multi-bid round criterium.

The bids in the auctions and exchanges that we discuss normally have an explicit or implicit bid price, but there are exceptions. Financial exchanges often allow for market orders or unrestricted orders, which indicate that a bidder wants the order for an indicated quantity to be executed at the best available price without any price limit ‘Non-competitive bids’ in security auctions by the US treasury are treated in a similar way. For a seller, the worst price would normally be the lowest permissible price. For a buyer, the worst price would normally be the highest permissible price. In many auction designs an unrestricted order and a non-competitive bid correspond to a limit order and a price-quantity pair, respectively, with a bid price at the worst permissible price (or some other very unattractive price) for the bidder. Thus our specification could be applied to such cases. Anyway, our specification and claims that concern permissible quantities of an auction and rationing can be relevant for unrestricted orders, non-competitive bids and related bids, even if such bids or transaction schedules do not include explicit or implicit bid prices. In single object auctions, bidders would normally only submit bid prices (without any indication of quantity). Parts of our discussion and some aspects of our invention apply also to such auctions, for example aspects that concern permissible prices or up-dating of rationing rules.

In some combinatorial auctions, a transaction schedule or bid for one type of good could also be contingent on prices and/or transacted quantities for other goods. In case multiple units are traded for a plurality of different goods in such combinatorial auctions, it would normally be possible to define a unique item for each type of mix (with the same percentage of each good. The combinatorial transaction schedule of a bidder can then be represented by a set of transaction schedules, one schedule per item, where each schedule is only contingent on the price of its associated item. The discussion above (and elsewhere in the specification and claims) would then apply to each such item and its associated transaction schedule. Similarly, the specification and claims would apply to any auction for circumstances such that bid(s) of a bidder can be represented by such a set of transaction schedules.

### Allocation and Pricing Rules

The auction format decides the transacted quantity (the allocation rule) and transaction price(s) of each bidder (the pricing rule). The allocation decision is often straightforward in single object auctions. After the auction has closed, the auctioneer would normally simply accept the bid with a bid price that is furthest from the reservation price, i.e. the highest sell bid or lowest buy bid.

In multi-unit auctions, the allocation is normally such that the total quantity bought by traders equals the total quantity sold by traders, where the auctioneer could be one of the traders. Thus the market for one type of item is often cleared at a point where the aggregate supply curve equals the aggregate demand curve, where either the aggregate supply curve or aggregate demand curve could represent the quantity that the auctioneer wants to transact. Note that there could be several potential clearing points, as for example illustrated in FIG. 12. In case there are multiple clearing points, the auction format would normally have a rule which picks the clearing point. In our specification we refer to the clearing price as the marginal price. Note that the transaction price of a bidder may differ from the marginal price. A quantity increment of a bidder at the marginal price is referred to as a marginal bid. We also refer to a bidder's quantity increment at the marginal price as its marginal quantity increment.

Sometimes it can also be helpful to have the limit order representation of independent bids in mind when discussing acceptance of bids for an item. For this representation, we would say that the auction format is often such that the auctioneer simply accepts the sell bids with lowest bid price and/or the buy bids with highest bid price, such that the total volume sold by traders equals the total volume bought by traders. The highest bid price of any partly or completely accepted sell bid is a marginal price, and sell bids with a bid price equal to the marginal price are referred to as marginal bids. Similarly, the lowest bid price of a partly or completely accepted buy bid is a marginal price, and buy bids with a bid price equal to the marginal price are referred to as marginal bids. In a double auction, acceptance of bids is often such that marginal prices are the same for sell and buy bids, which would normally maximize the total volume transacted. In case there is a difference, the marginal price of sell bids would normally be lower than the marginal price of buy bids, because it would normally be efficient to clear overlapping sell and buy bids. In case there is a difference, we implicitly let the marginal price mean the marginal price for sellers when discussing sell bids and supply schedules and the marginal price for buyers when discussing buy bids and demand schedules.

In principle, the clearing process is the same in clock auctions. In such auctions the clearing price is normally found in the following way. The opening price of a clock auction is normally very favourable to bidders. Thus they are normally willing to trade more units of an item at that price than the auctioneer is willing to transact. Bidders' interest to trade units is then reduced as the price gets less favourable in the next rounds. A basic clock auction ends when the aggregate minimum quantity that bidders want to transact of an item at the current price is equal to or lower than the quantity that the auctioneer wants to transact. In practice it is sometimes desirable to stop a clock auction earlier, when the aggregate minimum quantity that bidders want to transact of an item at the current price is sufficiently close to the quantity that the auctioneer wants to transact. An embodiment for cases when multiple related items are traded is illustrated in step 112a-2 of FIG. 7 in U.S. Pat. No. 7,899,734 by Ausubel, Cramton and Jones. The current price of the final round sets the marginal price of the item. As before, we set the marginal quantity increment of a bidder equal to the difference between the maximum and minimum quantity that the bidder is willing to transact at the marginal price, i.e. by how much the bidder reduced its bid quantity in the final round of the clock auction.

U.S. Pat. No. 7,899,734 by Ausubel, Cramton and Jones also explains the operation of a sales clock-auction with intra-round bids in detail, for cases with multiple related items. As explained in detail in FIGS. 8b and 8c of U.S. Pat. No. 7,899,734, such an auction is stopped after an intra-round if there is some bid price in the last round where the aggregate minimum quantity that bidders want to transact of an item at this bid price is less than or equal to the quantity that the auctioneer wants to transact. In this case, the auction clears at the lowest such bid price in a sales auction and at the highest such bid price in a procurement auction. This clearing price gives the marginal price in our specification and claims. As before, the marginal quantity increment of a bidder is set by the difference between the maximum and minimum quantity that the bidder is willing to transact at the marginal price.

The principle is often the same in exchanges with an allocation rule. In order-driven exchanges the clearing price is normally found as follows. Active orders are ranked with respect to an order precedence rule. Normally, the lowest active sell bid gets the highest ranking out of the active sell bids and the highest active buy bid gets the highest ranking out of the active buy bids. Orders are then accepted in the order of their ranking, high-ranking sell orders are accepted before low-ranking sell orders, and high-ranking buy orders are accepted before low-ranking buy orders. Orders are accepted as long as there is a remaining active sell order with a bid price equal to or lower than a remaining active buy order. The bid price of the last (lowest ranked) accepted sell order normally sets the marginal price for sell bids and the bid price of the last (lowest ranked) accepted buy order normally sets the marginal price for buy bids. A limit order with a bid price at the marginal price is considered to be a marginal bid in our specification and claims, and the bid quantity of such an order can be referred to as a marginal quantity increment. In an exchange with continuous trading, the clearing process would normally be repeated each time a new order is submitted to the exchange or each time an order becomes activated for other reasons. The matching procedure of rule based exchanges is described in further detail in the book “Trading and exchanges” by Harris (2003). Embodiments in U.S. Pat. No. 8,489,493 by Nager and in U.S. Pat. No. 4,903,201 by Wagner, especially the latter, provide detailed examples of how order-driven markets can be operated.

In this specification and claims, we use the term “infra-marginal quantity of a bidder” to denote the quantity that the bidder, according to its transaction schedule, would be willing to transact at a slightly worse price (from the bidder's perspective) in comparison to the marginal price. Normally the infra-marginal quantity of a bidder would be equal to the minimum quantity that the bidder would be willing to transact at the marginal price. Our use of the term infra-marginal is well-established among economists for sellers in an auction. But note that in comparison to some scientific publications, we use the term infra-marginal differently for buyers. Gresik (2001), for example uses the term “supramarginal quantity” to denote the minimum quantity that a buyer would like to procure at the marginal price. The infra-marginal quantity of sellers can be summed into an aggregated infra-marginal quantity for sellers. Similarly, the infra-marginal quantity of buyers can be summed into an aggregated infra-marginal quantity for buyers. Sometimes we use the somewhat more general term aggregated infra-marginal quantity, which could be either the aggregated infra-marginal quantity of sellers or the aggregated infra-marginal quantity of buyers.

The total transacted quantity is determined by the clearing point. But the auction format can differ in how much each bidder should transact. There are exceptions, but normally, all infra-marginal quantities are accepted, while, as discussed in a later section, marginal bids are often rationed.

Marginal prices can be different for different items, in case the auction trades different types of items. In this case, we implicitly let the marginal price mean the marginal price of a particular type of item when discussing that item. Deciding what bids to accept is often less straightforward when a combinatorial auction trades multiple types of items. In this case, the auctioneer's acceptance decision is referred to as the winner determination problem. U.S. Pat. No. 6,272,473 by Sandholm outlines an algorithm for solving this problem. In his scientific publication “The product-mix auction: A new auction design for differentiated goods”, Klemperer (2010) describes a static (single-round) auction for differentiated goods, which is relatively simple to use. As for example discussed in U.S. Pat. No. 8,335,738 by Ausubel, Cramton and Milgrom, sometimes auctioneers also take bid related information into account when accepting bids, such as terms of payment and delivery (settlement), and the use to which the auctioned one or more items will be put. Acceptance of a bid in Google's and Yahoo's keyword auctions takes into account a quality score of an ad that considers the click through rate, relevance of text and historical keyword performance. Bidder specific information that might be taken into account when accepting bids is location, credit-rating, minority status, foreign or domestic status of the bidder etc.

Allocation is not necessarily rule-based, an auctioneer may accept bids on its own judgement. In real-time electricity markets, a system operator sometimes accepts bids on its own judgement taking for example bid price, but also switching time (ramp rates) of generation, location of generation and various power system constraints into account when making its decision. In exchanges that are quote driven dealer markets, dealers announce buy and sell prices that clients can choose to accept or reject. In this case, dealers sometimes only trade with clients that they believe are trustworthy and creditworthy. A dealer may also refuse to trade with someone outside its preferred clientele and they sometimes try to avoid trading with well-informed clients. Quote-driven exchanges are discussed in more detail by Harris (2003). U.S. Pat. No. 8,489,493 by Nager presents embodiments of quote-driven exchanges. Many exchanges are hybrid markets, which mix characteristics of order-driven and quote-driven markets. New York Stock Exchange is essentially an order-driven market, but it requires specialist dealers to offer liquidity (submit bids) if no one else will do so. The Nasdaq Stock Market is essentially a quote-driven market, but it also has characteristics of an order-driven market. The contribution in U.S. Pat. No. 8,489,493 by Nager is how to implement an exchange that can quickly, in real-time, change between an order-driven, quote-driven and hybrid market.

The pricing rule of the auction format regulates how much accepted bids should pay or be paid. In uniform-price (single price), multi-unit auctions, all accepted bids for a particular item are transacted at a uniform clearing price, which is determined by the marginal price. In first-price (single object) and pay-as-bid/discriminatory (multi-unit) auctions, each accepted bid is transacted at its own bid price. In second-price, generalized second-price, Vickrey and Vickrey-Clarke-Groves (VCG) auctions and in auctions with core pricing, the transaction price of accepted bids is normally different to the marginal price and partly or completely determined by the bid price of competitors' bids. There are also auctions where bids that are not accepted in the auction have to pay or get paid, such as “all pay auctions”. Standard auction formats are discussed by Klemperer (2004) in “Auctions: Theory and Practice”. U.S. Pat. No. 7,729,975 by Ausubel, Cramton and Milgrom, Day and Milgrom (2008) and Day and Cramton (2012) discuss auctions with core outcomes. Normally, transaction prices in an auction occur at prices that are permissible for bidders, but this is not necessarily the case.

Many order-driven stock markets and many electronic futures markets open with a single price call market (auction) before continuous trading is started. In this case, orders submitted to the call market are cleared simultaneously at a uniform-price. A session with continuous trading may also close with a similar auction. Normally exchanges with frequent batch auctions would clear at a uniform-price at regular intervals, see for example Budish, Cramton and Shim (2013). Arizona Stock Exchange used to trade U.S. equities in a single-price auction.

The liquidity in a public exchange is often not sufficient to trade a block order with a large bid quantity. Therefore a counterparty that is ready to trade a block order is often found by a broker outside a public exchange. Such a match is often referred to as crossing. A broker can also cross orders with smaller bid quantities from its clients. Crossing is often regulated, for example by Regulation NMS in U.S., it may for example be the case that such trades can only be executed at the market price and that such trades have to be registered at a public exchange. In addition, before registering a crossed trade at a public exchange, active orders at better prices in the exchange may fully or partly displace orders matched by crossing. This process is sometimes referred to as to print a trade. Crossing may involve multiple clients and it could be organized similar to an auction.

Crossing networks are normally order-driven exchanges where all accepted bids transact at the same price, but unlike a uniform-price auction the transaction price is set by another market; normally a public exchange. One can therefore say that crossing networks use a derivative pricing rule. Crossing networks often rank and match orders similar to an order-driven market, and the allocation is normally such that the total quantity bought by traders equals the total quantity sold by traders. However, a difference is that normal order-driven markets would choose the clearing price in order to maximize the traded quantity, while in a crossing network the allocation is constrained by that the clearing price is set by an external market, and that only orders that are willing to trade at this external price are accepted. This constraint often results in a lower traded quantity. Due to this constraint a likely outcome is also that the marginal price would differ for sellers and buyers.

Crossing networks are often call markets with a single bid round, but some crossing networks operate continuously. One advantage for bidders with crossing networks is that it becomes possible for a bidder to trade large quantities, block orders, with less influence on market prices. This is for example attractive for institutional investors. To avoid information leakage, crossing networks are sometimes organized as dark pools with none or little displayed information. Crossing and crossing networks are discussed in more detail by Harris (2003). U.S. Pat. No. 8,131,633 by Schlifstein and David present embodiments of crossing-networks that are compatible with Regulation NMS in U.S.

Normally rule-based exchanges with continuous trading would use discriminatory pricing to set transaction prices. An old order, which was submitted or activated some time before being accepted, is normally transacted at a price equal to its limit price. A newly submitted or newly activated order is transacted at the price that is set by old orders that it is matched with. Sometimes a new order with a large bid quantity could be matched with several small old orders with different limit prices. In this case, the new order would be divided into parts that are transacted at different prices. Pricing rules of rule-based exchanges are discussed in more detail by Harris (2003).

Clock auction versions of the Vickrey auction (and other auctions where the transaction price of accepted bids is determined by the bid price of competitors' bids) are discussed in the U.S. Pat. No. 8,447,662 by Ausubel, U.S. Pat. No. 6,026,383 by Ausubel and U.S. Pat. No. 8,335,738 by Ausubel, Cramton and Milgrom. In particular clock auctions often use a concept called “clinching”. This means that a bidder has ensured to be allocated units at the standing price before all units of the auction have been cleared. The clinched units are often transacted at the standing price, which typically is closer to the reservation price compared to the marginal price. Clinching of a bidder occurs when the auctioneer is willing to trade more units at the standing price than competitor(s) of the bidder is/are willing to trade at the standing price. The number of units clinched at the standing price is given by the number of units that the auctioneer is willing to transact at that price minus the number of units that competitor(s) of the bidder is/are willing to trade at that price.

The advantage with letting competitors' bids completely decide the transaction price of a bidder's accepted bid is that it under some special circumstances, such as in second-price auctions, Vickrey auctions and in the Vickrey-Clarke-Groves (VCG) mechanism, become profitable for a bidder to choose a buy bid or demand schedule that fully and truthfully reveals the bidder's valuation of units of an item and a sell bid or supply schedule that fully and truthfully reveals its cost of providing units of an item. Such auctions have a truth-telling mechanism, and we say that they result in competitive bids (e.g. competitive transaction schedules or lists of competitive limit orders), which makes it possible for the auctioneer to allocate items in a socially efficient way. We use the term competitive bid price to denote a bid price of a price-quantity pair in a list of price-quantity pairs in a competitive transaction schedule and/or a bid price of a limit order in a list of competitive limit orders. Some of the embodiments of the clock auctions discussed in U.S. Pat. No. 8,447,662, U.S. Pat. No. 6,026,383 and U.S. Pat. No. 8,335,738 have this property. Still transaction prices are generally set at a non-competitive price in auctions with a truth-telling mechanism, as the transaction price of an accepted bid is normally set by rejected bids of the competitor(s), which typically are closer to the reservation price compared to the marginal price. Core-pricing and generalized second-price auctions are normally not truth-telling mechanisms, but they can be truth-telling mechanisms under some very special circumstances.

In auction formats that do not have a truth-telling mechanism, it is typically the case that a bidder would always or sometimes influence its own transaction price by at least one of its bids. This is obvious for a pay-as-bid auction, where an accepted bid is transacted at its bid price. Another example is the uniform-price auction, where a bidder would typically have the marginal bid with a positive probability, and it sometimes has a chance of influencing its transaction price for such outcomes. When a bidder can use its bid to influence its transaction price, it would normally have incentives to choose that bid strategically in order to improve its payoff. In this case, a seller would often find it profitable to choose the bid price for a given bid quantity or quantity increment above its competitive bid price. This is often referred to as a mark-up. Similarly, a buyer would often find it profitable to choose the bid price for a given bid quantity or quantity increment below its competitive bid price. This is often referred to as bid shading. In U.S. Pat. No. 8,447,662 by Ausubel this type of strategic behavior is referred to as demand reduction; instead of saying that a strategic buyer bids below its competitive bid price one can almost equivalently say that a strategic bidder offers to buy less at a given price in comparison to its competitive bid. In auction formats that do not have a truth-telling mechanism, a bidder's optimal bid is normally determined by the balance of the price and quantity effects. Changing a bid price in the direction of the reservation price will normally increase the payoff of a bidder provided that the bid is accepted. This is the price effect. But such a change in the bid price will normally also increase the risk that the bid is not accepted, which is the quantity effect.

An auctioneer often decides the bidding and auction format in order to maximize its own surplus or to increase the surplus of its clients, the bidders. Normally, the auctioneer wants bidders to bid competitively or nearly competitively, which also makes the auction outcome more efficient for the society as a whole. In financial exchanges, more competitive bids will reduce the price distance between sell and buy bids, which will speed-up trading and lower transaction costs.

In addition to receiving competitive bids, an auctioneer that procurers or sells one or more items would normally also prefer the transaction price to be equal to or close to the marginal bid. In practice it is difficult to motivate bidders to submit competitive bids if the transaction price is set to equal the marginal price. The choice of auction and bidding format is also determined by the auctioneer's risk preferences. A risk-averse auctioneer may prefer an auction that gives the auctioneer a safe payoff even if it has a lower expected surplus than an auction that gives a riskier payoff. Some auction formats are chosen to deter collusion among bidders or other types of manipulations of the auction. Other considerations are transparency of the auction, fairness and the administrative or computational burden for the auctioneer and bidders.

Some auctions also have side-payments to bidders, such as up-lift in electricity markets, which is used to compensate bidders for switching costs in production costs. Sometimes there are also such payments to producers, even when they do not produce.

After an auction has been cleared there is normally a settlement procedure, which ensures that each allocated item is delivered against a payment of the transaction price.

### Rationing

Sometimes there is excess demand from buyers or excess supply from sellers at the marginal price. This for example occurs if traders are willing to buy more units of an item at the marginal price than traders are willing to provide at this price, or vice versa. This often happens for stepped bid curves, so that the transacted quantity of a bidder is not uniquely determined by the clearing price. A situation with excess supply is illustrated in FIG. 11. Thus supply will not balance demand, unless the auctioneer rations acceptance of bids. Normally all buy bids above the marginal price and all sell bids below the marginal price are accepted, while bids at the marginal price are rationed. This is called rationing on the margin.

In practice, pro-rata (proportional) rationing on the margin is normally used in multi-unit auctions. This rule is for example discussed in “Divisible-Good Auctions: The Role of Allocation Rules” by Kremer and Nyborg (2004). Pro-rata rationing implies that the accepted volume from a bidder's quantity increment at the marginal price is proportional to the bidder's quantity increment at the marginal price. An example of a pro-rata rationing on the margin outcome is illustrated in FIG. 5. Sometimes auctions also give priority to the bid that arrives first (time-priority) or ration bids by some random method. Both of these rules would for example make sense in a single object auction, where it is not possible to divide the traded object between a plurality of bidders.

U.S. Pat. No. 8,447,662 by Ausubel briefly discusses rationing rules for combinatorial clock auctions, but note that this patent calls it a “reduction rule”. Also note that clock auctions as discussed in U.S. Pat. No. 8,447,662 often start with a price at or near the reservation price. Due to the activity/monotonicity rule, the bid quantity will then normally decrease as the price then moves further away from the reservation price. We instead use the convention that a bidder's bid prices are sorted, in reverse order, with respect to the distance to the reservation price, such that the bid price closest to the reservation price comes last. Thus a quantity increment at a bid price in our presentation corresponds to a quantity decrement at a price in U.S. Pat. No. 8,447,662. U.S. Pat. No. 8,447,662 mentions time priority and proportional rationing as examples of rationing rules. U.S. Pat. No. 6,026,383 by Ausubel mentions a random method as an example of a rationing rule (method of breaking ties). The already mentioned scientific publication by Kremer and Nyborg (2004) also show that bidding can sometimes be made more competitive if not only bids at the margin are rationed. They propose that infra-marginal quantities should also be rationed proportionally. However, rules that do not ration on the margin can result in significant allocative inefficiencies, also in a perfectly competitive auction, where all bidders bid their true values or true costs. Rather than accepting 50% from a low cost plant and 50% from a high cost plant in a procurement auction, it would obviously be more efficient to accept everything from the low cost plant, if possible. McAdams (2002) gets similar results to Kremer and Nyborg (2004) without rationing infra-marginal quantities by introducing an extra payment to rationed bidders. On the other hand such a payment reduces the payoff of the auctioneer for given bids.

Gresik (2001) discusses rationing rules in treasury auctions of the European Central Bank. He refers to pro-rata on the margin rationing as Q-rationing. He also discusses another rationing rule, ξ-rationing, where rationing is disproportionate on the margin in a special way; the marginal quantity increment of a bidder is (when possible) accepted in proportion to the infra-marginal volume that a bidder wants to trade at the marginal price.

Yago Saez, David Quintana, Pedro Isasi and Asuncion Mochon (2007) analyse rationing in a clock auction with a truth-telling mechanism. This type of auction is often referred to as an Ausubel auction. The four authors evaluate three rationing rules by running computational experiments. One is the standard pro-rata on the margin rationing rule, which they refer to as proportional rationing (PRR). The spread rationing rule (SRR) gives more priority to bidders with small infra-marginal quantities and the concentrate rationing rule (CRR) gives more priority to bidders with large infra-marginal quantities. The two latter are examples of rules with disproportionate rationing.

Dynamic auctions, especially exchanges with continuous trading, sometimes use time priority to ration marginal bids. This is often referred to as price-time priority, i.e. bids are first sorted with respect to the price. Bids with the same price are then ranked with respect to time of arrival. Time priority is a question of fairness, but it is also a way to encourage bidders to submit bids as quickly as possible, which improves liquidity. IEX, an alternative exchange in U.S., uses price-broker-time priority. In our context this would be price-bidder-time priority. This means that marginal sell and marginal buy bids from the same bidder are cleared before giving priority to bids with time-priority. The purpose with this type of rationing rule is to encourage brokers to submit all of their bids to IEX instead of crossing orders in-house. Some exchanges use public order precedence, which gives the public priority to members of the exchange, even if a member submitted a marginal bid before a public marginal bid. This is to weaken informational advantages that members often have compared to the public. U.S. Pat. No. 8,751,369 by Monroe discusses exchanges where the priority of bids can be modified, for example if a bidder pays a fee to be given a higher priority. Markets often give priority to displayed marginal bids relative to non-displayed marginal bids, in order to encourage bidders to expose their bids. Some exchanges allow bidders to specify that the whole bid, or a minimum part of it, must be accepted at the same time. Bidders use such size restrictions to avoid multiple fixed costs, including exchange fees, settlement fees and the cost of accounting for each trade. Producers in electricity markets sometimes use such bids to avoid situations where it needs to start up a plant (a fixed cost) only to produce a minor output. Bids with such size restrictions often get lower priority in the rationing process, as they are harder to execute. Large block orders that have been matched by a broker outside the exchange (crossing), often get priority in the rationing process of an exchange, if the exchange requires that such matched orders have to be printed. In such cases, U.S. equity exchanges often give priority to crosses involving matched orders in excess of 25,000 shares. Thus rationing could be disproportionate for orders matched outside the exchange. In exchanges this is referred to as a size precedence rule.

Some exchanges use pro-rata on the margin rationing. A scientific paper by Field and Large (2012) empirically analyses differences in bidding behavior for standard pro-rata on the margin and price-time priority rationing rules, and they find that the rationing rule has an impact on bidding behaviour.

In theoretical models of auctions, such as in the scientific papers by Deneckere and Kovenock (1996), Fabra, von der Fehr and Harbord (2006), Simon and Zame (1990), Jackson and Swinkels (1999), it is for academic purposes (to simplify proofs for theoretical models) sometimes convenient to consider type dependent rationing rules, where for example priority is given to the most efficient marginal bids, e.g. marginal sell bids with lowest cost or marginal buy bids with highest valuations. However, such rationing rules are difficult to apply in practice, where bidders' true costs or true values are normally not observed by the auctioneer.

The accepted volume from a bidder's marginal bids often depends on the rationing rule. Still, if one side of the auction is perfectly inelastic with respect to the price, such as the auctioneer's demand in FIG. 11, then the aggregated transacted quantity for all bidders is normally the same for given bids, irrespective of the rationing rule. However, this is not necessarily true in double auctions or in one-sided auctions where the auctioneer's demand or supply depends on the price. In this case, both the sell side and buy side of the auction could have a quantity increment at the marginal price. As illustrated in FIG. 12, this means that the aggregated supply curves and aggregated demand curves from traders could intersect in an interval of quantities, so that also the aggregated transacted quantity needs to be specified by the rationing rule. We use the term “interval of quantities” in a general way. Formally speaking this interval could be a “set of quantities” if aggregate quantities are only defined at discrete points, such as at permissible quantity levels. Note that aggregated supply curves and aggregated demand curves from traders also include the auctioneer's supply and demand curves, respectively, if any.

As far as we know, a rationing rule of a double auction would normally maximize the aggregated transacted quantity at the marginal price. Thus as long as there is a sell bid with a price limit at the marginal price, then this bid would be accepted as long as there is a remaining buy bid with a price limit at the marginal price (or higher).

### Uncertainty or Variation in Number of Transacted Units

Normally the number of units and characteristics of each item to be traded are described in detail before bidders start to submit their bids. However, there are auctions where the number of transacted units is revealed afterwards or where a bidder has to use the same bid curve for different items. In this case we say that the auction has a shock or variation in the transacted quantity. One example is the real-time electricity market, where bids are submitted before the delivery period starts. During the delivery period there are unexpected variations in for example demand as well as in wind and solar power production. The system operator manages this by continuously accepting buy and sell bids in order to keep production and consumption in balance every single minute during the delivery period. Similarly, some treasury auctions give an indication of the number of securities that will be auctioned off before bids are submitted, but the exact number could be changed afterwards, in case the exact number of securities depends on last minute market information.

We also say that the auction has a shock or variation in the transacted quantity if the bidding format forces bidders to submit the same bid curve for similar but slightly different items. Some electricity markets for example require bidders to submit the same bid curve for every delivery period of the same day. Demand varies during the day, so this has a similar effect on bidders as uncertainty in the transacted quantity.

Some auctions, e.g. some security auctions by the US treasury, divide bids into what they call “competitive bids” and “non-competitive bids”. The former are regular bids, and henceforth we refer to them as regular bids, as their bid prices are normally not competitive in the sense that they reveal the bidders' true costs or values. The so called “non-competitive bids” are irregular in that bidders only state the quantity that they want to trade; bidders do not state any bid prices for their irregular bids. The auction gives priority to these irregular bids, which normally come from small investors, and normally all irregular bids are accepted. Their transaction price is determined by bid prices from regular bids, such as the marginal regular bid or the average bid price of accepted regular bids. The number of irregular bids is normally uncertain when regular bids are submitted. This means that the remaining number of items that are available to regular bids is uncertain. Thus, we say that the auction has a shock or variation in the transacted quantity also in this case, even if this only applies to the transacted quantity of the regular bids.

Market orders in exchanges and auctions are similar to the irregular “non-competitive bids” in security auctions, in that market orders do not have a limit price; they are simply accepted as soon as possible at any price. The amount of incoming market orders is somewhat uncertain, so that the remaining number of items that are available to bidders that submit regular bids, such as limit orders becomes uncertain. Thus, we say that the auction has a shock or variation in the transacted quantity also in this case, even if this only applies to the transacted quantity of the regular bids, such as limit orders.

Other examples of auctions and markets with a shock or variation in the transacted quantity are for example discussed by Klemperer and Meyer (1989), Green and Newbery (1992), Holmberg and Newbery (2010), Vives (2011), Wilson (2008) as well as Wang and Zender (2002).

As shown by Klemperer and Meyer (1989), an advantage for the auctioneer with having a shock or variation in the transacted quantity is that it becomes more difficult for bidders to coordinate on equilibria with prices close to the reservation price. For this reason, Bourjade (2009) recommends that auctioneers should introduce uncertainty, randomization, in the rationing rule to increase the shock or variation in the transacted quantity.

### Aspects of the Invention and its Advantages

In our research activities, we have studied in detail how rationing rules, bidding formats and other details of the action design influence bidding behavior. This knowledge can for example be used to outline new auction designs that will result in more competitive bids, which would benefit the auctioneer and/or the society as a whole.

One aspect of our innovation that differs from prior art is that we have noticed that a rationing rule that depends on the marginal price can be used to improve competitiveness. One can use this to encourage bidders to submit more competitive bids by encouraging bidders to submit bids with higher bid quantities at prices far away from the reservation price. As illustrated by FIG. 8, this can be achieved by encouraging bidders to have large quantity increments at prices far away from the reservation price and (relatively) smaller quantity increments near the reservation price. Thus a rationing rule that gives priority to large quantity increments far from the reservation price and small quantity increments near the reservation price will normally result in more competitive bidding.

This and other aspects of our invention can also be explained by the price and quantity effect. The optimal bid price of a bidder is balanced by the price effect and the quantity effect. The price effect is the additional payoff of a bidder that results when it slightly moves the bid price for some units towards the reservation price under the assumption that acceptance of bids is unchanged. The quantity effect is the bidder's expected reduction in its transacted quantity that follows from this change in the bid curve. The bidder's loss associated with the quantity effect is given by the expected loss in payoff from its units that were expected to be accepted at old bid prices but expected to be rejected after the change in bid price.

Note that changing the bid for some units could also change acceptance for other units of quantity for the same bidder. FIG. 9 illustrates that increasing the bid price from Price 1 to Price 2 for some units in a supply curve will increase the bidder's quantity increment at Price 2 and reduce its quantity increment at Price 1. Depending on the rationing rule, this could change acceptance of any unit that is offered at Price 1 or Price 2, also for units with unchanged bids. Normally, there is one contribution to the loss associated with the quantity effect from quantity increments at Price 1 and another contribution to this loss from quantity increments at Price 2.

An auction design that strengthens the quantity effect and its associated loss will make the price effect relatively less attractive, so that bidders get incentives to submit more competitive bids, i.e. bids are closer to the bidder's true cost or value. In order to maximize the quantity effect for the case illustrated in FIG. 9, the rationing rule should disproportionately favor large marginal quantity increments at Price 1, where the bidder tentatively shortened its increment, and disproportionately favor small marginal quantity increments at Price 2, where the bidder tentatively increased its increment. Thus as explained in an alternative way above, bidding will become more competitive if more disproportionate priority is given to small marginal quantity increments at price levels closer to the reservation price. The same intuition would work for multiple price levels. In particular, it should be preferable to give small marginal quantity increments the highest possible priority at the reservation price, while it should be preferable to give large marginal quantity increments the highest possible priority at the price level that is furthest away from the reservation price. In some embodiments, the rationing rule would monotonically increase its priority to small marginal quantity increments as the marginal price gets closer to the reservation price.

We can illustrate the above by a simple example for a pay-as-bid procurement auction for a homogeneous good with two bidders, A and B. Assume that the auctioneer's demand for an item is 6 units and that it has the reservation price $3. To start with, each bidder offers a transaction schedule with the price-quantity pairs: 2 units at $1 and 6 units at $2, where each bid quantity is a maximum quantity that a bidder wants to sell at the associated bid price. For simplicity, assume that bidders can provide the units without any cost. In this case, bidders are rationed identically as they have identical bids and thereby identical quantity increments, so each bidder will sell 3 units, 2 units at $1 and 1 unit at $2. Thus each bidder gets a profit of $4. In aggregate, the auctioneer buys 4 units at the price $1 and 2 units at the price $2, which gives a total procurement cost of $8. The marginal price is given by the highest accepted bid, i.e. $2. Now suppose that Bidder B keeps its bid unchanged, but let's assume that bidder A increases its bid quantity at $1 by one unit to 3 units. It still offers 6 units at $2, so that its quantity increment at $2 is reduced from 4 units to 3 units. All infra-marginal units are accepted, so in aggregate this means that the auctioneer now buys 5 units at the price $1 and 1 unit at the price $2. This has lowered the procurement cost of the auctioneer to $7, so it would like to encourage bidder A to make this type of change in its supply curve. Now, consider two extreme rationing alternatives that the auctioneer could choose between at the marginal price $2. Alternative D gives disproportionate priority to long marginal quantity increments by accepting all marginal bids from the bidder with the longest marginal quantity increment before accepting any marginal bids from the other bidder. Thus after changing its supply curve, bidder A would not sell any units at $2 with such a rule. Its profit would be lowered to $2. Understanding this effect, a rational bidder would not change its supply curve in this way. Another rationing alternative E instead gives disproportionate priority to short marginal quantity increments by accepting all marginal bids from the bidder with the shortest marginal quantity increment before accepting any marginal bids from the other bidder. With such a rule Bidder A would sell 3 units at $1 and 1 unit at $2, so that its profit would increase to $5. Thus the extreme rationing alternative E that gives disproportionate priority to short marginal quantity increments at $2 would give bidders incentives to submit more competitive bids when the marginal price is $2.

By quickly going through a similar example for an auction with a marginal price at $1, we can also illustrate that a rationing rule that gives disproportionate priority to long marginal quantity when the marginal price is $1 would make bidding more competitive. Assume that the auctioneer's demand for an item is now 4 units. To start with, each bidder offers, as before, a transaction schedule with the price-quantity pairs: 2 units at $1 and 6 units at $2. Each bidder will now sell 2 units at $1 and 0 units at $2. Thus each bidder gets a profit of $2. In aggregate, the auctioneer buys 4 units at the price $1, which gives the total procurement cost $4. The marginal price is $1. Next, assume that bidder A increases its bid quantity at $1 by one unit to 3 units. This also increases the quantity increment of Bidder A from 2 units to 3 units at the marginal price $1. The auctioneer still buys 4 units at $1. All 3 units of Bidder A at $1 would be accepted under rationing alternative D. Thus its profit would increase to $3. But with rationing alternative E, bidder A would still sell 2 units at $1, so that its profit would be unchanged. Thus at the marginal price $1, the extreme rationing rule D that gives disproportionate priority to long marginal quantity increments would give bidders incentives to submit more competitive bids. In summary, the example illustrates that bidders get incentives to submit more competitive bids for a rationing rule that gives disproportionate priority to short quantity increments when the marginal price is at or near the reservation price and disproportionate priority to long marginal quantity increments at a marginal price far from the reservation price. Note that we have chosen very extreme rationing rules in this example to illustrate the effect. In practice, less extreme rationing rules are sometimes more appropriate—and are other embodiments of the current invention.

As argued above, the allocation of an optimal rationing rule would normally depend on whether the marginal price is considered to be high or low. However, a rationing rule that does not depend on the marginal price can still improve competitiveness of bids, but normally to a less extent. For example, if the expected contribution to the loss associated with the quantity effect is much larger at Price 1 than at Price 2, where Price 2 is closer to the reservation price, then the contribution from Price 1 dominates. A rationing rule could then focus on increasing the quantity effect at Price 1 by disproportionately favoring large marginal quantity increments. This would make bidding more competitive, even if the same rule is applied to both prices. This aspect of our invention is for example likely to be beneficial if the market is much more likely to clear at Price 1 than at Price 2, or if bids are much more competitive at Price 2, i.e. bids at Price 2 are closer to the true value/cost of the bidder, so that the bidder's payoff from acceptance of such bids is relatively small. Under these circumstances, we say that the contribution to the expected loss associated with the quantity effect is decreasing for price levels closer to the reservation price in a region around Price 1 and 2. The same argument can be made for a plurality of price levels.

If instead the expected contribution to the loss associated with the quantity effect is much smaller at Price 1 than at Price 2, where Price 2 is closer to the reservation price, then a rationing rule that disproportionately favors small marginal quantity increments would make bidding more competitive, even if it is applied to both prices. This aspect of our invention is likely to be beneficial if, for example, the market is much more likely to clear at Price 2 than at Price 1, or if bids are much more competitive at Price 1. In this case, we say that the contribution to the expected loss associated with the quantity effect is increasing for price levels closer to the reservation price in a region with Price 1 and 2. The same argument can be made for a plurality of price levels. What is considered to be a large or small quantity increment from a bidder could depend on the size of the bidder, for example in terms of trading capacity, transacted quantities in the past, production capacity, financial constraints, the total quantity (including infra-marginal quantity) that it is willing to trade at the marginal price or at a price closer to the reservation price. Thus for a disproportionate rationing rule it would sometimes be beneficial to normalize the bid quantities and/or quantity increments of a bidder with respect to a measurement of the bidder's size when deciding how large share of its marginal bids should be accepted. Such normalizations can also make the auction fairer, as it will often treat bidders of different sizes in a more similar way.

Given an aggregated transacted quantity, rationing between bidders on the same side of the auction can be performed by a rationing rule known from prior art or by new rationing rules introduced above and elsewhere in this patent application. If as illustrated in FIG. 12, the aggregate demand curve and aggregate supply curve from traders intersect in an interval of aggregated transacted quantities, then the cleared aggregated transacted quantity will also be decided by the rationing rule. In such cases, this part of the rationing rule can also be designed to make bidding more competitive, at least on one side of the auction. This can be achieved by using the rationing rule to increase the quantity effect on that side of the auction, i.e. such that a bidder on that side of the auction will sell less when it moves a bid towards the reservation price of its side of the auction. One would normally get this effect if the rationing rule chooses an aggregated transacted quantity that is closer to the minimum aggregated transacted quantity in the interval of possible aggregated transacted quantities when the marginal price is closer to the reservation price of that particular side of the auction. This is exemplified in FIG. 13, where the aggregated transacted quantity is rationed pro-competitively for supply curves from sellers. In particular, to improve competitiveness of the bids on one side of the auction, it should be preferable to choose the highest quantity in the interval of possible aggregated transacted quantities at the price that is furthest away from the reservation price of the considered side of the auction, and to choose the lowest aggregated transacted quantity in said interval at the reservation price of the considered side of the auction. This is another aspect of our invention where it would be of interest to let a rationing rule depend on whether the marginal price is considered to be high or low. A potential drawback with deciding the aggregated transacted quantity such that competitiveness would improve on one side of the auction is that competitiveness could potentially worsen on the other side, in case of a double auction. However, this would not be a problem if there are many bidders on that other side, so that bidding on that other side would be very competitive anyway. One such example is wholesale electricity market, where auctioneers are normally more concerned with competition on the production side than on the consumption side.

Another aspect of our invention is that the auctioneer can use the bidding format to create circumstances where the contribution to the expected loss associated with the quantity effect is either increasing or decreasing for price levels closer to the reservation price, or to strengthen such circumstances. As in FIG. 45, the bidding format could for example be used to encourage that quantity increments become smaller for price levels closer to the reservation price in some price interval, which would create a situation where the contribution to the expected loss associated with the quantity effect tends to decrease for price levels closer to the reservation price in that price interval. As discussed above, a rationing rule that disproportionately favours large marginal quantity increments would normally make bidding more competitive in such a price interval. Alternatively, as in FIG. 48, the bidding format could be used to encourage that quantity increments become larger for price levels closer to the reservation price. This would create a situation where the contribution to the expected loss associated with the quantity effect tends to increase for price levels closer to the reservation price; a situation where bidding would normally become more competitive for a rationing rule that disproportionately favours small marginal quantity increments.

Another aspect of our invention is that an auctioneer may want to focus on a region where the auctioneer is mostly concerned with competition. The advantage with a small region is that it is then possible to focus the power of changing the rationing rule and/or bidding format to give a larger effect on competitiveness in that specific region. A disproportionate rationing rule can then for example change from giving maximum priority to large marginal quantity increments to giving maximum priority to small marginal quantity increments in just a short price interval with a few permissible price levels, and such a large change increases the effect on competitiveness of bids in that short price interval. Similarly using the bidding format to encourage or force a bidder to change its quantity increment from one price level to the next in a short price interval with few price levels has a stronger impact on the bidding behavior than a similar change in a longer price interval with many price levels.

We want to stress that even if some aspects of our invention that relates to the bidding format may involve more restrictions on the bids, it does not necessarily make it more difficult for bidders to choose bids that represent their preferences. As long as bidders are allowed to make many bids, bids can often be chosen to approximate any monotonic bid curve. As an example FIG. 14 illustrates this for a case where bid prices get denser towards the reservation price.

Another aspect of our invention is that efficiency of the auction can be further improved if the auctioneer updates the bidding format and/or rationing rule with respect to auction relevant information. With this we mean that the bidding format and/or rationing rule depends on (is contingent on) auction relevant information. For example what is considered to be a low or high price could depend on predicted marginal price, such as the price in the previous auction, the marginal price in a previous round of the auction, or the forward/futures price of the same or related items in financial markets. Updating is particularly useful if aspects of our invention are mainly used to improve competiveness in a limited range, and when this range is updated to include the predicted marginal price and/or clearing quantity. Prices above the predicted marginal price could then be regarded as high prices and prices below the predicted marginal price could be regarded as low prices. Updating is also beneficial for an auctioneer that for each bidder wants to predict the contribution to its loss associated with the quantity effect for each price level. We know from the discussion above that such information can sometimes be used to optimize the rationing rule. The bidding format and/or rationing rule can be updated before the bids are submitted to the auction. In a dynamic auction, performance can be further improved if the auctioneer iteratively updates the bidding format and/or rationing rule with respect to bidders' bids in previous rounds and other information that has been received during the progress of a dynamic auction.

An exemplary rationing rule would combine several of the mentioned aspects. Such a rationing rule would be updated with respect to auction relevant information, it would depend on whether the marginal price is regarded to be high or low, it would normalize the bids from bidders with respect to the size of the bidders, and it would use disproportionate rationing in most circumstances. Disproportionate rationing as such is already known from the following publications: Gresik (2001); Kremer and Nyborg (2004); Yago Saez, David Quintana, Pedro Isasi and Asuncion Mochon (2007), but otherwise these are new aspects of rationing rules, which makes it possible to improve competitiveness of bids and effectiveness of auctions beyond what is known from prior art. As discussed later, a particular embodiment of our invention has, unlike prior art, disproportionate rationing rules with special monotonicity properties, which would often be desirable in practice. Simpler, but normally also less efficient, embodiments would use fewer aspects of our invention. In most cases, it would be ideal to only ration marginal bids, but we do not want to rule out other cases. Normalization of bid quantities with respect to the size of bidders can also be applied to other disproportionate rationing rules, such as the ones known from prior art, in order to make the auction fairer and sometimes also more efficient. Updating with respect to auction relevant information could also make such auctions more efficient.

To increase the effect of an exemplary rationing rule even further, it could be combined with aspects of the new bidding formats that we discuss above. One could also think of cases where a simplified embodiment that combines a new bidding format with a rationing rule that is known from prior art—such as pro-rata on the margin, time priority, or randomization—would improve competitiveness of an auction. Such a simplified embodiment of our innovation is partly known from the following studies of single object auctions: Esther David et al. (2007) and Zhen Li and Ching-Chung Kuo (2011; 2013), who also show that such embodiments can make bidding more competitive. However, aspects of our innovation go beyond their work also for simplified embodiments with rationing rules that are known from prior art. First, we note that updating of the bidding format with respect to auction relevant information can give a significant improvement of auction performance. Second, Esther David et al. (2007) and Zhen Li and Ching-Chung Kuo (2011; 2013) consider single object auctions, while we present embodiments of the bidding format, such as non-constant lot-sizes, that only have relevance for auctions trading a plurality of units.

Aspects of our invention are expected to be more powerful in auctions without a truth-telling mechanism. If an auction has a truth-telling mechanism, then bids would in theory already fully reveal the true values of buyers and the true costs of sellers, and bids cannot become more competitive than that. However, it is different in practice. If the set of permissible prices and quantities are discrete, which normally is the case in practice, then a bidder can normally not choose bids that exactly match its true preferences, even if it wanted to. This is for example illustrated by David, Rogers, Jennings, Schiff, Kraus, and Rothkopf (2007) in their analysis of an English auction (a second-price auction). They show that the bidding format matters for a discrete set of permissible price levels, even if second-price auctions have a truth-telling mechanism for a continuum of permissible prices, i.e. when the tick-size is infinitesimally small. In practice, a bidder may also not be sure of the cost of providing an item or the value of an item. In a dynamic auction, a bidder would then tend to learn of the cost/value from the bids of competitors, which makes its bidding behavior more complicated. Thus aspects of our invention could also be useful in auctions with a truth-telling mechanism, even if some aspects of our invention are likely to be less powerful there.

It is our belief that it would mainly be of interest to use aspects of our invention to improve competitiveness of bids in auctions. However, one could think of situations where an auctioneer may actually want to worsen competition. As an example, instead of increasing the tick-size in a financial exchange, an auctioneer may instead want to worsen competition in order to increase the price difference between active sell and buy bids. Similar to an increased tick-size, this would slow down trading in the exchange, which would increase the order depth; one aspect of liquidity. This could be achieved by giving priority to large quantity increments near the reservation price and small quantity increments far from the reservation price, which is the opposite of our preferred embodiment. Similarly, all of our suggestions above that would improve competition in the auction, could be used in the opposite way so that bids instead become less competitive.

We have said that aspects of our invention can be used to influence competitiveness of bids and to improve the perceived fairness of the auction. But we do not want to rule out that there can be other advantages with our embodiments apart from changed competitiveness of bids, such as reduced risk for the auctioneer or bidders, improved deterrence of collusion among bidders or other types of manipulations of the auction, more stable auction outcomes with less regret ex-post among the auctioneer and bidders, improved transparency, or reduced administrative or computational burden for the auctioneer and/or bidders. In one preferred embodiment, the present invention is a computer-implemented method for clearing a sealed-bid auction wherein the rationing rule is disproportionate on the margin and marginal bids are accepted monotonically. In a second preferred embodiment, the present invention is a computer-implemented method for clearing a sealed-bid auction wherein the rationing rule depends on the marginal price. In a third preferred embodiment, the present invention is a computer-implemented method for clearing a sealed-bid auction wherein the aggregate transacted quantity that is chosen by the rationing rule depends on the marginal price. In a fourth preferred embodiment, the present invention is a computer-implemented method for clearing a sealed-bid auction wherein there is some marginal price p0 such that the rationing rule favors large marginal quantity increments of some bidder. In a fifth preferred embodiment, the present invention is a computer-implemented method for clearing a sealed-bid auction wherein there is some marginal price p0 such that the rationing rule favors small marginal quantity increments of some bidder. In a sixth preferred embodiment, the present invention is a computer-implemented method for clearing a sealed-bid auction wherein the rationing rule is automatically updated with respect to auction relevant information with short notice. In a seventh preferred embodiment, the present invention is a computer-implemented method for clearing a sealed-bid auction wherein the rationing rule is automatically updated with respect to external auction relevant information. In an eighth preferred embodiment, the present invention is a computer-implemented method for clearing a sealed-bid auction wherein the rationing rule is automatically updated with respect to bid data and/or the bid submissions from previous bidding rounds. In a ninth preferred embodiment, the present invention is a computer-implemented method for clearing a sealed-bid auction wherein the rationing rule is automatically updated with respect to the number of bidders that are active in the auction and/or the number of bidders that have registered for the auction. In a tenth preferred embodiment, the present invention is a computer-implemented method for clearing a sealed-bid auction wherein the rationing rule is disproportionate and is normalized with respect to the size of some bidder at some price p0. In an eleventh preferred embodiment, the present invention is a computer-implemented method for clearing a sealed-bid auction wherein the marginal excess quantity of some bidder is normalized with respect to the size of that bidder in the rationing procedure at some price p0. In a twelfth preferred embodiment, the present invention is a computer-implemented method for clearing a sealed-bid auction wherein bidders' shares of the volume of marginal bids accepted/rejected by the auctioneer depends on the size of a bidder.

In other preferred embodiments, the present invention is a non-transitory machine readable medium storing one or more sequences of instructions which, when executed in a computer system, implements any of the twelve computer-implemented methods enumerated in the previous paragraph.

In other preferred embodiments, the present invention is a machine, a computer, a network, or a system that is capable of implementing any of the twelve computer-implemented methods enumerated two paragraphs above.

In one preferred embodiment, the present invention is a computer-implemented method for clearing a dynamic auction (such as a clock auction for one or more types of goods or a financial exchange) wherein the rationing rule is disproportionate on the margin and marginal bids are accepted monotonically. In a second preferred embodiment, the present invention is a computer-implemented method for clearing a dynamic auction (such as a clock auction for one or more types of goods or a financial exchange) wherein the rationing rule depends on the marginal price. In a third preferred embodiment, the present invention is a computer-implemented method for clearing a dynamic auction (such as a clock auction for one or more types of goods or financial exchange) wherein the aggregate transacted quantity that is chosen by the rationing rule depends on the marginal price. In a fourth preferred embodiment, the present invention is a computer-implemented method for clearing a dynamic auction (such as a clock auction for one or more types of goods or financial exchange) wherein there is some marginal price p0 such that the rationing rule favors large marginal quantity increments of some bidder. In a fifth preferred embodiment, the present invention is a computer-implemented method for clearing a dynamic auction (such as a clock auction for one or more types of goods or a financial exchange) wherein there is some marginal price p0 such that the rationing rule favors small marginal quantity increments of some bidder. In a sixth preferred embodiment, the present invention is a computer-implemented method for clearing a dynamic auction (such as a clock auction for one or more types of goods or a financial exchange) wherein the rationing rule is automatically updated with respect to auction relevant information with short notice. In a seventh preferred embodiment, the present invention is a computer-implemented method for clearing a dynamic auction (such as a clock auction for one or more types of goods or a financial exchange) wherein the rationing rule is automatically updated with respect to external auction relevant information. In an eighth preferred embodiment, the present invention is a computer-implemented method for clearing a dynamic auction (such as a clock auction for one or more types of goods or a financial exchange) wherein the rationing rule is automatically updated with respect to bid data and/or the bid submissions from previous bidding rounds. In a ninth preferred embodiment, the present invention is a computer-implemented method for clearing a dynamic auction (such as a clock auction for one or more types of goods or a financial exchange) wherein the rationing rule is automatically updated with respect to the number of bidders that are active in the auction and/or the number of bidders that have registered for the auction. In a tenth preferred embodiment, the present invention is a computer-implemented method for clearing a dynamic auction (such as a clock auction for one or more types of goods or a financial exchange) wherein the rationing rule is disproportionate and is normalized with respect to the size of some bidder at some price p0. In an eleventh preferred embodiment, the present invention is a computer-implemented method for clearing a dynamic auction (such as a clock auction for one or more types of goods or financial exchange) wherein the marginal excess quantity of some bidder is normalized with respect to the size of that bidder in the rationing procedure at some price p0. In a twelfth preferred embodiment, the present invention is a computer-implemented method for clearing a dynamic auction (such as a clock auction for one or more types of goods or a financial exchange) wherein bidders' shares of the volume of marginal bids accepted/rejected by the auctioneer depends on the size of a bidder.

In other preferred embodiments, the present invention is a non-transitory machine readable medium storing one or more sequences of instructions which, when executed in a computer system, implements any of the twelve computer-implemented methods enumerated in the previous paragraph.

In other preferred embodiments, the present invention is a machine, a computer, a network, or a system that is capable of implementing any of the twelve computer-implemented methods enumerated two paragraphs above.

Implementing our methods using a computer or even better using a computer network (as for example discussed in U.S. Pat. No. 4,789,928 by Fujisaki) has many advantages. It allows the auction to be conducted swiftly and reliably, even if bidders are not located on-site. As discussed in U.S. Pat. No. 8,335,738 by Ausubel, Cramton and Milgrom, the amount of information that is transmitted to the bidder computers and/or displayed to the bidders may be carefully controlled. It also facilitates updating the bidding format and rationing rule with respect to new information as it arrives.

To facilitate the distribution of a computer implemented version of aspects of our invention to auctioneers, exchanges, and brokers, data representing sequences of instructions that implements an auction with aspects of our invention when the sequence is executed by a computer or computer system, can be stored on a non-transitory machine-readable medium. We use the term non-transitory to clarify that we do not regard transitory signals as machine or computer readable mediums.

Finally, after the auction has been cleared, a dispatch process could potentially be used to automatically allocate resources among parties or processes in an industrial application, such as an electric power network, telecom/computer network, cloud resources in a computer network, the dispatch of vehicles in a transportation network, or to automatically deliver allocated items.

As of today, numbers used by computers and numbers communicated in networks are normally discrete, so that numbers have a restricted number of significant digits. As a consequence of this, the constraints in the bidding format that are discussed in this specification, such as that the “lot sizes” and “tick sizes” are discrete, are inherent in computer-implemented auctions. In addition, the discreteness of prices and quantities implies that the occurrence of ties and the need for rationing will be more frequent, and rationing decisions will be more important, than otherwise. Thus aspects of our invention show how auction performance can be improved under circumstances that are rooted in computer technology. In addition, many aspects of our invention, such as the new rationing rules, normalizations and updating, are calculation-intensive in nature.

### BRIEF DESCRIPTION OF THE DRAWINGS

FIG. 1: Permissible price levels for bids to sell are illustrated by horizontal lines. The reservation price is the highest permissible price for bids to sell. Another permissible price and one tick-size are singled out as examples. Tick-sizes are constant here, which is known from prior art.

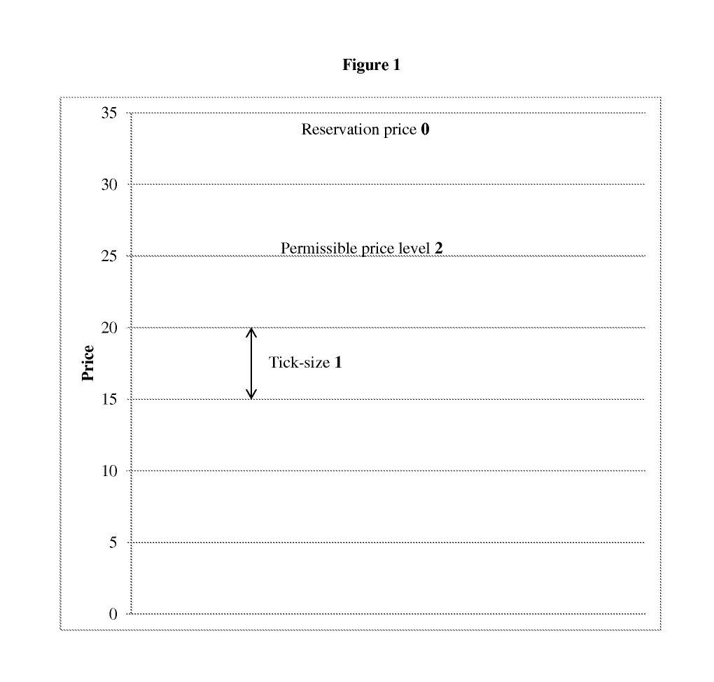

FIG. 2: Permissible quantity levels are illustrated by vertical lines. One permissible quantity and one lot-size are singled out as examples. Lot-sizes are constant here, which is known from prior art.

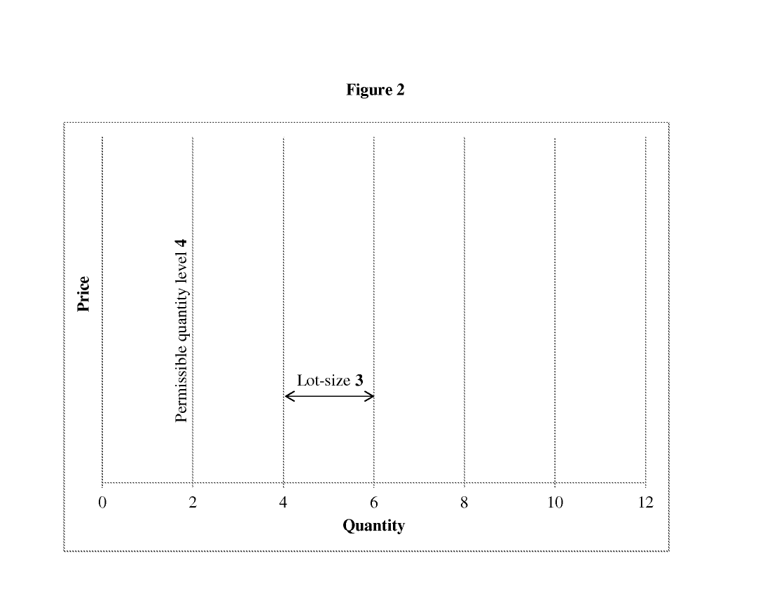

FIG. 3: Example of a stepped supply curve. Stepped supply curves are known from prior art.

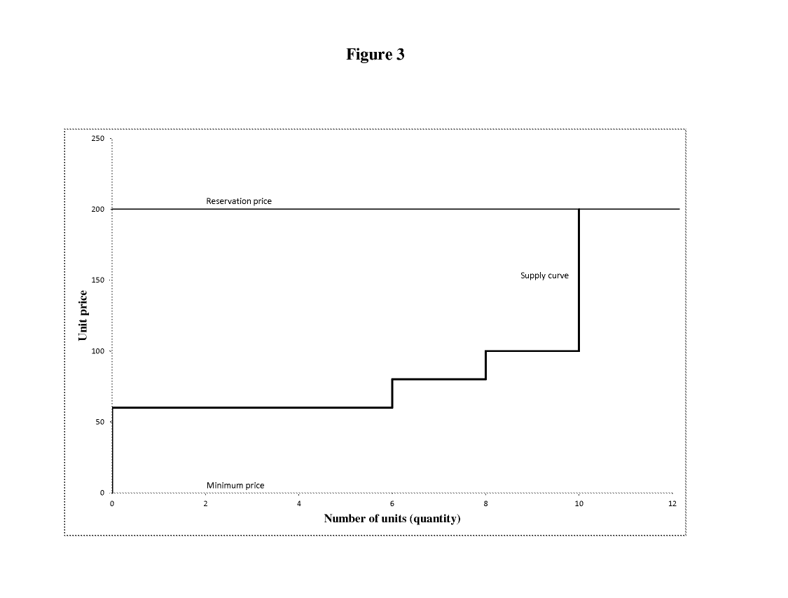

FIG. 4: Illustration of the marginal quantity increment of a bidder.

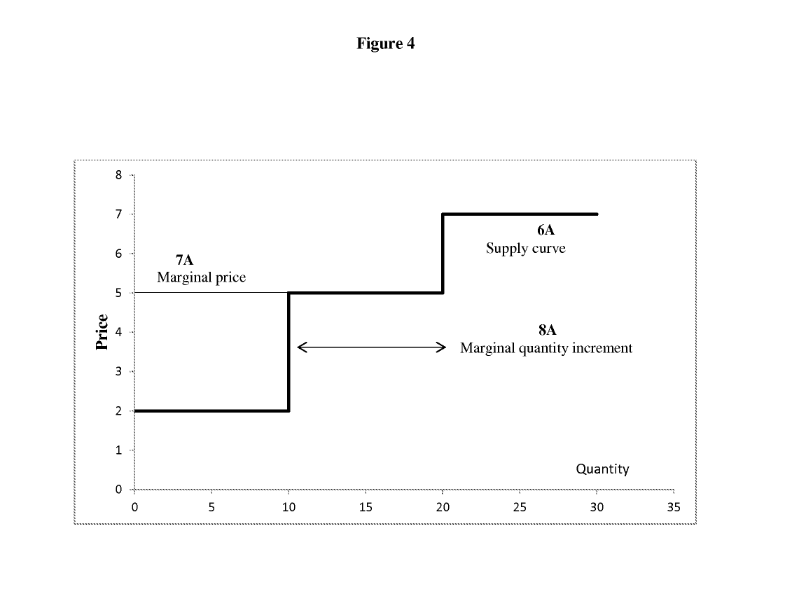

FIG. 5: Example of outcome where bidders' marginal quantity increments are rationed proportionally (pro-rata), which is known from prior art.

FIG. 6: Example of outcome where the rationing rule disproportionately favours bidders with small marginal quantity increments.

FIG. 7: Example of outcome where the rationing rule disproportionately favours bidders with large marginal quantity increments.

FIG. 8: Competition in an auction can be improved by encouraging large quantity increments far from the reservation price and small quantity increments near the reservation price.

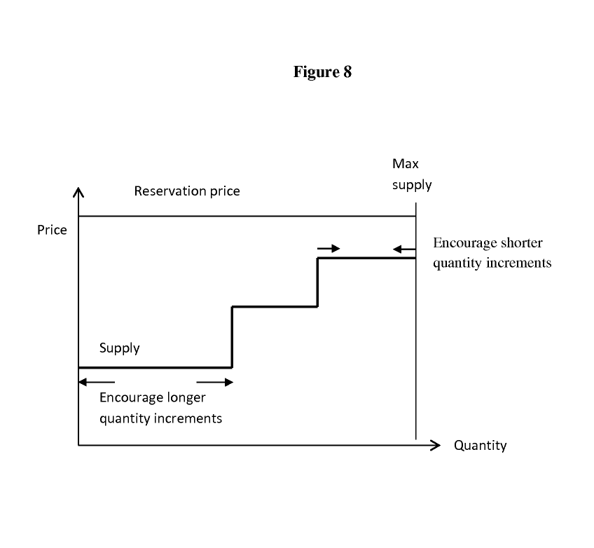

FIG. 9: Illustration of changes in a bidder's quantity increments when it changes the bid price for some bid quantities in its supply schedule.

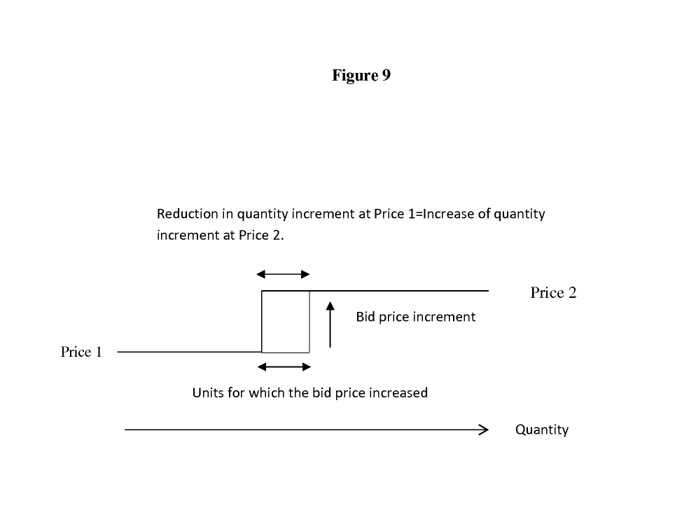

FIG. 10: Example of a stepped demand curve. Stepped demand curves are known from prior art.

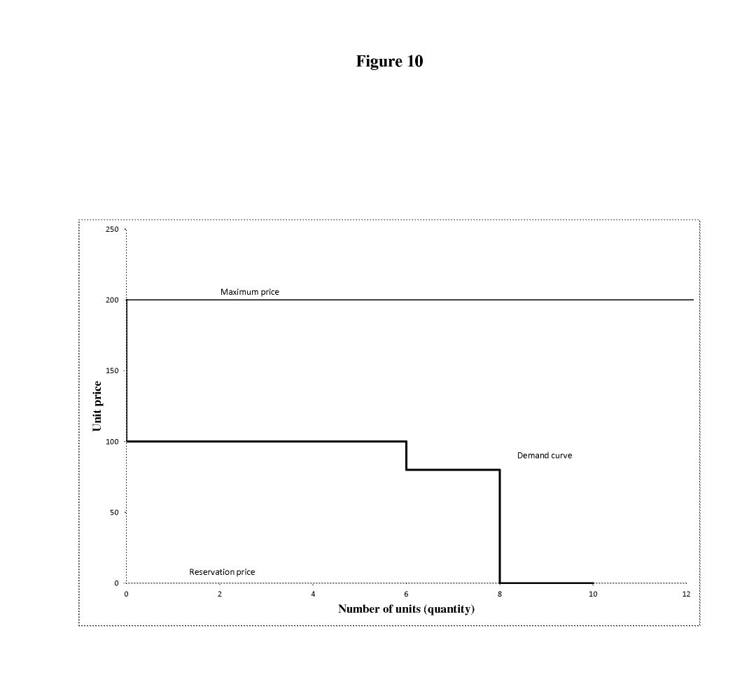

FIG. 11: Example with excess supply at the marginal price, so that rationing is needed to clear the auction. Excess supply at the marginal price is known from prior art.

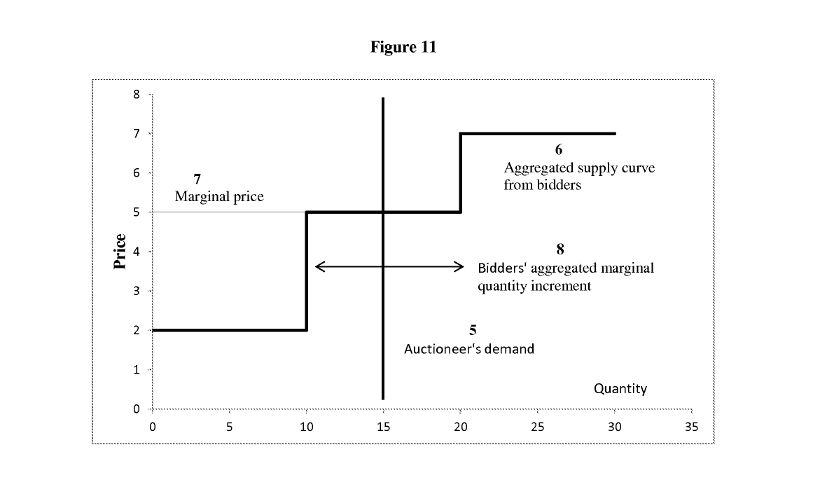

FIG. 12: Example where the aggregated stepped supply curve intersects the aggregated stepped demand curve in an interval of quantities. Similar examples are known in prior art.

FIG. 13: Example with two outcomes where the aggregated transacted quantity is rationed pro-competitively for sellers.

FIG. 14: The graph illustrates that, even if bid prices for bids to sell get denser towards the reservation price, they can still be used to approximate any monotonic supply curve.

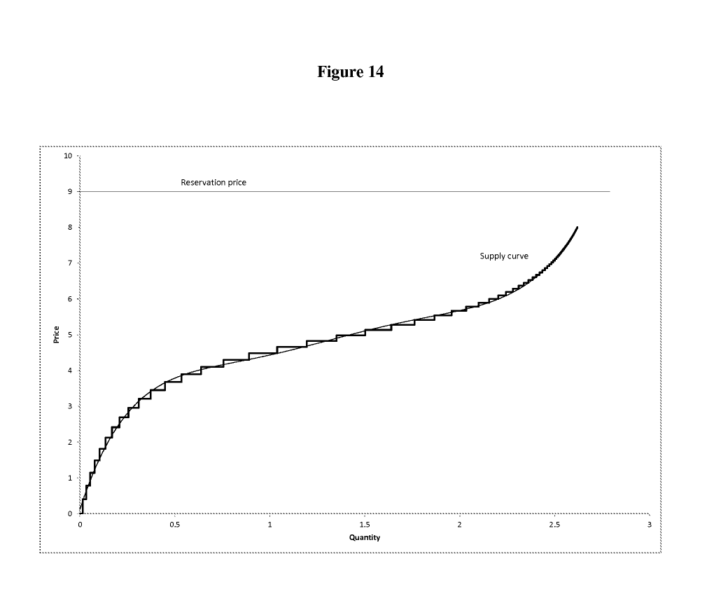

FIG. 15: Example of an auction computer system: a network that connects an auction computer, bidder computers and an auctioneer computer.

FIG. 16: Example of components inside an auction computer, when it is a single computer.

FIG. 17: Example of data stored on a data storage device of an auction computer when it is a single computer.

FIG. 18: Another example of data stored on a data storage device of an auction computer when it is a single computer.

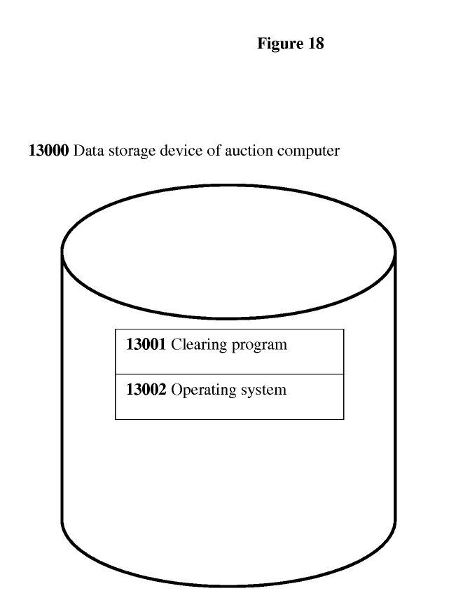

FIG. 19: Example of data stored on a non-transitory machine readable medium.

FIG. 20: Example with bidder client program stored on a non-transitory machine readable medium.

FIG. 21: Example of data and programs stored in the memory of an auction computer.

FIG. 22: Another example of data and programs stored in the memory of an auction computer.

FIG. 23: Example of auction data stored in the memory of an auction computer.

FIG. 24: Example of components inside the auctioneer computer when it is a thin client.

FIG. 25: Example of components inside a bidder computer when it is a thin client.

FIG. 26: Another example of components inside a bidder computer.

FIG. 27: Example of data and programs stored in the memory of a bidder computer.

FIG. 28: Example of structure of the auction process, some of its subprocesses and how they interact.

FIG. 29: Example of flow chart for a static auction.

FIG. 30: Example of flow chart for a dynamic auction.

FIG. 31: Example of flow chart for a dynamic auction where bids are cleared repetitively.

FIG. 32: Example of flow chart for a dynamic auction where the bidding format is updated.

FIG. 33: Flow chart illustrating clearing process.

FIG. 34: Flow chart illustrating rationing procedure for one side of the auction.

FIG. 35: Alternative rationing procedure.

FIG. 36: Alternative rationing procedure.

FIG. 37: Alternative rationing procedure.

FIG. 38: Example of share process which determines each bidder's share of an increment in the auctioneer's accepted volume.

FIG. 39: Example of flow chart for a dynamic auction where allocated items are automatically dispatched or prepared for dispatch.

FIG. 40 Example of flow chart for a simple auction process without automatic verification that bids satisfy the bidding format and without automatic information disclosure to bidders.

FIG. 41: Example of flow chart for a bidder client.

FIG. 42: Example of flow chart for a bidder client in an auction, which could have a plurality of bidding rounds.

FIG. 43: Example of flow chart for a bidder client in a dynamic auction, where bids are cleared repetitively.

FIG. 44: One embodiment with denser price levels towards the reservation price, so that bid prices become denser towards the reservation price. In addition to the reservation price, another permissible price and one tick-size are singled out as examples.

FIG. 45: One embodiment with denser quantity levels as the quantity increases. One permissible quantity level and one lot-size are singled out as examples.

FIG. 46: Example where denser bid prices towards the reservation price are not driven by permissible price and quantity levels.

FIG. 47: One embodiment that combines denser permissible price levels with denser permissible quantity levels.

FIG. 48: One embodiment with sparser quantity levels as the quantity increases. One permissible quantity level and one lot-size are singled out as examples.

FIG. 49: One embodiment where quantity increments tend to decrease towards the reservation price in a specific region, which could create a situation where the contribution to the expected loss associated with the quantity effect is decreasing for price levels closer to the reservation price in that region.

FIG. 50: Example where bid constraints are imposed on the price and quantity index of multiple heterogeneous items.

### DETAILED DESCRIPTION OF PREFERRED EMBODIMENTS

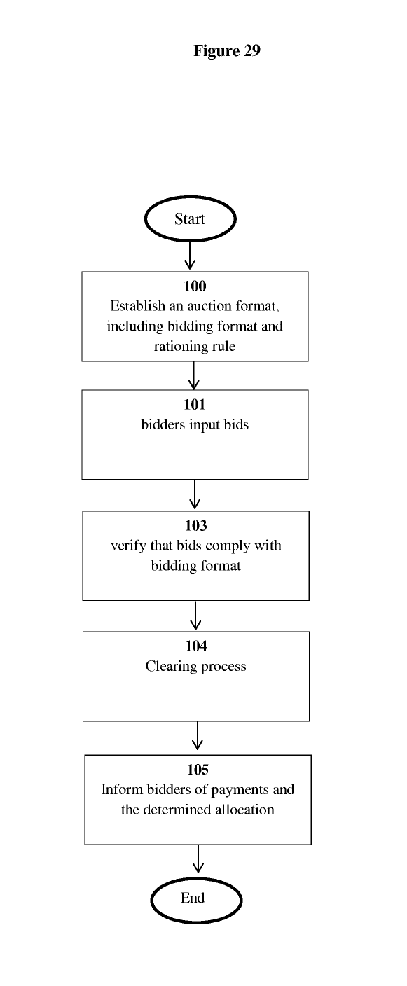

In a preferred embodiment, the auctioneer uses an auction process that conducts a partly or fully automatic auction with aspects of our invention on behalf of the auctioneer. An auction process could receive bids and manage market clearing for a plurality of item types. However, if the bids and clearing processes are independent for different types of items, then we can separate bid management and the clearing processes into a separate auction process for each type of item. In principle the auction process could execute all tasks of the auctioneer. An auction process could, for example, execute the operations illustrated in our flow charts, such as FIG. 29 to FIG. 32.

The flow chart in FIG. 29 illustrates the operation of a static (single bidding round) auction when a preferred embodiment of our invention is applied to such an auction. The first step in the process is to initialize the auction, such as establishing an auction format, including a bidding format and rationing rule. Normally, this step also defines the number of units that are to be traded in the auction and their characteristics. This initial step may also involve registration of bidders and their characteristics.

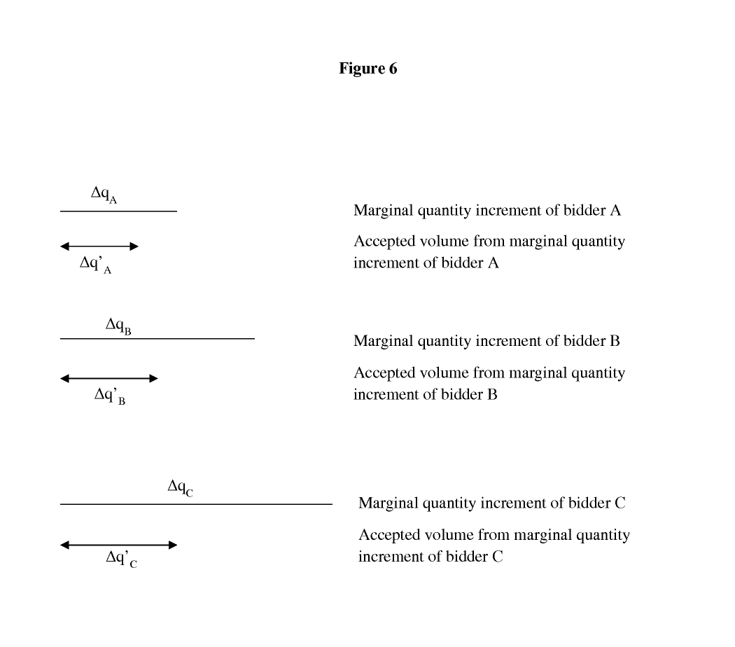

The second step (101 in FIG. 29), in the exemplified single bidding round auction is that one or more bidders input their bids, or are given an opportunity to input their bids. The next step 103, verifies that bids comply with the bidding format. This normally involves a verification that submitted bid prices have been selected from permissible prices, bid quantities have been selected from permissible quantities and that bids do not violate a monotonicity constraint or activity rule. As an example, FIG. 6a of U.S. Pat. No. 7,899,734 by Ausubel, Cramton and Jones illustrates a process, which verifies that bids comply with an activity rule and other bid constraints. If a bid does not comply with the bidding format, the bidder could be informed of this and be given an opportunity to resubmit its bid, or the bid could simply be neglected. Alternatively the bid might be accepted if the bidder pays a fine. U.S. Pat. No. 7,062,460 by Growney and Youssi for example discusses an auction where bidders are allowed to bid for sublots, i.e. volumes smaller than the lot-size, if they pay an extra price. In their case the additional cost reflected the higher transaction cost with trading sublots, while in our case the fine would be used to motivate bidders to submit bids that would enhance performance of the auction.

The next step 104 is a clearing process. It calculates an allocation of auctioned units based on the bids that have been received from bidders. A preferred embodiment of our invention uses rationing aspects of our invention whenever there are ties in the auction. Such a rule uses disproportionate rationing on the margin such that bidders' incentives to submit competitive bids increases. As an example, the rationing rule could be more disproportionately favourable to small marginal quantity increments at price levels closer to the reservation price. Preferably, the rule would combine different aspects of our invention to make bids as competitive as possible. Thus the rationing rule would for example be updated with regard to auction relevant information, the allocation would depend on whether the marginal price is high or low, the rationing rule would take the size of the bidder into account (normalization with respect to the size of the bidder). To strengthen the power of the rule even further, it could be combined with aspects of our new bidding format to improve competiveness of bids even further. It is not necessary, but the accepted quantity for each bidder might be rounded to quantities that are permissible for bidders. If bids were not sufficiently attractive, one possible allocation is that one or more units stay with the original owner (e.g. a bidder or the auctioneer). In the next step 105, bidders are informed of the allocation and the payment outcome. Similar to prior art, this step (and corresponding steps in our other embodiments) may also involve a settlement procedure, which ensures that each allocated item is delivered against a payment of the transaction price.

We present sequential processes in our flow charts, but this does not rule out that some of these tasks could be conducted in parallel. This would normally speed up the operation of the auction. This would be an advantage in dynamic auctions, especially for continuous trading, such as financial exchanges, where it is sometimes critical that clearing of the auction is as quick as possible. In case of an auction with a plurality of bidders there could for example be several parallel processes, bidder clients, that manage the auction process' communication with bidders and that verifies that bids comply with the bidding format. This would primarily correspond to steps 101 and 103 in case of a single bidding round auction. This means that bids can be received simultaneously from several bidders. Parallel communication processes with bidders may not be synchronized. As an example, in case of a single bidding round auction, one parallel process could be at step 101 with one bidder while another parallel process is at step 103 for another bidder.

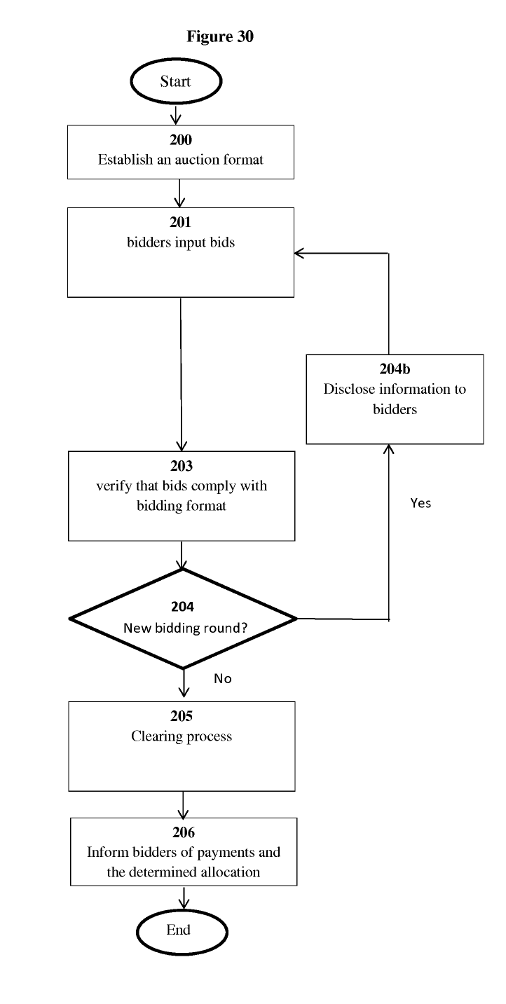

FIG. 30 illustrates the flow chart of a dynamic auction when a preferred embodiment of our invention is applied to such an auction. The main difference to the static (single bidding round) auction in FIG. 29 is that there is a new step 204 that checks whether there should be a new bidding round. This step could for example check whether the bids received are sufficient to clear the auction or to check whether the predetermined number of bidding rounds has been achieved. An auction may also close at a specified time. The auction process can also decide not to have additional bidding rounds if no or too few bids were received in the previous bidding round or if too few bidders submitted bids. It could also be that the auction ends for bidders that have not been sufficiently active, while other bidders can continue to bid in the new bidding round. If there is a new bidding round, the auctioneer may in step 204b choose to disclose new auction relevant information to the bidders before new bids are submitted in this new round. Such information could for example be characteristics of bids in previous rounds, such as all bids or aggregated bid information. The same information could be disclosed to all bidders, or bidders could get different information. U.S. Pat. No. 8,335,738 by Ausubel, Cramton and Milgrom discusses in greater detail what type of information an auctioneer may want to disclose in a clock auction and similar auctions. U.S. Pat. No. 8,489,493 by Nager briefly discusses information that exchanges may want to disclose to bidders. Existing financial markets sometimes allow bidders to give display instructions when submitting a bid. Thus how much information is disclosed to bidders may also depend on instructions from the bidders. Next, steps 201-203 are repeated, where bidders are given the opportunity to input new bids and the auction process verifies that they comply with the bidding format. In some embodiments of step 201, bidders could also choose to withdraw, alter or cancel bids that have been submitted in previous bidding rounds. Bids may also expire automatically, for example in case they have some type of time limit.

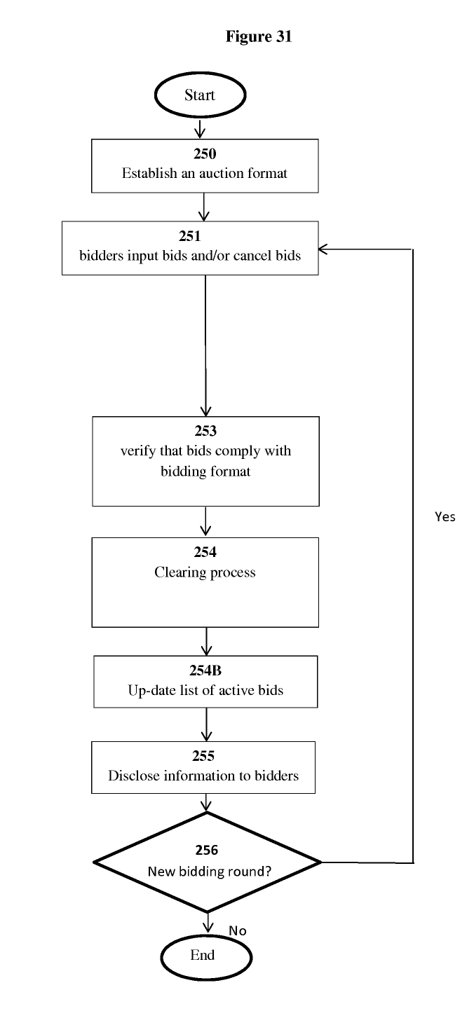

In a more general auction, the auction may determine the allocation for some units (called clinching in clock auctions), before all units have been cleared. Such an embodiment could also of interest for an exchange with continuous trading. Such an example is illustrated by the flow chart in FIG. 31 where a partial or full allocation decision could be made in step 254. After parts of a bid quantity or quantity increment have been accepted, those parts would normally be removed from the active bids. This is done in step 254B. Similar to some existing financial markets, step 254B, may also involve activation of a bid that was submitted in a previous bidding round. Similar to some existing financial markets, activation may for example occur at a time specified by the bidder or for market conditions (such as a price level or a direction of price movement) specified by the bidder. In an alternative embodiment, active bids could instead be updated inside the clearing process. In another embodiment, up-dating of active bids may instead occur just after step 251 or as a part of step 251. Bidders are informed of the allocation in step 255. In embodiments for auctions where speed is an issue, such as for financial exchanges, allocation decisions and communication of them to bidders would in some embodiments run parallel with processes that receive new bids from bidders. Step 256 decides whether to continue the auction with more bidding rounds. The auction may stop for reasons similar to the ones discussed for step 204 in FIG. 30. Similar to some existing financial markets, the auction may also decide to take a break (trading halt) in step 256, for example if there has been extraordinarily large movements in bid prices and/or clearing prices in the last round(s) or if critical market news are expected for the traded item(s).

Normally, all or parts of a bid quantity or quantity increment that are associated with a bid price that is furthest away from the reservation price would be accepted first. Thus bid quantities and/or quantity increments are first accepted from sellers with the lowest bid prices. Similarly, bid quantities and/or quantity increments are first accepted from buyers with the highest bid prices. Step 256 decides whether it is going to be a new bidding round. If so, the auction could then continue to receive new bids and/or clear the remaining number of active bids.

In a bidding round, the auctioneer may allow bids from all bidders or from a restricted number of bidders, such as the first bidder that submits a bid. Some of the bids may be intra-round bids, be submitted as flexible information to a proxy agent or be submitted from a proxy agent. Bidding rounds could be discrete with a specified time period of each round or bidding could occur continuously. Note that a static (single bidding round) auction, e.g. as in FIG. 29, could be considered as being a special type of dynamic auction, where the number of bidding rounds has been set to one. Thus, normally the embodiments that we discuss for dynamic auctions are also applicable to degenerate dynamic auctions with one bidding round, i.e. a static auction.

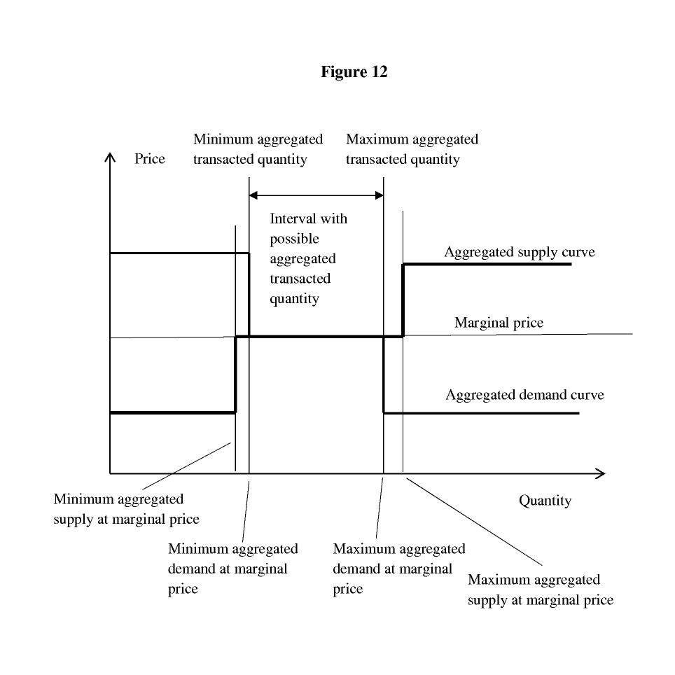

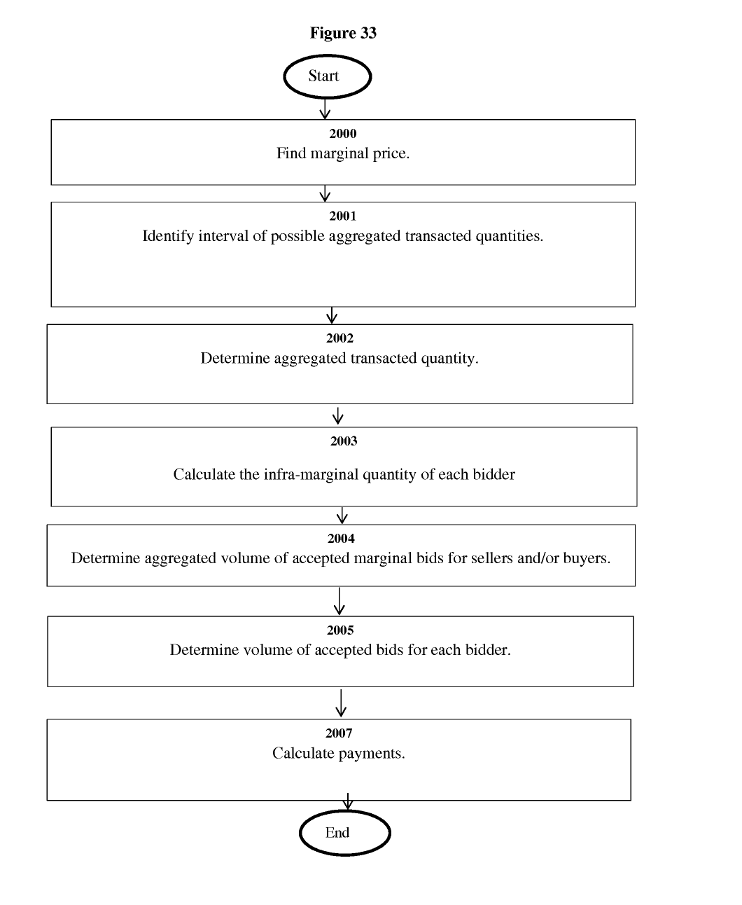

The flow chart in FIG. 33 describes one detailed embodiment of the clearing process for an item. It could for example be used in step 104 in FIG. 29, step 205 in FIG. 30, step 254 in FIG. 31 and in corresponding steps of other embodiments. The clearing process could be more complicated in combinatorial auctions. The first step 2000 calculates the marginal price, where aggregate supply from traders intersects with the aggregate demand from traders. At the marginal price, maximum aggregate demand of traders is weakly larger than minimum aggregate supply of traders. Moreover, maximum aggregate supply of traders is weakly larger than minimum aggregate demand of traders at this price. There is normally a unique such price if supply is strictly increasing with respect to an increasing price and demand is strictly decreasing with respect to an increasing price. In case there are a plurality of possible marginal prices, the auction format will use some rule to set the marginal price, e.g. at the highest possible clearing price or the lowest possible clearing price. In such cases, marginal price could differ for sellers and buyers in a double auction. Note that here and elsewhere in the specification and claims, we use “weakly” to stress that we are discussing a weak inequality. We use “strictly” here and elsewhere in our specification and claims to explain that we are discussing a strict inequality. Thus a strictly increasing or strictly decreasing function could not be constant in some price range. The second step 2001 determines possible aggregated transacted quantities at the marginal price. This would be an interval of quantities if aggregate supply intersects with aggregate demand in an interval of quantities at the marginal price. As illustrated in FIG. 12, the lowest possible aggregated transacted quantity at the marginal price is the largest value of the minimum aggregated demand and minimum aggregated supply at the marginal price. The highest possible aggregated transacted quantity is given by the lowest value of the maximum aggregated demand and the maximum aggregated supply at the marginal price. In some embodiments it would be natural to integrate step 2000 and 2001 in FIG. 33 into one joint task. In one-sided auctions, where bidders are either buyers or sellers, not both, the aggregated transacted quantity is often straightforwardly given by the quantity that the auctioneer wants to transact, unless this quantity depends on the price.

In the third step 2002 in FIG. 33, a rationing rule is used to determine the aggregated transacted quantity, if the maximum aggregated transacted quantity is strictly larger than the minimum aggregated transacted quantity at the marginal price. The rule in step 2002 could choose the maximum aggregated transacted quantity, the minimum aggregated transacted quantity, or anything in between. To improve competition on one side of the auction, an exemplary embodiment would choose the aggregated transacted quantity in a pro-competitive way. In this case, the chosen aggregated transacted quantity would be relatively closer to the minimum aggregated transacted quantity when the marginal price is closer to the reservation price of the considered side of the auction. One possible embodiment would for example be that

Q^{agg}=Q^{agg}ₘᵢₙ+k(p)*(Q^{agg}ₘₐₓ−Q^{agg}ₘᵢₙ,

where Q^{agg} is the chosen aggregated transacted quantity at the marginal price p, Q^{agg}ₘᵢₙ is the minimum aggregated transacted quantity at the marginal price, Q^{agg}ₘₐₓ is the maximum aggregated transacted quantity at the marginal price, and the function k(p) returns a number between 0 and 1. In one pro-competitive embodiment, k(p) decreases towards the reservation price of the considered side of the auction. To get a large impact on competitiveness, there would be advantages with setting k(p) to zero at the reservation price of the considered side of the auction. For similar reasons, there are advantages with setting k(p) equal to one at the permissible price that is furthest away from the reservation price of the considered side of the auction. It is not necessary, but as an example, k(p) could decrease linearly. Thus a possible embodiment would be:

k(p)=(p^{res}−p)/(p^{res}−p^{far-res}),

where p^{res} is the reservation price of the considered side and p^{far-res} is the permissible price that is furthest away from the reservation price of the considered side. In more complicated cases, the rationing rule could be pro-competitive for one side of the auction in some region of prices and quantities, where the auctioneer might be particularly concerned about competitiveness of bids, and pro-competitive for the other side of the auction in another region of prices and quantities, where the auctioneer is also particularly concerned with competitiveness of bids. Thus in an alternative embodiment, k(p) could be increasing in some price intervals and decreasing in other intervals.

All infra-marginal quantities are accepted in a preferred embodiment of the clearing process. The infra-marginal quantity of each bidder is calculated in step 2003 in FIG. 33 for the considered side of the auction. But in alternative embodiments, this can be done anywhere after the marginal price is determined in step 2000 and before the aggregate accepted volume of marginal bids is calculated in step 2004. The step 2004 determines the aggregate volume of marginal bids that is to be accepted from sellers and/or buyers. For sellers, this volume is given by the difference between the aggregated transacted quantity and the aggregated infra-marginal quantity of sellers. For buyers, this volume is given by the difference between the aggregated transacted quantity and the aggregated infra-marginal quantity of buyers. In FIG. 33, the step 2005 uses a rationing process to determine the volume of marginal bids that is accepted from each seller and buyer, respectively. The accepted quantity from a seller is then calculated by adding its accepted volume of marginal bids to the infra-marginal quantity of the seller. Similarly, the accepted quantity from a buyer is calculated by adding its accepted volume of marginal bids to the infra-marginal quantity of the buyer. The step 2007 calculates payments. In a uniform-price auction, this is done by multiplying the transacted quantity of a bidder by the marginal price. However, as discussed in more detail earlier in the specification, the payment and the calculation of the payment will differ depending on the auction format. Also note that this is just one example of a possible embodiment of the allocation process. It is possible to change the order of some steps. Some steps could also be executed in parallel.

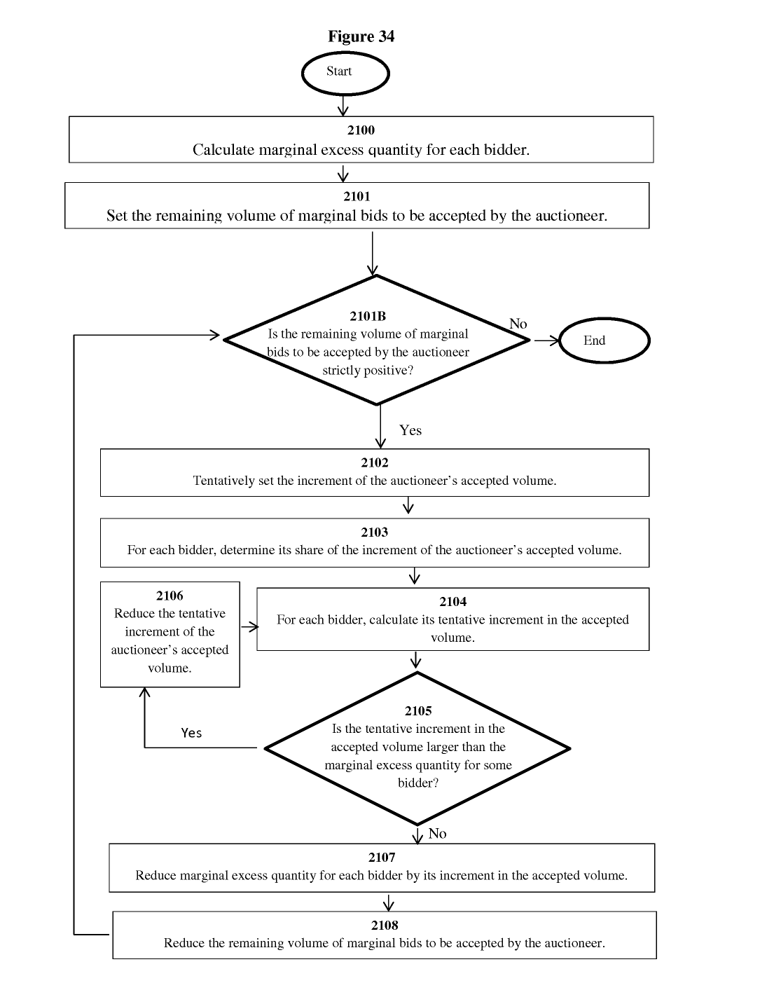

FIG. 34 presents an example of a rationing process, which for example could be used as a part of step 2005 in the clearing process outlined in FIG. 33. It determines how bidder's marginal bids could be rationed in a repeated process for one side of the auction. We refer to the quantity that a bidder is willing to transact at the marginal price, but which has not yet been accepted, as the marginal excess quantity. For sellers this would correspond to an excess supply, while it is called excess demand for buyers. The first step 2100 is to calculate the initial marginal excess quantity for each bidder on the considered side of the auction. A preferred embodiment would accept all infra-marginal quantities. In this case the initial marginal excess quantity of a bidder is given by the marginal quantity increment of the bidder. In the next step 2101, the aggregated volume of marginal bids that remains to be accepted by the auctioneer on the considered side of the auction is calculated. This is given by the aggregated transacted quantity minus the aggregated infra-marginal quantity for the considered side of the auction. In an alternative embodiment, steps 2100 and 2101 could be executed in reverse order, or in parallel processes. One could also think of embodiments where step 2100 is even later in the sequence, but not after step 2105. Step 2101B checks whether the remaining aggregate volume of marginal bids that is to be accepted by the auctioneer is strictly positive for the considered side of the auction, if so the rationing procedure continues to accept marginal bids, otherwise the rationing procedure ends. The step 2102 sets a tentative increment in the aggregated accepted volume of the auctioneer for the considered side of the auction. Normally it would be less than or equal to the aggregated volume of marginal bids that remains to be accepted by the auctioneer. In principle the tentative increment could be set infinitesimally small. This would ensure that the tentative increment is not too large, so that the check in step 2105 could be omitted. This could simplify the rationing process from a theoretical viewpoint. For example it would in some circumstances be possible to determine the accepted volumes from marginal bids from a solution of a set of differential equations. As discussed later, another advantage with setting a sufficiently small increment in the aggregated accepted volume of the auctioneer is that it under some circumstances would ensure that the acceptance and rejection for the rationing rule satisfy certain monotonicity properties, which are not known from disproportionate rationing rules in prior art. On the other hand, in practice a small increment could also slow down the rationing process, as a small increment would normally increase the number of iterations in the rationing process. As another example, a somewhat related iterative rationing procedure by Gresik (2001), which is used for ξ-rationing, sets the tentative increment in the aggregated accepted volume of the auctioneer equal to the aggregated volume of marginal bids that remains to be accepted by the auctioneer. Anything between these two extremes is also a possible embodiment.

Step 2103 runs a share process, where each bidder's share of the tentative increment in the aggregated accepted volume of the auctioneer is calculated. Bidders with no marginal excess quantity for the considered side of the auction would normally have no share of the increment in the aggregated accepted volume of the auctioneer. Alternative embodiments are possible in case bidders' shares do not depend on the size of the tentative increment in the aggregated accepted volume of the auctioneer. Three such alternative embodiments are: 1) Step 2103 could be conducted before step 2102, or in a process parallel to this step. 2) Step 2103 could sometimes also be conducted parallel with step 2101B. 3) Step 2103 could also be executed after marginal excess quantities have been calculated in steps 2100 and 2108. In an exemplary embodiment, bidders' shares of the increment in the aggregated accepted volume of the auctioneer depend on bidders' marginal excess quantities. Thus in exemplary embodiments, bidders' shares of the increment in the aggregated accepted volume of the auctioneer are calculated after marginal excess quantities have been calculated.

The step 2104 in FIG. 34 tentatively calculates the increment in the accepted volume for each bidder on the considered side of the auction. This increment is given by the product of the tentative increment in the aggregated accepted volume of the auctioneer and a bidder's share of this increment. One could also think of more advanced embodiments, where the calculation of bidders' shares and the tentative increment of the auctioneer's accepted volume are interlinked and have to be determined jointly in one step, which, in addition, may also determine the tentative increment in the accepted volume of each bidder. In case of a double auction, the rationing processes of both sides of the auction could be interlinked.

Step 2105 checks whether the tentative increment in the accepted volume of some bidder is larger than its marginal excess quantity. This would mean that the auction process is trying to accept a larger volume of marginal bids from some bidder than this bidder has submitted. In this case, one possible embodiment is to reduce the tentative increment in the aggregated accepted volume of the auctioneer, as in step 2106. After that steps 2104 and 2105 can be repeated. To speed up the process, the calculations could also be organized such that the increment in the aggregated accepted volume of the auctioneer and bidders' shares of it are already from the start chosen such that the increment in the accepted volume of a bidder never exceeds its marginal excess quantity. In particular there could be cases where an expression is used to directly calculate acceptance of marginal bids for each bidder without any iterations. In this case, many of the steps in FIG. 34 could be omitted.

Let's continue with describing the embodiment in FIG. 34. After it has been verified that there is no bidder such that its tentative increment in the accepted volume exceeds its marginal excess quantity, then, in step 2107, the accepted volume for each bidder is increased by its tentative increment and its marginal excess quantity is reduced by the same amount. In step 2108, the remaining aggregate volume of marginal bids that is to be accepted by the auctioneer is reduced by the tentative increment in the aggregated accepted volume of the auctioneer. Steps 2107 and 2108 could also be executed in reverse order or in parallel processes. Next the rationing procedure is repeated from step 2101B, which again checks whether the remaining aggregate volume of marginal bids that is to be accepted by the auctioneer is strictly positive.

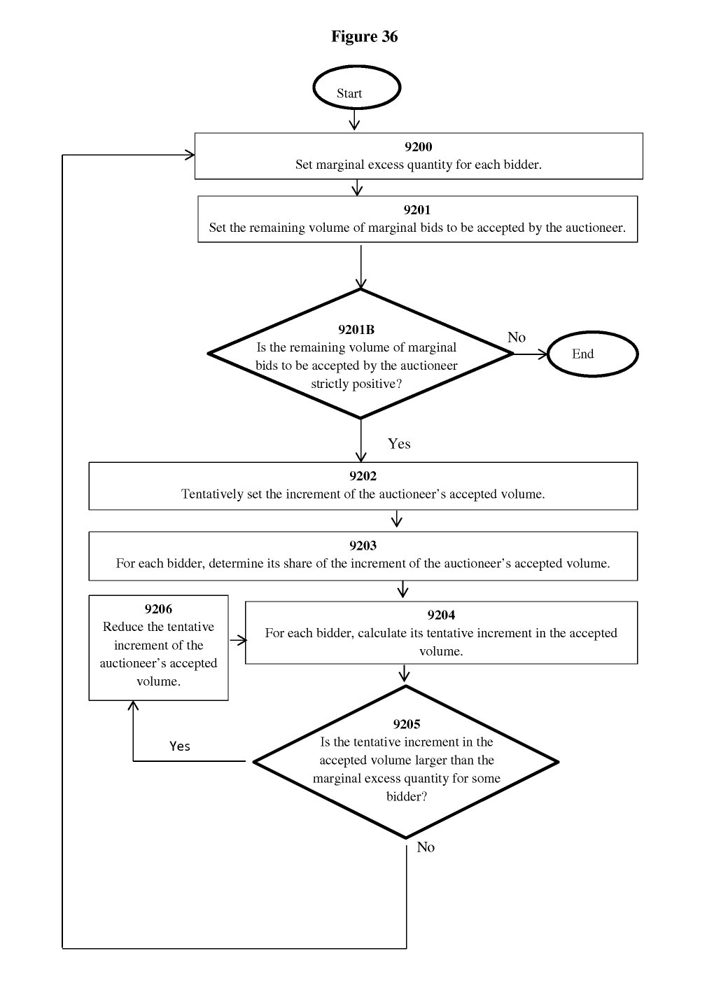

It can be noted that steps 2100 and steps 2107 in FIG. 34 are similar. Thus, they can be combined in a more compact embodiment of the rationing procedure illustrated in FIG. 36. In addition, steps 2101 and 2108 are similar, so these steps are also integrated in the alternative embodiment.

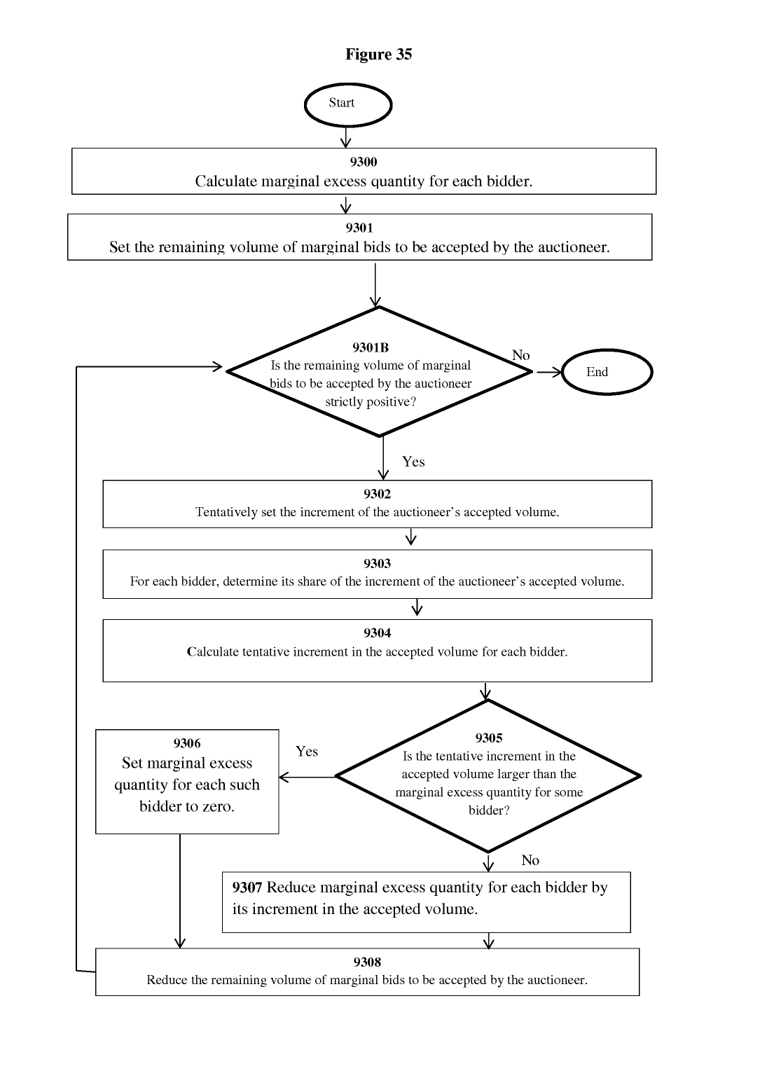

An alternative embodiment of the rationing process is presented in FIG. 35. This embodiment uses a rationing procedure that is somewhat similar to a related iterative rationing procedure by Gresik (2001), which is used for rationing. Steps 9300 to 9305 are similar to the steps 2100 to 2105 in FIG. 34. Moreover, steps 9307 and 9308 are similar to steps 2107 and 2108. The main difference is that step 9306 differs to 2106. Instead of reducing the tentative increment of the auctioneer's accepted volume when the auction process tries to accept more marginal bids from a bidder than the bidder has provided (the tentative increment in the accepted volume from the bidder exceeds its marginal excess quantity), then step 9306 sets the increment in the accepted volume of each such a bidder equal to its marginal excess quantity. Thus all marginal bids are accepted from such bidders. The increment in the accepted volume is set to zero for other bidders. Acceptance from such bidders are then determined in a later iteration. In an alternative embodiment, step 9306 may set the increment in the accepted volume for each other bidder equal to its tentative increment in the accepted volume. In both embodiments, the procedure then continues to step 9308, where the remaining volume of marginal bids to be accepted by the auction process is reduced by the total volume of marginal bids accepted in step 9306.

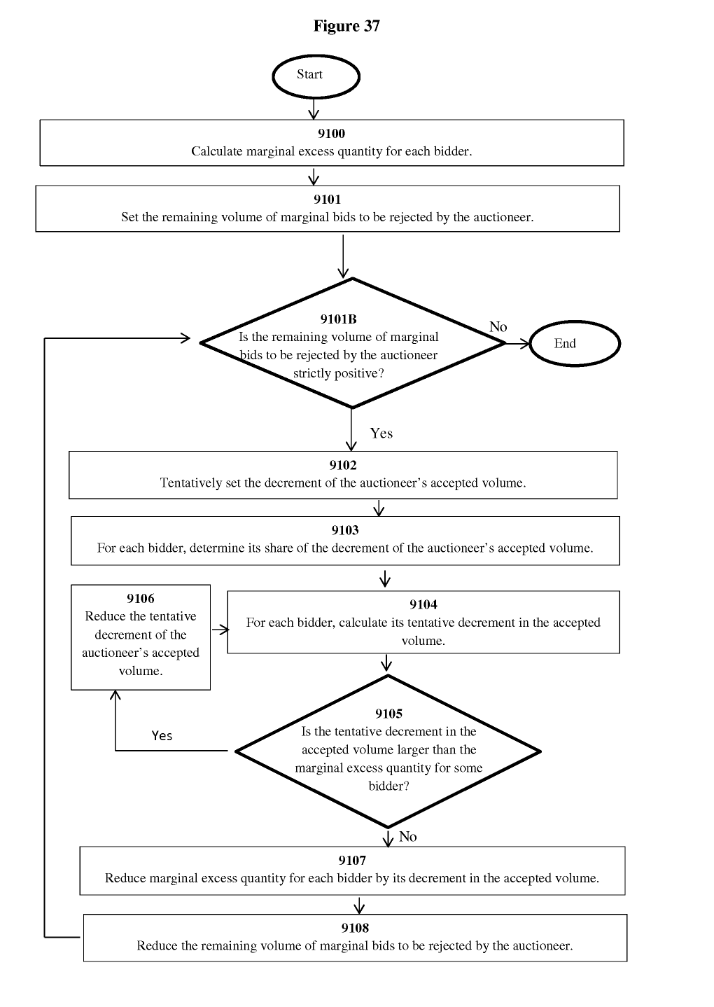

One could say that the rationing processes in FIG. 34 and FIG. 36 starts by accepting infra-marginal quantities and then the accepted volume is increased in steps until the auction has been cleared. However, an alternative embodiment in FIG. 37 is different. Here one could instead say that all marginal and infra-marginal bids are first tentatively accepted and then the accepted volume is decreased stepwise until the auction has been cleared. This would be somewhat similar to the rationing process used for SRR and CRR rationing in Saez et al. (2007). As for earlier embodiments of the rationing process, it is a repeated process that can be applied to either side of the auction. In step 9100 in FIG. 37, the marginal excess quantity of a bidder is, as in previous rationing processes, initially set to its marginal quantity increment. This is the maximum volume of marginal bids that can be rejected of the bidder. The marginal excess quantity of the bidder is then reduced, in step 9107, for every confirmed volume of marginal bids that the auction process decides to reject from the bidder. Thus in this embodiment of the rationing process, the marginal excess quantity corresponds to the remaining volume of marginal bids of a bidder that can be rejected. The remaining total volume of marginal bids that is to be rejected from sellers (buyers) by the auctioneer is, in step 9101, initially set to the total volume of marginal bids from sellers (buyers) minus the total volume of marginal bids that is to be accepted from sellers (buyers). The remaining total volume of marginal bids that is to be rejected is then reduced, in step 9108, for every confirmed volume of marginal bids that the auction process decides to reject from sellers (buyers).

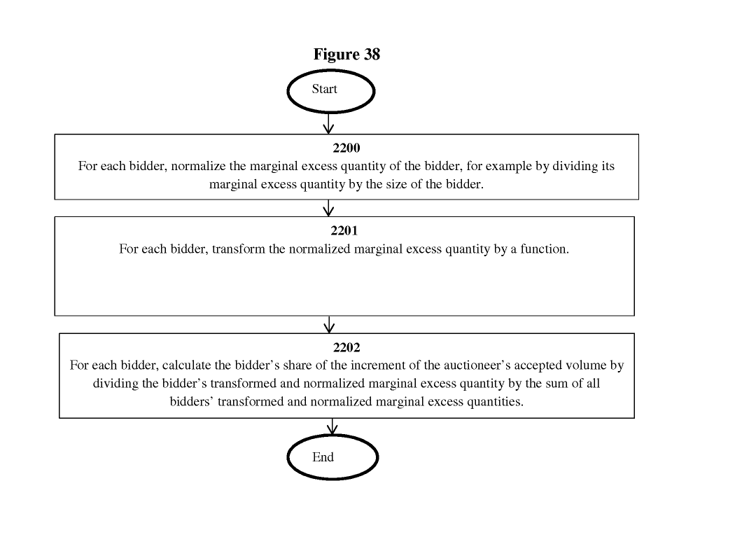

FIG. 38 provides an example of a share process, which is used in the rationing process, such as in step 2103 in FIG. 34, step 9303 in FIG. 35 and step 9203 in FIG. 36. The flow chart in FIG. 38 illustrates how each bidder's share of an (tentative) increment in the aggregated accepted volume of the auctioneer could be calculated. In the first step 2200, the marginal excess quantity of each bidder is normalized with respect to the size of the bidder. The normalization can for example be done by dividing the marginal excess quantity of a bidder by the size of the bidder according to some relevant measurement method. We refer to this as a linear normalization of the marginal excess quantity. More generally, we say that the marginal excess quantity of a bidder is normalized with respect to the size of a bidder, if there is a transformation that returns a weakly and sometimes strictly higher output when the marginal excess quantity of the bidder increases and the transformation returns a weakly and sometimes strictly smaller output when the size of the bidder increases. Note that any monotonic transformation of a bidder's size results in a new method of measuring the size. An exemplary share process would have a normalization step, which for example could reduce the discrimination of small or large bidders in the auction. Normalization could also make the auction more efficient for asymmetric (heterogeneous) bidders with different sizes. However, normalization is an optional step. Thus when we below discuss normalized excess supply in the next steps of the share process, the discussion would also apply to excess supply that has not been normalized with respect to the size of a bidder.

In the second step 2201 in FIG. 38, the normalized marginal excess quantity is transformed by a function for each bidder. In an exemplary embodiment the chosen function would be monotonic and the choice would depend on the marginal price, e.g. such that the function is more concave (or equivalently less convex) with respect to the normalized marginal excess quantity for a marginal price that is closer to the reservation price. The reason is that a more concave (or equivalently less convex) function would tend to reduce the relative differences between the normalized marginal excess quantities of the bidders, which would favour bidders with small quantity increments relative their size, i.e. give them a larger share than otherwise in the next step. The exemplary embodiment would equivalently have the property that the function would be more convex (or equivalently less concave) with respect to the normalized marginal excess quantity for a marginal price that is further from the reservation price. This would favour bidders with large quantity increments relative their size, i.e. give them a larger share, because a more convex function would tend to increase the relative differences between the normalized marginal excess quantities of the bidders. As one example of a function, one could transform the normalized marginal excess quantity of a bidder by raising it to the power of an exponent. In an exemplary embodiment, the exponent is non-negative and the exponent becomes smaller, which corresponds to a more concave function, for marginal prices closer to the reservation price. In principle, the rationing rule could use different transformations, which might be non-monotonic, of the normalized marginal excess quantity for different bidders.

In an exemplary embodiment of the third step 2202 in FIG. 38, each bidder's share of an increment in the aggregated accepted volume of the auctioneer can be calculated for each bidder by dividing the bidder's transformed and normalized marginal excess quantity by the sum of all bidders' transformed and normalized marginal excess quantities, whereby bidders' shares sum to one. Our exemplary embodiment of the third step 2202 in FIG. 38 is somewhat reminiscent of the way bidders' shares of the volume of marginal bids is calculated from marginal excess quantities for standard pro-rata on the margin rationing, except that we normalize marginal excess quantities and transform them. Our exemplary embodiment of the third step 2202 in FIG. 38 is a straightforward way to ensure that the bidders' shares sum up to one. But there are many other formulas that could be used to calculate shares from transformed and normalized marginal excess quantities. In the general case, the calculation could be more integrated, e.g. such that the normalization and transformation of normalized marginal excess quantity would not easily be separated into different steps.

A monotonic function in step 2201 is useful as it would ensure, at least for exemplary embodiments of the third step 2202, that a bidder with a larger normalized excess supply gets a larger share of the auctioneer's acceptance increment. In addition, let us preliminary assume that excess supply has not been normalized with respect to the size of bidders and that the auctioneer's acceptance increment is sufficiently small in steps 2102, 9302 and 9202 of embodiments shown in FIG. 34, FIG. 35 and FIG. 36, respectively. Under these circumstances, a bidder that, compared to a competitor, starts the rationing process with a strictly larger initial marginal excess quantity in steps 2100, 9300 and 9200 in FIG. 34, FIG. 35 and FIG. 36, respectively, will end the rationing process with a weakly larger marginal excess quantity and a weakly larger volume of accepted marginal bids, compared to the competitor. We say that the rationing rule accepts and rejects marginal bids monotonically.

The procedure in FIG. 38 can also be used to calculate shares of rejected volumes (acceptance decrements) in step 9103 in FIG. 37. In such cases, an exemplary embodiment of step 2201 would have the property that the function is instead more convex with respect to normalized marginal excess quantity for a marginal price that is closer to the reservation price. Such an embodiment can also be used in step 2103 in FIG. 34, step 9303 in FIG. 35 and step 9203 in FIG. 36, if the auctioneer wants to worsen competition in the auction. Other shapes of the function can be optimal for other circumstances, for example if an auctioneer is primarily concerned about competition in a short price interval.

We say that bidders' shares of the volume of marginal bids accepted/rejected by the auction depends on the size of a bidder, if at least one bidder's share of an increment in the aggregated accepted volume of the auctioneer depends on the size of some bidder for at least one iteration in the rationing process for at least some marginal price.

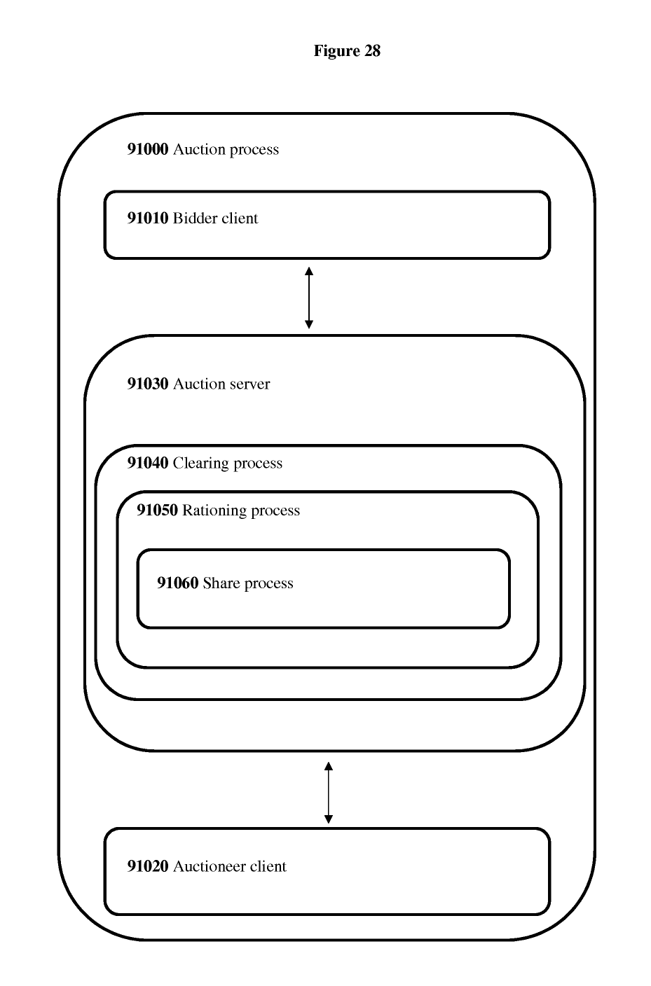

In an exemplary embodiment, which is illustrated by FIG. 28, the auction process 91000 can be divided into three types of subprocesses: a bidder client 91010, an auctioneer client 91020 and an auction server 91030. In FIG. 28 there is only one bidder client, but alternative embodiments could have several bidder clients, e.g. one bidder client per bidder. This would speed up the auction if the bidder clients would be parallel processes. In special embodiments an auction process could also have a plurality of auctioneer clients. In special cases, such as in some combinatorial auctions, there could also be multiple auction servers that manage market clearing for multiple items. There are alternative embodiments where the auctioneer client interacts directly with the bidder client.

### Embodiment for Bidder Client

Some auctions would have one bidder client and some auctions would only have one bidder. But an automatic process could also have a plurality of (two or more) bidder clients that can interact with a plurality of bidders at almost the same time, i.e. bidder clients could be parallel processes. A bidder client could communicate with one auction server that manages the trade of units for one or more types of items. In some cases, such as when trading of different types of items are managed by different auction servers, a bidder client could communicate with a plurality of auction servers. A bidder client could act as a proxy bidding agent. In this case, the bidder submits flexible bid information to the bidder client, which then uses this information to submit bids to the auction server on behalf of the bidder. The bidder client can then bid on behalf of the bidder without much further communication with the bidder.

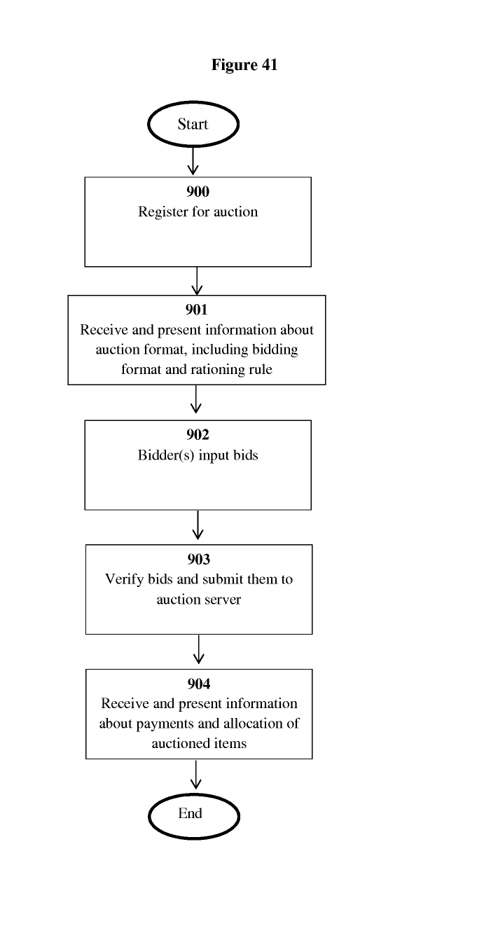

The flow chart in FIG. 41 illustrates how a bidder client communicates with both an auction server and one or more bidders. In the first step 900, which can be omitted in some embodiments, a bidder registers for the auction. The bidder client communicates this information to the auction server. In the second step 901, the bidder client receives information from the auction server about the auction design, including bidding format and rationing rule, which would have some aspects of our invention. The information is presented to the bidder. In an alternative embodiment, the bidder client may receive and present information about the auction format before registering for the auction. Step 901 could also be omitted, for example in case a bidder can easily find this information by other means. In the third step 902, the bidder inputs bids to the bidder client, or are given an opportunity to input bids. A bid might be flexible bid information, so that the bidder client can bid repetitively on behalf of the bidder. In the fourth step 903, the bidder client verifies that bids comply with a bidding format with aspects of our invention and then it submits the bid(s) to the auction server. In the fifth step 904, the bidder client receives information from the auction server about the auction outcome. The information is presented to the bidder.

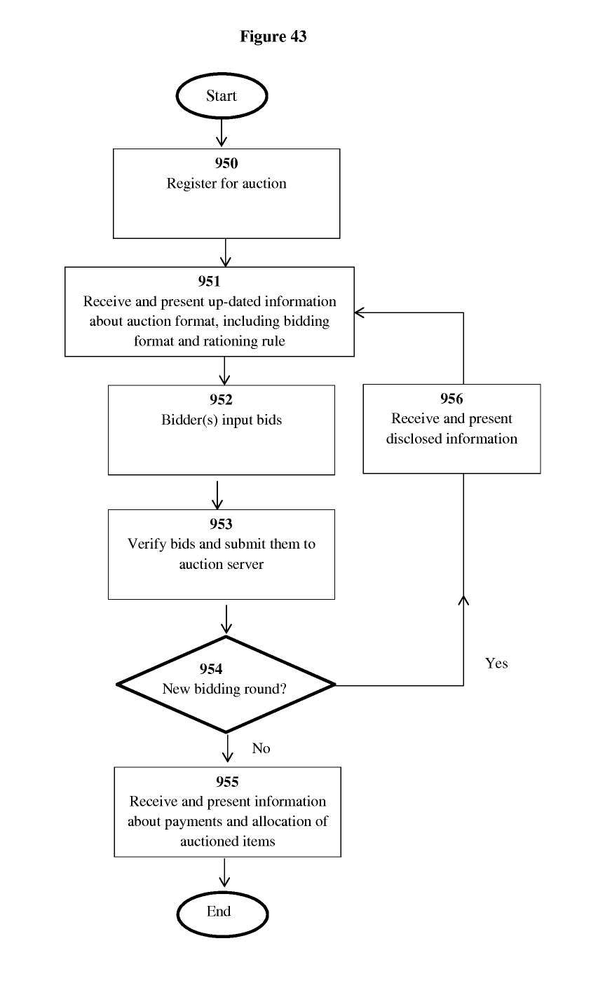

FIG. 43 describes the flow chart when the bidder takes part in a dynamic auction with additional steps. After bids have been verified and communicated to the auction server in step 953, there is one additional step 954, where the bidder client may receive information on whether there is going to be a new bidding round. Note that the bidder client may not receive such information, for example if the number of bidding rounds is predetermined and announced to the bidder at the beginning of the auction. Another additional step 956 is that if there is a new bidding round, then the bidder client may receive new auction relevant information, such as characteristics of bids (including competitors' bids) in previous rounds. The new auction relevant information or part of it is presented to the bidder. Before the bidder is allowed to submit additional bids in the new bidding round, there is a step 951, where the bidder client may receive updated information about the auction design, including possible changes in the bidding format and rationing rule. The updated information or parts of it is presented to the bidder.

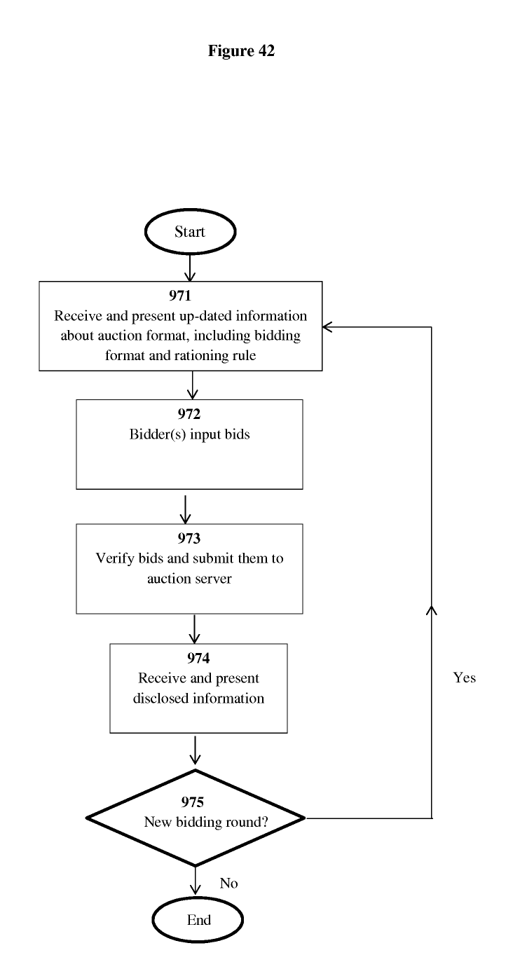

In an alternative embodiment, the auction may determine the allocation for some items (called clinching in clock auctions), while continuing receiving new bids for the remaining items. Such an example is illustrated for a bidder client by the flow chart in FIG. 42. A similar flow chart could also be used to represent the bidding process of an exchange with continuous trading. In this embodiment, the step 974, where disclosed information is received would normally also include a complete or partial disclosure of the auction's allocation decisions. Bidders would normally also receive an update of their active bids.

### Auctioneer Client

The auctioneer client is an automatic process that primarily communicates with the auctioneer and auction server. The same auctioneer client may communicate with a plurality of auction servers. In some cases, the same auctioneer client might communicate with multiple auctioneers.

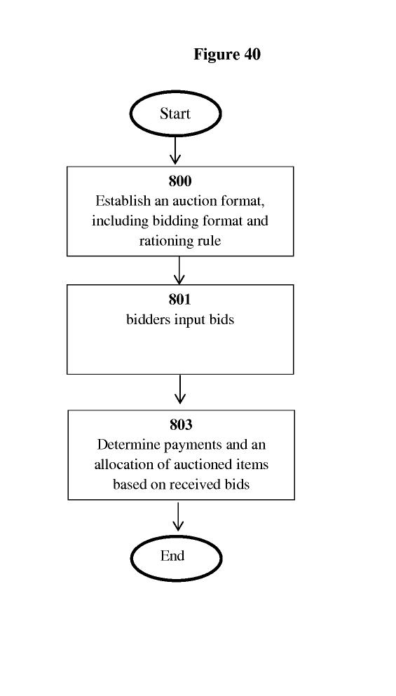

In an exemplary embodiment of our invention, the auction process runs the auction automatically, so that there is no need of a human auction operator. In this case, the auction could sometimes operate without an auctioneer client, or the auctioneer client could operate without any interaction with a human operator. In an alternative embodiment, a human operator interacting with the auctioneer client may take a passive or an active part in the operation of the auction. It might be that the auction process' recommendation on whether to start a new bidding round or the auction process' allocation recommendation needs the approval of a human operator via the auctioneer client. It could also be the case that the human operator has the possibility to overrule recommendations from the auction process. The human auction operator may make decisions in exceptional circumstances, and use the auctioneer client to communicate with bidders or help bidders with placing bids when they have problems to communicate with the auction server. The auction process could disclose information automatically to bidders, including information about the determined allocation, or after approval or assistance by a human operator via the auctioneer client. One could also think of simpler auctions where the automatic auction process does not disclose any type of information to bidders, including information about the final allocation. There could also be circumstances where an auctioneer prefers to keep parts of the auction design, such as the rationing and allocation rule, secret. This could for example be the case if the auctioneer has special deals with some bidders that it prefers to keep secret. It is not our preferred embodiment of the auction process, but the simplest version of auction would not even check whether submitted bids satisfy the bidding format. FIG. 40 shows an example of such a flow chart for a simplified auction process. Our other flow charts of an auction process could be simplified in a similar way.

### Auction Server

An auction server for example gets bid data from the bidder clients and sends information to the bidder client, such as information about new bidding rounds, the auction format, progress of the auction and other information that should be presented to bidders. The auction server could also receive instructions and information from the auctioneer client, and it could send back information, such as information about the progress of the auction to the auctioneer client.

In many embodiments, the main task of the auction server is to receive bids from one or more bidder clients in one or more bidding rounds, to clear those bids in a clearing process, and to report the result of the clearing process. In a preferred embodiment, the clearing process 91040 is a subprocess of the auction server 91030. In a preferred embodiment, the share process 91060 is a subprocess of the rationing process 91050, which in its turn is a subprocess of the clearing process 91040. This is illustrated by FIG. 28.

Alternative Embodiments with Disproportionate Rationing

This section discusses rationing rules that can be applied to the bidders' side of an auction, (supply or demand side). They can also be applied to any of the sides of a double auction with both buyers and sellers as bidders. For the sake of clarity we will normally consider bids on one side at a time.

The rationing rules of auctions can give priority to different bidders or bids for different reasons. As mentioned earlier, some exchanges and auctions for example use time priority and/or broker priority (i.e. marginal sell bids and marginal buy bids from the same bidder are cleared before marginal bids are rationed by other means) when rationing their bids. There are also exchanges that give priority to traders/bidders depending on membership or VIP status when rationing bids. In some exchanges, priority in the rationing process could depend on whether orders were matched outside the exchange (crossing). Some exchanges give priority to displayed orders in the rationing process. As discussed in U.S. Pat. No. 8,751,369 by Monroe, one could also think of cases where bidders pay a fee to get priority in the rationing process. These are examples where ranking in the rationing rule depend on aspects other than bid price and bid quantity. The discussion below and elsewhere in the specification applies to such cases as well, for example if all marginal bids have exactly the same priority in the rationing process for aspects other than bid price and bid quantity, such as timing, broker, display instruction, priority fees, VIP status, membership status and crossing. The discussion could also apply to situations where the auction process uses aspects of our invention to ration a subset of marginal bids that have the same priority with aspects other than bid price and bid quantity.

Exchanges sometimes use aspects other than bid price and bid quantity in the rationing process, such as time-priority, broker-priority, display-priority, membership-priority, crossing priority etc., to improve liquidity or information flow in the market. Some auctioneers should find it attractive to use a rationing rule that balances liquidity or information motivated aspects with competition motivated aspects, such as aspects of our invention.

DEFINITION: We say that a rationing rule balances liquidity and competition aspects when both of the following conditions are satisfied for the same type of item: 1) aspects other than bid price and bid quantity, such as time, crossing, display, broker, priority fees, membership status or VIP status influence the allocation decision of the item, and 2) there are circumstances where a marginal bid with a higher priority with respect to aspects other than bid price and bid quantity, such as time, crossing, display, broker, priority fees, membership status or VIP status is only accepted partly, even though a marginal bid with a lower priority with respect to aspects other than bid price and bid quantity is also accepted to some extent.

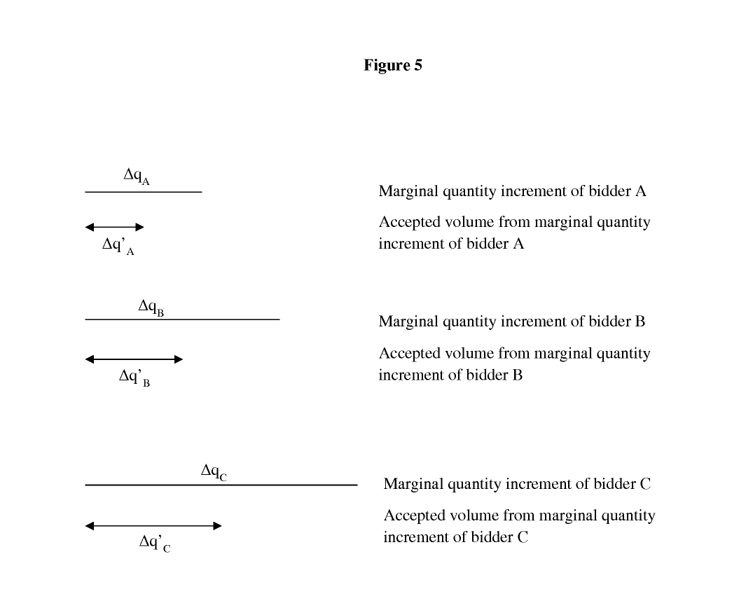

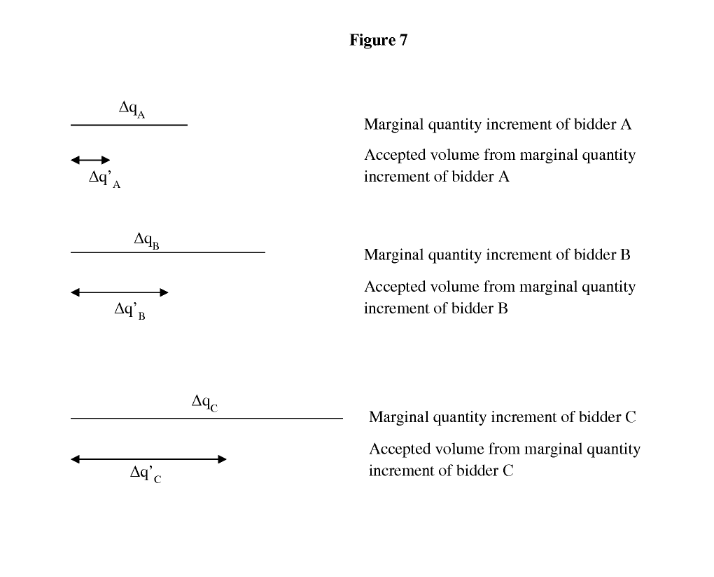

In the following we will define properties of embodiments with disproportionate rationing for auctions trading multiple units. We let X be a bidder on a particular side of the auction. Note that some bidders (including X) might be active on both sides of the auction, in case it is a double auction. Let Δq_{X} be the quantity increment of bidder X at the marginal price at the particular side of the auction. FIGS. 5-7 illustrate marginal quantity increments for an auction with three active bidders: A, B and C. X could represent any bidder in that particular example. We let Δq be the aggregated quantity increment at the marginal price from all bidders that are on this particular side of the auction. We denote the infra-marginal quantity of bidder X by q_{X} and the aggregated infra-marginal quantity from all bidders on this particular side by q. Let Δq′_{X} be the volume that is accepted (in expectation) from marginal bids of bidder X at this particular side. Similarly, we let Δq′ denote the aggregated volume that is accepted (in expectation) from marginal bids of all bidders on this particular side. We write in expectation as the rationing rule could be partly randomized.

Randomization could for example be used to smooth the effect of rounding accepted quantities, for example to permissible quantity levels in the bidding format. Randomization could also be used if bidders submit bids with size restrictions, such as when they prefer to have their marginal quantity increments completely accepted or not at all accepted compared to partial acceptance of marginal quantity increments.

As before, rationing on the margin implies that all infra-marginal quantities are accepted and only marginal bids are rationed. We focus on characterizing rationing rules for auction outcomes with monotonic bids. One reason for this is that many auctions use monotonicity rules or activity rules in practice. Another is that even if an auction would allow for non-monotonic bids, bidders would often or sometimes submit monotonic bids anyway. Another is that the rationing rule and the chosen marginal price could have non-standard properties for outcomes where bids are non-monotonic.

We say that a multi-unit auction has a benign outcome if the following three conditions are satisfied: 1) rationing on the considered particular side is on the margin, 2) bids are monotonic for each bidder on the considered particular side of the auction and 3) if we let X represent one bidder at a time on the considered particular side of the auction, then it is true for all bidders that Δq_{X}·Δq′/Δq is a multiple of the lot-size at the marginal price, i.e.

Δq_{X}·Δq′/Δq=I·lot-size, (A)

where I is some integer number. The last condition rules out that an allocation with a non-pro rata on the margin outcome was due to rounding of accepted quantities to permissible quantity levels. If rounding of accepted quantities is made in a different way for some auction design, then condition (A) should be replaced by another condition that makes sure that the allocation decision is not influenced by rounding of accepted quantities. For auction designs where rounding of accepted quantities does not occur, then condition (A) can be omitted when defining benign auction outcomes.

DEFINITION: We say that rationing on the margin is disproportionate if the auction uses rationing on the margin and it has at least one benign outcome, such that there is at least one bidder, here denoted by Y, on the considered particular side of the auction, such that

Δq′_{Y}/Δq_{Y}≠Δq′/Δq if Δq>Δq′>0.

We say that a rule favours large marginal quantity increments of a bidder Y on the considered particular side of the auction at a price level p₀, if for every benign auction outcome with marginal price p₀ where bidder Y has the strictly largest marginal quantity increment on the considered particular side of the auction, it is always the case that

Δq′_{Y}/Δq_{Y}≠Δq′/Δq if Δq>Δq′>0,

and sometimes the case that

Δq′_{Y}/Δq_{Y}≠Δq′/Δq if Δq>Δq′>0.

We also say that a first rationing rule is more disproportionately favourable to large marginal quantity increments of bidder Y at a price level p₀ compared to a second rationing rule when the accepted volume from marginal bids of bidder Y, Δq′_{Y}, is always weakly and sometimes strictly larger for the first rule compared to the second rule when the marginal quantity increment and infra-marginal quantity of each bidder are unchanged for the two rules, the supply and/or demand curve of the auctioneer is identical for the two rules, and the auction outcome for both rules satisfy all of the following four conditions: 1) the auction outcome is benign, 2) the marginal price is p₀, 3) Δq>Δq′>0, and 4) bidder Y has the strictly largest marginal quantity increment on this particular side of the auction.

We say that a rule favours small marginal quantity increments of a bidder Y on the considered particular side of the auction at a price level p₀, if for every benign auction outcome with marginal price p₀ where bidder Y has the strictly smallest marginal quantity increment on the considered particular side of the auction, it is always the case that

Δq′_{Y}/Δq_{Y}≧Δq′/Δq if Δq>Δq′>0,

and sometimes the case that

Δq′_{Y}/Δq_{Y}≧Δq′/Δq if Δq>Δq′>0.

We also say that a first rationing rule is more disproportionately favourable to small marginal quantity increments of bidder Y at a price level p₀ compared to a second rationing rule when the accepted volume from marginal bids of bidder Y, Δq′_{Y}, is always weakly and sometimes strictly larger for the first rule compared to the second rule when the marginal quantity increment and infra-marginal quantity of each bidder are unchanged for the two rules, the supply and/or demand curve of the auctioneer are identical for the two rules and the auction outcome for both rules satisfy all of the following four conditions: 1) the auction outcome is benign, 2) the marginal price is p₀, 3) Δq>Δq′>0, and 4) bidder Y has the strictly smallest marginal quantity increment on this particular side of the auction.

Now assume that bidder Z is a competitor to bidder Y on the considered particular side of the auction. Bidder Z has the marginal quantity increment Δq_{Z} at the marginal price. We denote the infra-marginal quantities of bidder Z by q_{Z}, and Δq′_{Z} is the volume that is accepted from marginal bids of bidder Z.

DEFINITION: If for auction outcomes with monotonic bids and a marginal price p₀, it is always the case that

Δq′_{Y}≧Δq′_{Z} if Δq_{Y}≧Δq_{Z},

for all pairs of bidders on the considered particular side of the auction, then we say that the rationing rule accepts marginal bids monotonically at the price level p0.

A rationing rule that accepts marginal bids monotonically at p₀ is said to give maximum priority to small marginal increments at p₀ if the following condition is satisfied for all pairs of bidders on the considered particular side for auction outcomes with monotonic bids and a marginal price p₀:

Δq′_{Y}=Δq′_{Z} whenever Δq_{Y}≧Δq_{Z}>Δq′_{Z}.

The difference Δq_{Y}-Δq′_{Y} corresponds to the volume from marginal bids of bidder Y that is rejected.

DEFINITION: If for auction outcomes with monotonic bids and some marginal price p₀, it is always the case that

Δq_{Y}−Δq′_{Y}≧Δq_{Z}−Δq′_{Z} if Δq_{Y}>Δq_{Z},

for all pairs of bidders on the same side of the auction, then we say that the rationing rule rejects marginal bids monotonically at p₀.

A rationing rule that rejects marginal bids monotonically is said to give maximum priority to large marginal increments at a price level p₀, if the following condition is satisfied for all pairs of bidders on the particular side of the auction for all auction outcomes with monotonic bids and the marginal price p₀:

Δq_{Y}−Δq′_{Y}=Δq_{Z}−Δq′_{Z} whenever Δq_{Y}>Δq_{Z}>Δq′_{Z}>0.

Note that many of the properties of the disproportionate rationing rules that we have discussed in this section have a consistent dependence on the marginal quantity increments of bidders. Such properties are not known from prior art. Rationing rules that depend on timing of bids, broker priorities, whether orders are displayed or crossed, paid priority fees, or VIP/membership status would not be consistent in this way. Neither would the disproportionate rationing rule, rationing, in Gresik (2001), where marginal bids (when possible) are rationed in proportion to the infra-marginal volume that a bidder wants to trade at the marginal price. SRR and CRR rationing in Saez et al. (2007) are disproportionate rationing rules, but they are also not consistent with respect to marginal quantity increments of bidders. In their case rationing depend on bidders' quantity increments relative to clinched quantities (the number of clinched units) of bidders, and they would often differ from marginal quantity increments. Thus a problem with SRR and CRR rationing in Saez et al. (2007) is that some infra-marginal bids could be rejected, which would give efficiency problems similar to Kremer and Nyborg (2004).

Embodiments with Normalization

A disproportionate rationing rule tends to discriminate against either large or small bidders. To improve the perceived fairness of an auction with disproportionate rationing, it could then be of interest to use normalization. Normalization could also make the auction more efficient for asymmetric (heterogenous) bidders with different sizes. It could for example be of interest to let a disproportionate rationing rule normalize or weight bid quantities of a bidder with respect to a size of the bidder, such as the maximum quantity (normally infra-marginal quantity plus marginal quantity increment) that the bidder is willing to trade at the marginal price, or the maximum quantity that the bidder is willing to trade at a bid price that is closer to the reservation price than the marginal price, the registered production capacity or financial constraint of a bidder, how much the bidder has traded in the past etc. More generally the size of a bidder could be calculated from a function of the bid quantities offered at a plurality of bid prices in the present or previous bidding rounds. If the size of a bidder is measured from one or more bid quantities in a transaction schedule, then at least one such bid quantity has to be associated with a bid price that is at the marginal price or closer to the reservation price. Any monotonic transformation of a size can normally be regarded as a new method to measure the size. One can also create a new method of measuring the size by combining different ways of measuring the size.

We say that a disproportionate rationing rule gives priority at p0 to a marginal quantity increment of bidder Y that is large relative to the size of bidder Y if decreasing the size of bidder Y (according to a relevant measurement method), without changing its marginal quantity increment or infra-marginal quantity, would make the rationing rule more disproportionately favorable to the marginal quantity increment of bidder Y at p0.

An exemplary embodiment of our invention would have the property that, at price levels far from the reservation price, a disproportionate rationing rule would give priority to a marginal quantity increment of a bidder that is large relative to the size of the bidder, because this would encourage the bidder to submit more competitive bids. In this case and for such price levels, the disproportionate rationing rule would reward a smaller bidder size for given infra-marginal quantities and marginal quantity increments.

Near the reservation price a preferred embodiment should instead give priority to a marginal quantity increment that is small relative to the size of the bidder. In this case and for such price levels, the disproportionate rationing rule would instead reward a larger bidder size for given infra-marginal quantities and marginal quantity increments.

Even if a rationing rule uses normalization with respect to sizes of bidders, the accepted volume from a bidder's marginal quantity increment would still normally depend on the (unnormalized) marginal quantity increment, as it is an upper bound on the volume of marginal bids that can be accepted from the bidder. For example, the marginal excess quantity of a bidder is initially set to the marginal quantity of the bidder in our embodiments of the disproportionate rationing procedures in FIG. 34 to FIG. 37.

DEFINITION: We say that a disproportionate rationing rule has been normalized with respect to the size of bidder Y if the accepted volume from the marginal quantity increment of bidder Y for benign auction outcomes is determined by the (unnormalized) marginal quantity increment of bidder Y, no other unnormalized bid quantity of bidder Y and at least one bid quantity of bidder Y that has been normalized with respect to the size of bidder Y.

Note that a quantity increment is given by the difference between two bid quantities. Thus a normalized marginal quantity increment would involve two normalized bid quantities.

Embodiments where Rationing Depends on the Marginal Price

In our preferred embodiment, the disproportionately of the rationing rule changes with the marginal price. Preferably, a rationing rule would give priority to large quantity increments far from the reservation price and small quantity increments near the reservation price. But there could also be special circumstances where the auctioneer would prefer the opposite design, for example if it wants to increase the order depth in a dynamic auction with continuous trading by making bids less competitive. Such a special embodiment would for example change the second step 2201 of the share process in FIG. 38, such that the normalized marginal excess quantity is transformed by a function that is more convex with respect to normalized marginal excess quantity for a marginal price that is closer to the reservation price.

DEFINITION: The rationing decision in prior art would depend on bidders' and the auctioneer's maximum and minimum quantities that are supplied and demanded at the marginal price. Sometimes, in case of clinching, rationing could also depend on bid quantities at prices that are closer to the reservation price than the marginal price. If the rationing decision in addition depends on the marginal price itself, then we say that the rationing rule depends on the marginal price.

It may also be helpful to make the following definitions. Let Interval A be a closed price interval (without any gaps) that includes the marginal price. Let the Set B be a set of all permissible prices in interval A, except for the marginal price and the reservation prices of all sides of the auction that have bidders. Make interval A and the set B as large as possible, under the constraint that there are no bids with bid prices in the Set B and such that the auctioneer has no quantity increments at prices in the set B. Thus Set B would contain a region of permissible prices around the marginal price, where no trader has a quantity increment.

DEFINITION: Consider an auction outcome with monotonic bids and a non-empty Set B. We say that the rationing rule of an auction is proven to depend on the marginal price, if there is such an auction outcome and the allocation would change (in expectation) if all bids (including bids on both sides of the auction) with a bid price equal to the marginal price and any marginal quantity increment of the auctioneer would move to at least one of the permissible prices in set B.

A pro-competitive rationing rule tends to have more impact if the change in the rationing rule is large from one price level to the next. As an example, assume that we restrict attention to rationing rules that accepts and rejects marginal bids monotonically. In this case, we would expect that a rationing rule would have the highest impact on bidding at two neighbouring price levels if the rationing rules changes from giving maximum priority to large marginal increments at one price level to give maximum priority to small marginal increments at the other price level. It is sometimes the case that changing the properties of the rationing rule at price levels that are not used by the bidder has little or no impact on its bidding strategy. Thus in order to give a bidder Y the strongest possible incentives to submit competitive bids, it could be beneficial to let the rationing rule depend on bidder Y's bid prices. In particular, it could be beneficial to let the rationing rule at a bid price of bidder Y depend on the position of said bid price in a list of sorted price-quantity pairs from bidder Y. In this way, it for example becomes possible to let the rationing rule give large quantity increments of bidder Y maximum disproportionate priority at its bid price that is furthest away from the reservation price and small quantity increments of bidder Y maximum disproportionate priority at its bid price that is closest to the reservation price.

The auctioneer may also find it beneficial to introduce an individual rationing rule, for example such that large marginal quantity increments of some bidder Y are given priority in price intervals where quantity increments of bidder Y are decreasing towards the reservation price and small marginal quantity increments of bidder Y are given priority in price intervals where quantity increments of bidder Y are increasing towards the reservation price. Such a rationing rule could be based on bids that actually were submitted by bidder Y or on bids that the auctioneer expects bidder Y to submit.

### Embodiments for Double Auctions and Related Auctions

In double auctions or at prices where the auctioneer has quantity increments, the aggregate demand curve and aggregate supply curve from traders can intersect in an interval of quantities. In case the highest aggregated transacted quantity is strictly larger than the lowest aggregated transacted quantity, then the rationing rule will determine the aggregated transacted quantity.

The rationing decision in prior art would depend on bidders' and the auctioneer's maximum and minimum quantities that they are willing to trade at the marginal price. Sometimes, in case of clinching, rationing could also depend on bid quantities at prices that are closer to the reservation price than the marginal price. If the rationing decision in addition depends on the marginal price itself, then we would (as before) say that the rationing rule depends on the marginal price.

To make a more formal definition, we use the same definitions of Interval A and Set B that we introduced in the previous section.

DEFINITION: Consider an auction outcome with monotonic bids and a non-empty Set B. We say that the aggregated transacted quantity that is chosen by the rationing rule of an auction is proven to depend on the marginal price, if there is such an auction outcome and the chosen aggregated transacted quantity would change (in expectation) if all bids (including bids on both sides of the auction) with a bid price equal to the marginal price and any marginal quantity increment of the auctioneer would move to at least one of the permissible prices in set B.

Consider two prices, p0 and p1, such that p1 is closer to the reservation price for a side of the auction (which has at least one bidder). Consider auction outcomes with monotonic bids where the marginal price is p0, and p1 belongs to Set B. We say that the aggregated transacted quantity at prices p0 and p1 is chosen pro-competitively for this side of the auction, if for the considered auction outcomes, the chosen aggregated transacted quantity would not increase (in expectation) and for some considered auction outcomes decrease (in expectation) if all bids (including bids on both sides of the auction) with a bid price equal to the marginal price p0 and any marginal quantity increment of the auctioneer would move to p1.

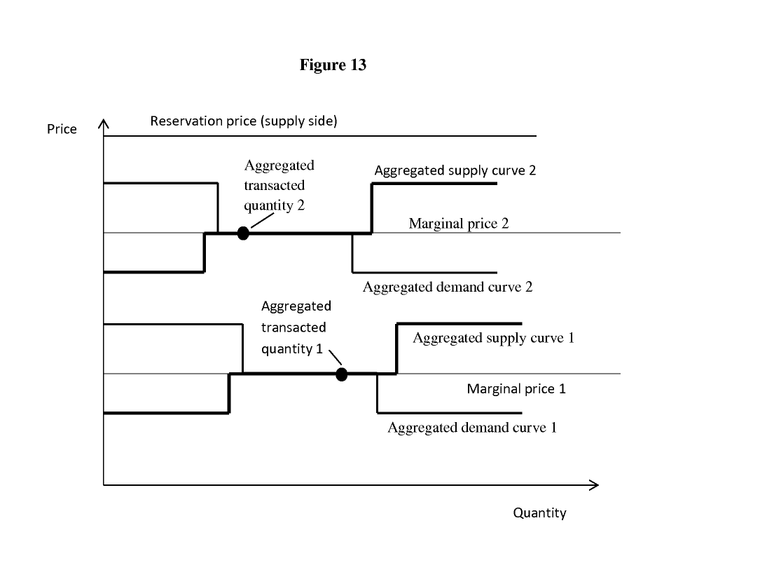

Rationing the aggregated transacted quantity pro-competitively for one side of the auction can for example be beneficial for the auctioneer if the other side is represented by the auctioneer or if the other side is expected to bid fairly competitively, anyway. FIG. 13 illustrates two outcomes where the aggregated transacted quantity is rationed pro-competitively for sellers, the supply side of the auction. For these two outcomes, the aggregated transacted quantity that is chosen by the rationing rule is closer to the minimum aggregated transacted quantity as the marginal price increases.

It is normally sufficient to define a rationing rule at the bid prices that bidders' use in their bids. Similar to disproportionate rationing on the margin it should therefore be beneficial to let the rationed transacted quantity depend on the bid prices of bidders' bids. In particular, it should be beneficial to let the rationing rule at a bid price depend on the position of said bid price in a list of sorted bid prices from all bidders on the same side of the auction. In this way, it for example becomes possible to minimize the chosen aggregated transacted quantity at the bid price in said list of sorted bid prices that is closest to the reservation price of the considered side of the auction and to maximize the chosen aggregated transacted quantity at the bid price in said list that is furthest away from the reservation price of the same side of the auction.

Alternative Embodiments that Give Bids an Exemplary Shape

When discussing how permissible quantities can be used to shape bids, we primarily think of permissible bid quantities for transaction schedules or bids (e.g. limit orders) that have been transformed into an equivalent transaction schedule. However, we do not rule out that permissible quantities could also apply to quantity increments, e.g. in limit orders.

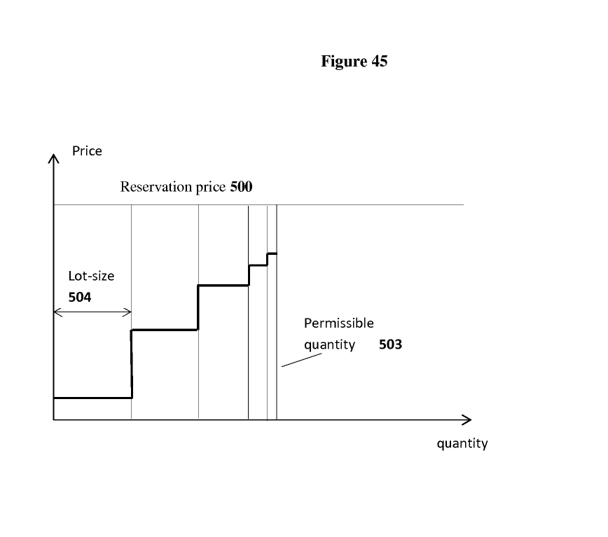

There are several ways to design a bidding format that influences the expected loss associated with the quantity effect, and, as discussed earlier, this can strengthen the impact a rationing rule has on competitiveness of bids. The bidding format could for example be used to encourage that quantity increments become smaller for price levels closer to the reservation price, which would often create a situation where the contribution to the expected loss associated with the quantity effect is decreasing for price levels closer to the reservation price. FIG. 45 illustrates one such embodiment for a procurement auction where permissible quantity levels 503 get denser or tend to get denser, as the quantity increases. Equivalently one can also say that lot-sizes 504 get smaller or tend to get smaller for higher quantity levels.

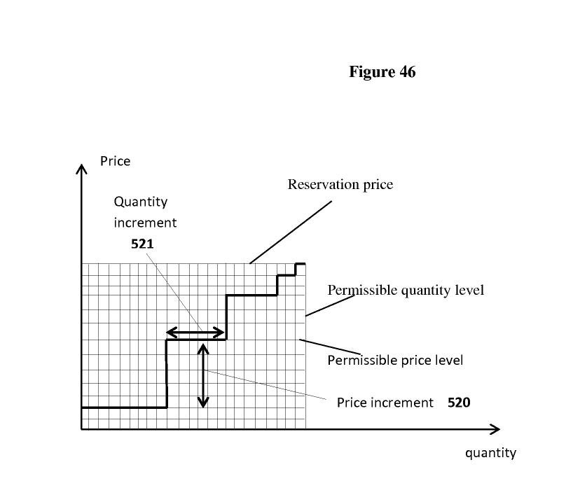

Another embodiment is to introduce additional restrictions on the quantity increments of a bid curve. Assume that price-quantity pairs of a bidder's transaction schedule are sorted into a list that is ascending with respect to bid quantities. In this case, one rule could for example be that the quantity increment (the difference between neighbouring bid quantities), as for example illustrated by 521 in FIG. 46, must be decreasing or must tend to decrease for increasing bid quantities.

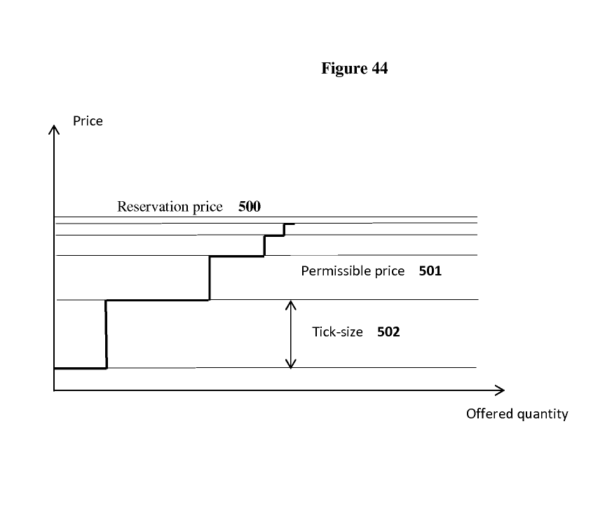

FIG. 44 illustrates another embodiment with permissible price levels 501 that get denser or tend to get denser, as the price approaches the reservation price 500 in a procurement auction. This also means that tick sizes get smaller or tend to get smaller towards the reservation price. Denser prices means that bidders also get incentives to have smaller quantity increments in their bid curves towards the reservation price as illustrated in FIG. 44, which would often create a situation where the contribution to the expected loss associated with the quantity effect tends to decrease for price levels closer to the reservation price. This is a situation where bidding would normally become more competitive for a rationing rule that disproportionately favours large marginal quantity increments. In a sales auction, permissible price levels should instead become denser (or tend to get denser) as the price decreases, if one would like to create a situation where the contribution to the expected loss associated with the quantity effect is normally decreasing for price levels closer to the reservation price.

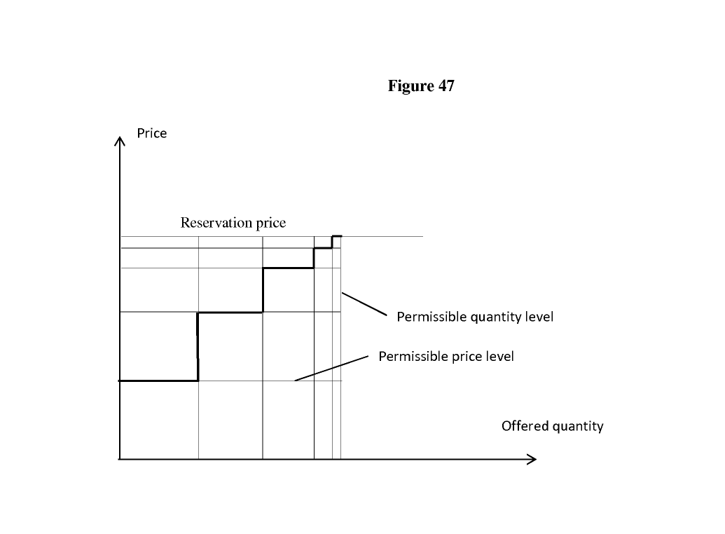

Generally, the allowed price increments and quantity increments in a bid curve may depend on all aspects, including bid prices and bid quantities, of all bids from a bidder. It is also possible to combine the different embodiments (and related embodiments) to motivate bidders' to submit bids with a shape that is preferred by the auctioneer. FIG. 47, for example illustrates one embodiment of our invention where permissible prices get denser towards the reservation price and permissible quantities get denser for increasing quantities.

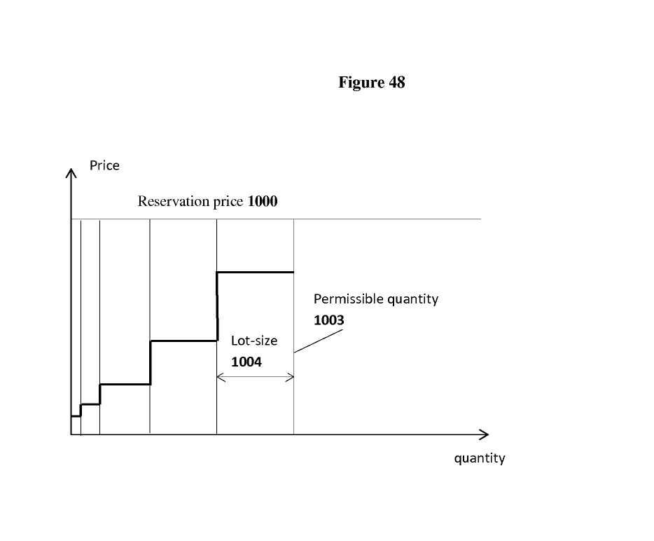

Alternatively, the bidding format and the examples above could be adjusted to encourage that quantity increments instead become larger for price levels closer to the reservation price. FIG. 48 illustrates one such example. This would create a situation where the contribution to the expected loss associated with the quantity effect is often increasing for price levels closer to the reservation price; a situation where bidding would normally become more competitive for a rationing rule that disproportionately favours small marginal quantity increments.

In clock auctions, prices are presented by the auctioneer. This means that the auctioneer can control the price increments with respect to the bidding history. This control could be used to make bids more competitive. In order to get a significant effect on competitiveness of bids, an exemplary pro-competitive clock auction would be transparent in how price increments are chosen, so that bidders are fully aware that the auction design encourages competitive bids. In particular, price increments often tend to be shorter in clock auctions, but also in other ascending bid auctions, away from the reservation price and closer to clearing price, i.e. as bidders' aggregate bid quantity at the current price gets closer to the quantity that the auctioneer wants to transact. This is for example the case for the up-date of current prices in FIG. 5a of U.S. Pat. No. 7,899,734 by Ausubel, Cramton and Jones, but also for minimum price increments in the discussed Canadian spectrum auction. From our previous arguments, this would suggest that a rule that disproportionately favour small quantity increments (in absolute terms or relative to the size of the bidder) at all prices would often improve competitiveness of bids in such ascending bid multi-unit auctions. A rule that disproportionately favours small (positive) quantity increments (in absolute terms or relative to the size of the bidder) at all prices, including the clearing price, would also encourage bidders to be active early in an ascending bid auction, as the rationing rule would discourage large quantity changes late in the auction, at prices where the auction might clear. Thus in some circumstances such a disproportionate rationing rule would allow for a less rigid activity rule; perhaps such a disproportionate rationing rule could even replace an activity rule for some special circumstances. Analogous to clock auctions, one could also imagine that quantity levels are presented by the auctioneer, and that bidders choose bid quantities implicitly by choosing prices for those presented quantity levels. Such an embodiment could be used to control quantity increments of bidders, and this control could be used to make bids more competitive, especially when combined with a rationing rule.

Normally bidders are free to pick and choose bid prices from the set of permissible prices. In theory, a bidder would normally find it profitable to submit as many price-quantity pairs in its transaction schedule as it is allowed to, in order to make their bid curves match their true preferences or strategic preferences as well as possible. However, in practice bidders sometimes submit fewer price-quantity pairs than they are allowed to and often they do not use all permissible bid prices, perhaps because bidders find it costly and time-consuming to formulate precise bid curves. This phenomenon is for example discussed by Kastl (2011) and Kastl (2012). To some extent this is true also for limit orders. This phenomenon could potentially make it more difficult for auctioneers to influence the shape of bidders' bid curves. To motivate bidders to submit precise bid curves with as many price-quantity pairs as they are allowed to, the bidding format could state a minimum number of price-quantity pairs that bidders must submit or impose a fine for bidders that do not submit the desired number of price-quantity pairs. The fine may also depend on other features of the bid curve.

An alternative embodiment is that the bidding format directly regulates the price increments in a bidders' bid curve. FIG. 46 shows an example where bid prices become denser towards the reservation price in a way that is not driven by permissible prices or permissible quantities. If one sorts a bidder's bids with respect to bid prices' distances to the reservation price, one rule could for example be that the price increment 520 (the absolute difference between two neighboring bid prices) must be increasing or must tend to increase away from reservation price. One could also think of situations where the bidding format not only stipulates which bid prices or bid quantities are permissible, but also which combinations of bid prices or bid quantities are permissible.

DEFINITION: The bidding format in prior art often require prices to be chosen from permissible prices, quantities to be chosen from permissible quantities, and sometimes also require bids of a bidder to be monotonic and/or bid prices to be ascending in a dynamic auction. In case a chosen bid price or bid quantity of a bidder, in addition to just said restrictions in prior art restricts which other bid prices or bid quantities are permissible for said bidder, then we say that the bidding format restricts the combinations of bid prices and bid quantities that are permissible.

It could also be advantageous to have different bidding formats for different bidders, e.g. depending on characteristics of the bidder or its bidding history.

Examples of single object sales auctions with tick-sizes that are used to improve efficiency of auctions have been discussed in three mentioned publications by Esther David et al. (2007) as well as Zhen Li and Ching-Chung Kuo (2011; 2013). However, unlike us they do not use ticks-sizes (or other aspects of the bidding format) to shape multiple bids (e.g. price-quantity pairs or limit orders) from a single bidder. We are the first to suggest new bidding formats to enhance efficiency in auctions trading multiple units. Obviously, we are also first to combine new bidding formats with new rationing rules. Esther David et al. (2007) as well as Zhen Li and Ching-Chung Kuo (2011; 2013) show that the number of bidders and the knowledge that an auctioneer has of them influence the optimal permissible price levels for the single object auctions that they analyse. As discussed in a later section, our contribution to the single object auction application is that we observe that the bidding format and/or rationing rule can be updated with respect to auction relevant information, for example after bidders have registered or between rounds of a dynamic auction. With auction relevant information we mean any information that can be used to predict bidding behaviour. It could for example be the number of bidders that have registered for the auction.

Ascending bid auctions (including the discussed Canadian spectrum auction and clock-auctions), sometimes use tick-sizes or minimum price increments that can change during the progress of the auction. However, ticks-sizes and minimum price increments or the current price are in those cases fixed during each bidding round. In their case, the regulation of tick-sizes and minimum price increments is driven by a desire to reduce the number of bidding rounds and to speed up the dynamic auction; their tick-sizes are administratively motivated. While aspects of our invention (including the bidding format) can be used in a multi-bid round, such as a sealed-bid auction or intra-round bids, where the speed of the auction is of less concern.

Normally, embodiments that give bid curves a preferred shape are more efficient when combined with an exemplary rationing rule, but embodiments that give bids a preferred shape can also be used on their own to improve efficiency of auctions, especially when the bidding format is updated with respect to auction relevant information.

In practice, bid curves in auctions trading multiple units are stepped or piece-wise linear. But other shapes are possible. There is a range of well-known interpolation schemes, including polynomial, spline etc. that could be used to transform the price-quantity pairs in the transaction schedule of a bidder into a bid curve. One could even think of more general curve fitting techniques, where a smooth bid function would approximately fit the price-quantity pairs of a transaction schedule without necessarily passing through the points associated with the price-quantity pairs. Irrespective of the shape of a bid curve, it would normally be the case that bid prices and bid quantities of the price-quantity pairs must be chosen from permissible price and quantity levels, and often aspects of our invention would also apply to such cases. Also bidders can sometimes submit bids, such that a bid curve gets a stepped shape, even if a stepped shape is not required by the bidding format. Our discussion and aspects of our invention that applies to auctions that require stepped bid curves, also applies to occasions in other auctions where bidders voluntarily choose to make stepped bid curves.

Alternative Embodiment with an Auction Format that is Tailored for a Specific Region

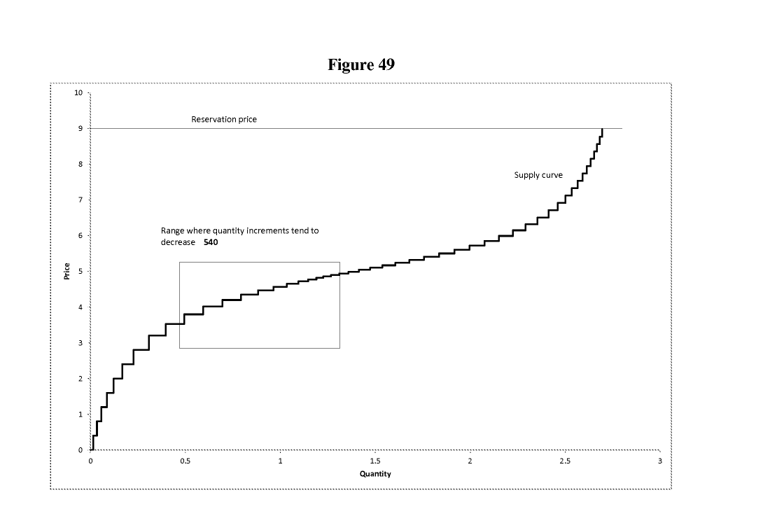

The effect on competitiveness of the embodiments discussed above is strengthened if disproportionateness of the rationing rule changes quickly from one price level to the next or if quantity increments changes quickly from one price level to the next. However, it is difficult to maintain a quick change over a long price interval with many price levels. A large change in the bidding format or rationing rule from one price level to the next price level can sometimes give less scope for changes at other price levels. In such cases, it would be beneficial to introduce changes where they are expected to be of most use. Thus one aspect of our invention is that the embodiments discussed above are implemented in a specific region, consisting of a limited range 540 or a plurality of limited ranges, such that the specific region is smaller than the whole range of permissible prices or quantities. FIG. 49 provides one example of such a specific region. In this particular example, quantity increments are smaller at price levels closer to the reservation price in the specific region, which could be combined with a rationing rule that gives disproportionate priority to large marginal quantity increments in order to increase competitiveness of bids.

Implementing our disproportionate rationing rule and suggested bidding format measures in a specific region could for example be advantageous if the auctioneer is mainly concerned with competitiveness in a limited range of prices or quantities; perhaps if the auction is expected to clear in that range or perhaps because competitiveness between bidders is expected to be worse in a specific range. In case the auctioneer is concerned with bidding (such as competitiveness of bids) in one (or more) specific regions, it may even be beneficial to allow for changes in the rationing rule or bidding format that worsen competition outside these regions, as this may allow for more quick changes in the disproportionateness of the rationing rule or quantity increments from one price level to the next inside the specific region where bids are of more concern. Thus some or all properties of the rationing rule could be opposite to those of an ideal rationing rule outside the specific region. As an example, outside the specific region, there could be circumstances where it would be useful with a rationing rule that would give increased priority to bidders with large marginal quantity increments at prices closer to the reservation price. Similarly, properties of the bidding format and how it is combined with a rationing rule could be opposite to those of an ideal bidding format outside the specific region.

Ideally, the bidding format and rationing rule are optimized to maximize expected welfare or the auctioneer's expected payoff with regard to an estimated probability distribution for different auction outcomes, such as bidding outcomes, transacted quantities or marginal prices. As discussed in the next section, this probability distribution should ideally be updated with respect to all auction relevant information that is available to the auction process.

Alternative Embodiment with an Auction Format that is Updated

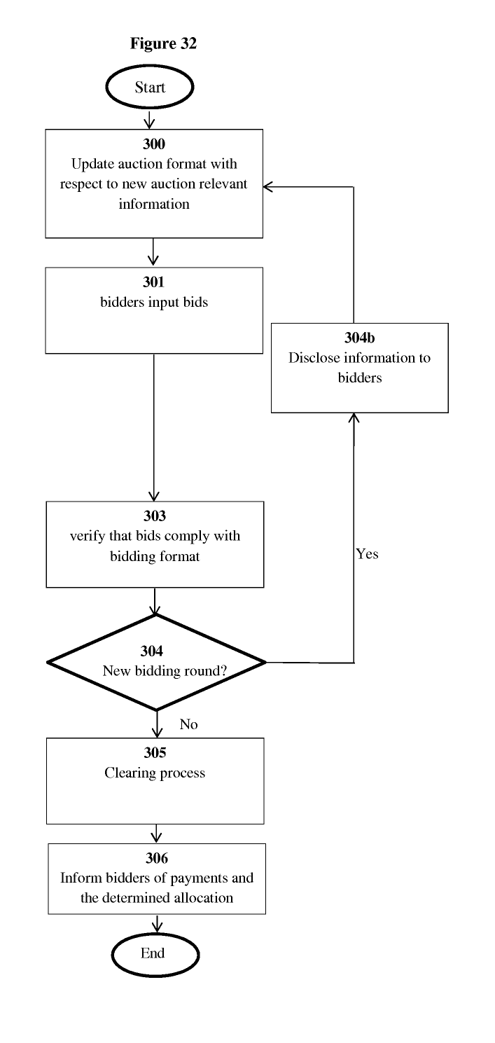

The specific region that is of most concern to the auctioneer can be updated with regard to new information that is arriving, and so could the optimal design of the bidding format and rationing rule. Any information that will influence the predicted outcome of the auction is auction relevant information, including market news, how many bidders registered for the auction, what are the characteristics of registered bidders, how did registered bidders bid in previous auctions, what was the outcome of previous auctions. In a dynamic auction, bids in previous rounds could also be used to update the bidding format and rationing rule for a next round. For example, an auctioneer may want to automatically adjust tick-sizes with respect to liquidity in the previous period. FIG. 32 presents the flow chart of an embodiment of our invention with this updating feature. Note that the auction format includes the bidding format and rationing rule. The difference to the flow chart in FIG. 30 is that we have changed the first step of each bidding round, where the auction format is now updated with respect to new information that has arrived before a new bidding round starts.

In a double auction, the number of registered bidders and their characteristics may indicate which side of the auction is least competitive and rationing of the aggregated transacted quantity could be tuned to improve competition on the least competitive side of the auction. Updating of the rule that rations the aggregated transacted quantity may also continue during the progress of the auction. In an exchange, the order imbalance, such as the difference between the total bid quantity submitted for active sell orders and active buy orders, could also be used as one measure of which side of the exchange is least competitive. The side with least bid quantity would normally be the least competitive side. One could also apply various market concentration measures to estimate competitiveness of a side of an exchange, e.g. from historical bid data and/or from active bids. The Herfindahl-Hirschman index and other related measures of market competitiveness are for example discussed by Bikker and Haaf (2002) in “Measures of competition and Concentration in the banking Industry: a Review of the Literature”, by Newbery (2009) in “Predicting market power in wholesale electricity markets”, and by Lo Prete and Hobbs (2015) in “Market power in power markets: an analysis of residual demand curves in California's day-ahead energy market (1998-2000)”.

DEFINITION: We say that characteristics of the auction design are updated automatically if there is some auction relevant information that could arrive to the auction process that will change at least one of the bidding format and rationing rule automatically without any interference from a human operator, except that a human operator may have to acknowledge updated characteristics of the auction design. It may even be the case that the human operator has the possibility to overrule recommendations from the automatic auction process. The updating aspect of our invention does not require that the bidding format or rationing rule is updated for each bidding round, it is enough that there are some circumstances when the arrival of new information leads to an update of the bidding format or rationing rule in or before at least one of the bidding rounds.

A more narrow definition of auction relevant definition that we use in this specification is external auction relevant information.

DEFINITION: External auction relevant information is auction relevant information that does not originate from the auction process, the auctioneer, or bidders' interaction with the auction process or auctioneer, but which could still be used to predict the auction outcome.

Examples of external auction relevant information could be forward prices, when issued prices, prices of related items that are traded in other auctions and markets or by another auction process, any external information that can be used to predict the supply side of the auction, any external information that can be used to predict the demand side of the auction, economic macro data etc. Other examples of external auction relevant information that is primarily relevant for stock exchanges are: stock splits, stock mergers and profit warnings. However, note that forward prices of an item or when issued prices of an item would not be external auction relevant information for an auction process that trades those particular contracts for that particular item. Information from bidding or clearing for related items that are cleared independently of an item could be regarded as external auction relevant information for that item, even if the items are traded by the same auctioneer and/or by the same machine or computer.

We also introduce the following concept:

DEFINITION: We use non-bid characteristics of bidders to describe auction relevant characteristics of bidders, including how many bidders have registered for the auction and how many bidders are active in the auction, but excluding bid data and auction outcomes from present or previous bidding rounds of the same auction process.

As far as we know, changes in the bidding format, such as lot-sizes and tick-sizes, in financial exchanges are announced long (days) before the new bidding format becomes active.

DEFINITION: We say that an update is with short notice if there is some auction relevant information that could arrive to the auction process that automatically would change characteristics of the auction design within one hour after the last piece of that auction relevant information became first known to some automatic process in the world, which may not be part of the auction process.

Similarly, we can define:

DEFINITION: We say that an update is immediate if there is some auction relevant information that could arrive to the auction process that automatically would change characteristics of the auction design within three minutes after the last piece of that auction relevant information became first known to some automatic process in the world, which may not be part of the auction process.

When up-dating the bidding format, one could make exceptions for active bids that were submitted for an old bidding format, and allow them to be active even if one or more such bids may violate the new bidding format. Alternatively, active orders violating the new bidding format could be cancelled or adjusted to match the new updated bidding format.

Sometimes, an auctioneer may be able to predict how bidding behaviour will change during a period. A wholesale electricity market is one such example, where demand and the price vary fairly predictable during the day. In such cases up-dating of the auction format can be predetermined before a dynamic auction or a sequence of auctions start.

U.S. Pat. No. 8,489,493 by Nager discusses up-dating of exchange rules, but his patent focuses on exchanges switching between order-driven, quote-driven and hybrid markets.

### Alternative Embodiments for Combinatorial Auctions

Aspects of our invention can also be applied to combinatorial auctions with heterogeneous goods. Recall that an item could represent a particular mix of goods. For each type of mix with the same percentage of each good we can define a unique item, which quantity has been normalized to one. The simplest embodiment for combinatorial auctions is essentially the same as for homogeneous goods, i.e. to clear each type of item independently. There are also more complicated embodiments, but first it is helpful to give a more precise definition of what we mean with a permissible price, a permissible quantity and price/quantity increments in a combinatorial auction.

A unit price that is allowed as a bid price for an item in one or more bidding rounds is referred to as a permissible price. Permissible unit prices can be explicitly stated in the bidding format of an auction. But permissible unit prices for an item can also be defined implicitly by total prices that are allowed for a group of goods. Permissible prices could be defined for average unit prices for a group of heterogeneous goods or more generally as a weighted average price, similar to a price index, for a group of heterogeneous goods. The weights may depend on characteristics of a good, such as the number of eligibility points. The weights may change between auctions or during a dynamic auction, for example with respect to preferences revealed by bidders. This could be regarded as an update of the bidding format as discussed in the previous section. A bidding format could also state permissible price levels for unit prices that have been normalized or transformed with respect to the quality and/or other characteristics of an item. Such normalizations and transformations of prices in auctions are for example discussed in U.S. Pat. No. 7,792,723 by Molloy and U.S. Pat. No. 7,010,511 by Kinney et al. Permissible prices could apply to a bid price of a bidder, flexible bid information (including contingent bids), proxy bids.

When discussing permissible quantities, we primarily think of permissible bid quantities of price-quantity pairs in transaction schedules or bids (e.g. orders to an exchange) that have been transformed into an equivalent transaction schedule. However, we do not rule out that permissible quantities could also apply to quantity increments, e.g. in limit orders. A quantity could be the number of units or share of an item. More generally, permissible quantities could apply to a weighted number of units of heterogeneous goods, similar to a quantity index, where the weight of a good could depend on its characteristics, such as its eligibility points. The weights may change between auctions or during a dynamic auction, for example with respect to preferences revealed by bidders. This could be regarded as an update of the bidding format. The auction could use the same weights in the quantity index as in an activity rule (see background on bidding format), which tries to ensure that bids are monotonic. Permissible quantities could apply to a bid quantity in a transaction schedule, a bid quantity in an equivalent transaction schedule that has been computed from other bid information, a quantity increment, a bid quantity or quantity increment in flexible bid information (including contingent bids), a bid quantity or quantity increment in proxy bids.

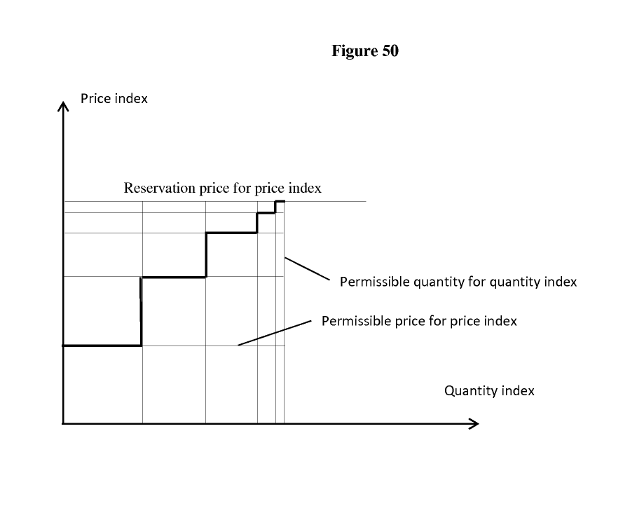

The bid shaping and rationing aspects of our invention can also be applied to a group of heterogenous goods, for which the bids have been aggregated into a price and/or a quantity index, or something similar. FIG. 50 illustrates one embodiment where bid restrictions have been applied to a price and quantity index. The bidding format could also force bidders to submit the same bid curve for similar but slightly different items. Some electricity markets for example require bidders to submit the same bid curve for every hour of the same day. Similar to the Australian electricity market, the bidding format could also force bidders to use the same bid prices, but perhaps different bid quantities, for similar but slightly different items.

We do not rule out that the rationing rule, permissible prices and permissible quantities can be different for different bidders. It could for example be beneficial to have different bidding formats and rationing rules for sellers and buyers. The bidding format could also depend on characteristics of a bidder, such as its bidding history, its financial constraints, terms of payment etc.

Each type of item could have its individual marginal price. The marginal price could also correspond to a price index for marginal units of different types of items or be a weighted average of marginal prices for different types of items. Similarly, each type of item may have its individual marginal quantity increment. But the marginal quantity increment (in aggregate or per bidder) could also be an increment in a quantity index for marginal units of different items or a weighted average for marginal quantity increments for different items. Our new embodiments for rationing rules with disproportionate rationing, rationing of aggregated transacted quantities etc. and our bidding format embodiments that we have discussed earlier could also be applied to such definitions of marginal prices and marginal quantity increments.

Embodiments with Automatic Dispatch

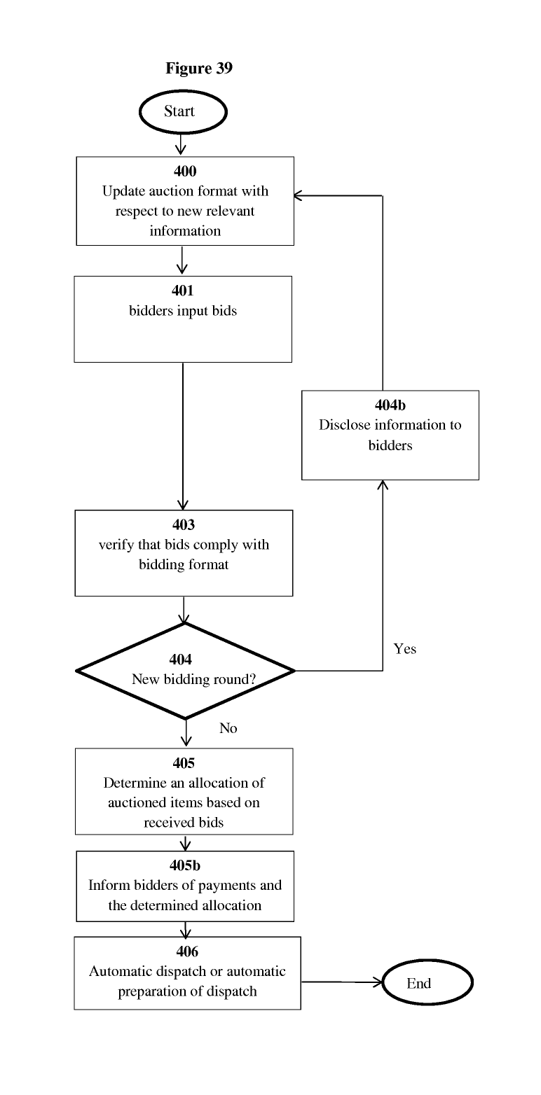

As illustrated by the flow chart in step 406 in FIG. 39, the determined allocation could be automatically dispatched or prepared for dispatch or delivery by the auction process, perhaps in cooperation with one or more automatic processes, dispatch clients. Similar automatic dispatch steps could be added in our other flow charts of an auction process at a point where the auction process has calculated an allocation for submitted bids. Examples of automatic dispatches in real-time are: automatic dispatch orders sent at the end of an auction to electricity consumers, electricity generators or network operators of an electric power network; automatic dispatch orders sent to network operators and clients in telecommunication systems; automatic dispatch orders sent to vehicles, such as airplanes, cars, trucks, trains, boats, taxis etc., in a traffic network; automatic orders to prepare auctioned items for delivery and/or to deliver such items. Delivery and preparation for delivery could for example involve automatic collection of items from a storehouse, automatic packaging of items, automatic mail processing, including automatic printing of delivery addresses for packages and letters.

### Computer Implementation

The auction process can be implemented on an auction computer system. In a preferred embodiment of the auction computer system, each bidder interacts with a bidder computer and the auctioneer interacts with an auctioneer computer. Preferably each bidder interacts with its own bidder computer, but some bidders may share the same bidder computer. Normally a bidder computer would be a single computer, but in the general case it could be a system of computers, such as a computer cluster or a grid of computers. Similarly, an auctioneer computer would normally be a single computer, but generally it could be a system of computers. The auctioneer computer is optional. Some embodiments of the auction computer system do not have an auctioneer computer. The clearing process, a subprocess of the auction process, is implemented on an auction computer, which could be a single computer or a system of computers. The auction computer system may also have an optional support computer, where parts of the auction process could be implemented. The support computer could be a single computer or a system of computers. Parts of the auction process could also be implemented on the bidder computer(s) and the optional auctioneer computer. For example, there could be advantages with implementing a bidder client (process) on a bidder computer. An optional auctioneer client (process) could be implemented on the optional auctioneer computer. In exemplary embodiments, most parts of the auction server (process), in addition to the clearing process, would be implemented on the auction computer. In some embodiments the whole auction process could be implemented on the auction computer.

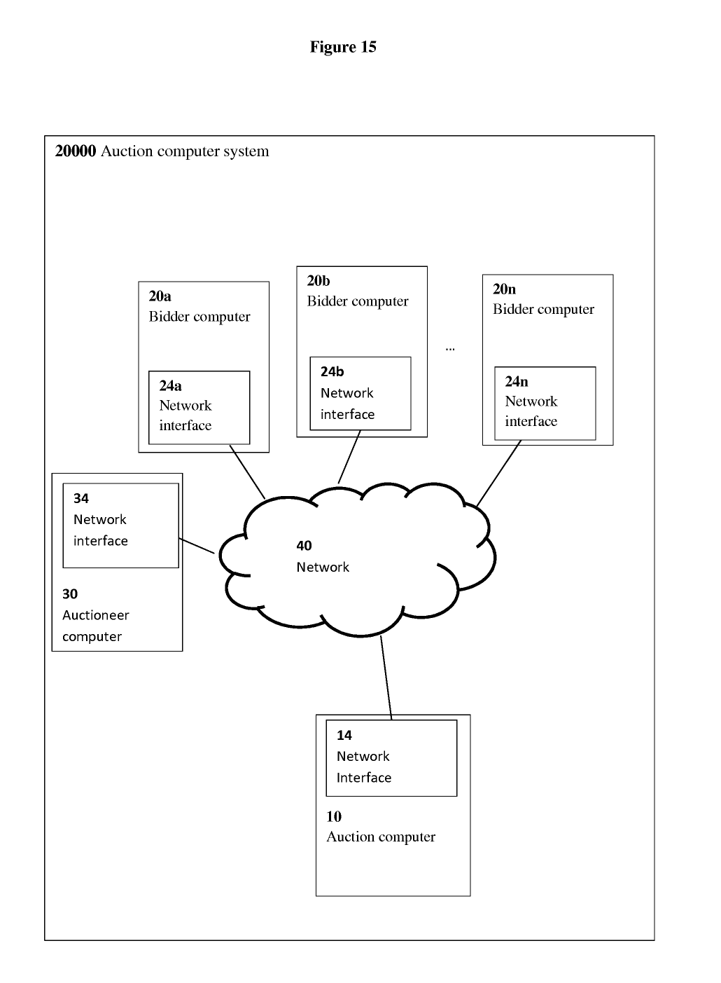

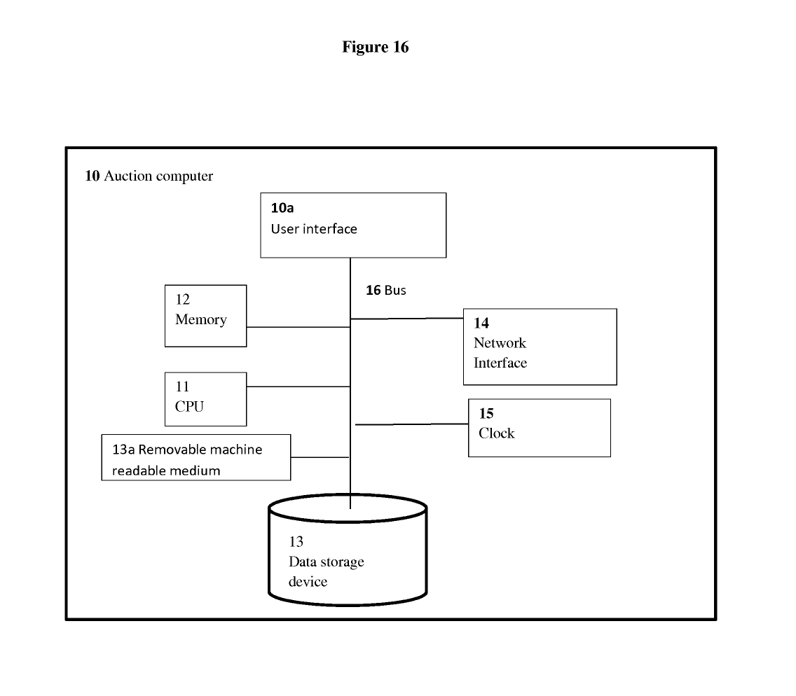

The auction computer, the bidder computer(s), the optional auctioneer computer, and the optional support computer can communicate through a network. Our preferred embodiment of the auction computer system would not have a support computer. FIG. 15 presents a preferred embodiment of an auction computer system where an auction computer 10 and bidder computers (20a-20n) and the auctioneer computer 30—are located in different nodes of the network 40. As shown in FIG. 15, the auction computer, bidder computers and the auctioneer computer are connected to the network 40 via network interfaces 14, 24a-24n and 34, respectively. Thus the auction computer, bidder computers and auctioneer computer can communicate through the network 40. In other embodiments, one or more bidder computers could be in the same node. In some special cases, one or more bidder computers may be in the same node as the auction computer. In an alternative embodiment, the auctioneer uses the user-interface 10a in FIG. 16, which is connected directly to the auction computer 10, to communicate with the auction computer. Such an alternative embodiment may not have a separate auctioneer computer. In an alternative embodiment, the auction computer could be situated in different nodes in case it is a system of computers. Similarly, a bidder computer could be situated in a plurality of nodes. This could be advantageous if there is a team working for the same bidder and/or if a bidder is a corporation with several employees that are authorized to submit bids in the name of the corporation. In such cases, it could also be advantageous to let a plurality of bidder clients manage the same bidder. Similarly, an auctioneer may have several employees or representatives that help with the operation of the auction from different computers, which could be located in different nodes of the network. Thus an auctioneer computer could also be a system of computers, where individual computers could be situated in a plurality of nodes.

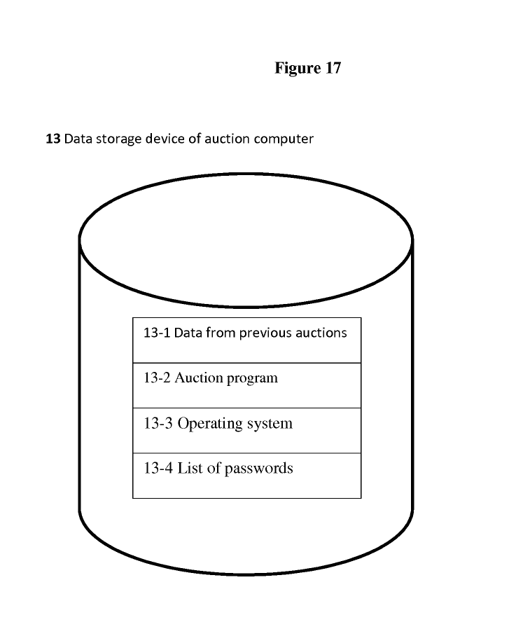

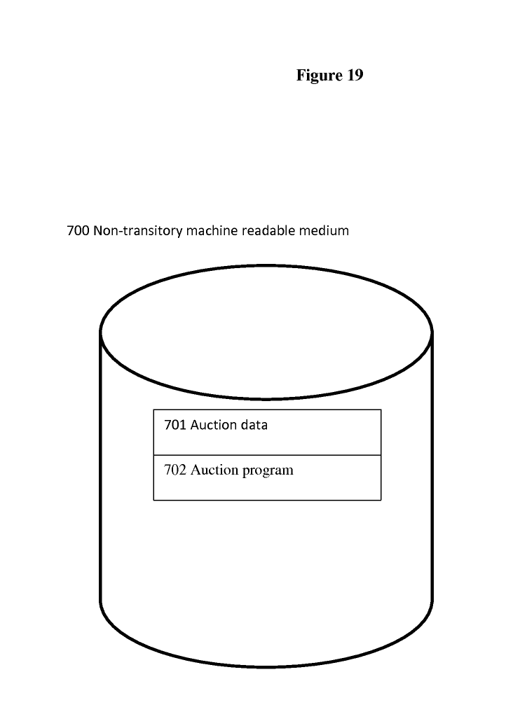

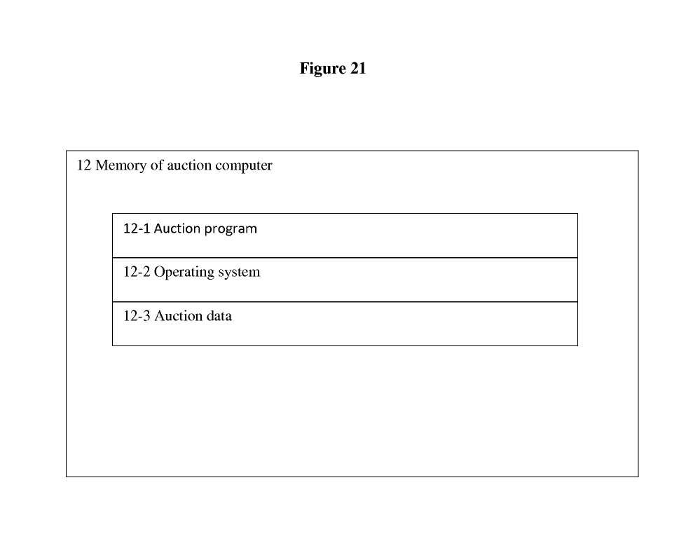

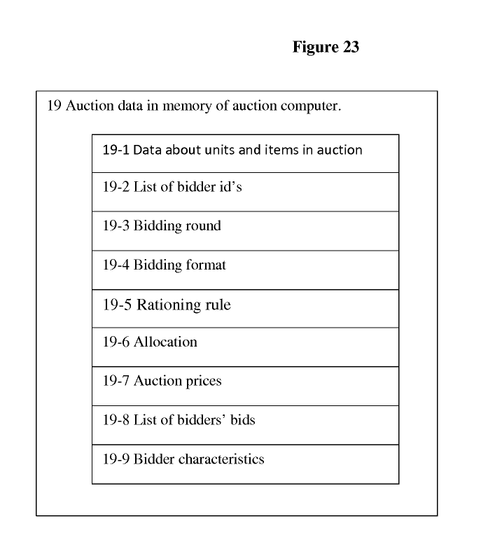

FIG. 16 shows an embodiment of an auction computer 10. In this particular embodiment the auction computer is a single computer comprising the following computer components: one central processing unit (CPU) 11, one system clock 15, one (non-transitory) memory 12, one network interface 14, one (non-transitory) data storage device 13, and one bus 16 that transfers data between components inside the auction computer. In addition, the auction computer may also have an optional user interface 10a and the auction computer may be connected to an optional non-transitory, removable machine readable medium 13a. As shown in FIG. 17, the exemplified data storage device 13 can, among other things, store data from previous auctions 13-1, an operating system 13-3, a list of bidders' passwords 13-4, and an auction program 13-2. As shown in FIG. 19, the auction program 702 and all or part of the auction data 701 can also be stored on a non-transitory, machine readable medium 700. The machine readable medium could for example correspond to Memory 12 in FIG. 16, or the medium could be removable and may correspond to the Removable machine readable medium 13a in FIG. 16. The CPU 11 of the auction computer 10, as exemplified in FIG. 16, is normally ready to run a clearing process (perhaps also auction server process or auction process) when the operating system (13-3 in FIG. 17), the auction program (13-2 in FIG. 17) and auction data (19 in FIG. 23)—such as bidder id's 19-2, bidding format 19-4, rationing rule 19-5, bidder characteristics 19-9 (such as historic bids, financial constraints, transaction constraints, VIP status and measured size of bidder), and data about items and units in the auction 19-1—are fully or partly uploaded in the memory (12 in FIG. 16). A memory with these contents is shown in FIG. 21. In an exchange, the list of bidder's bids 19-8 in FIG. 23 could correspond to the order book with open bids.

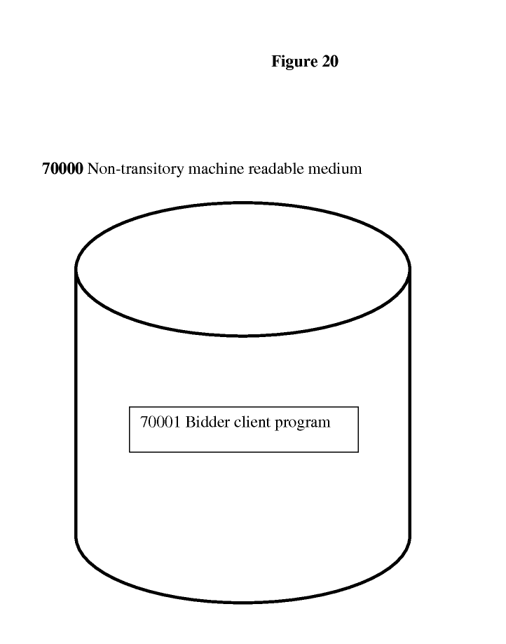

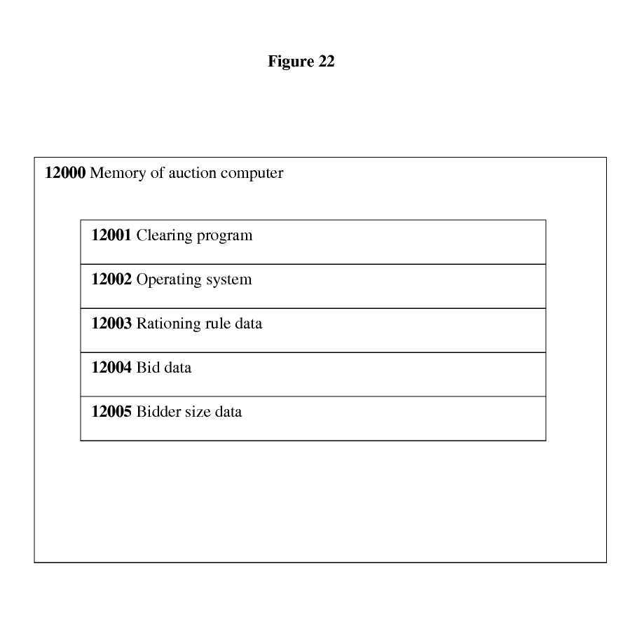

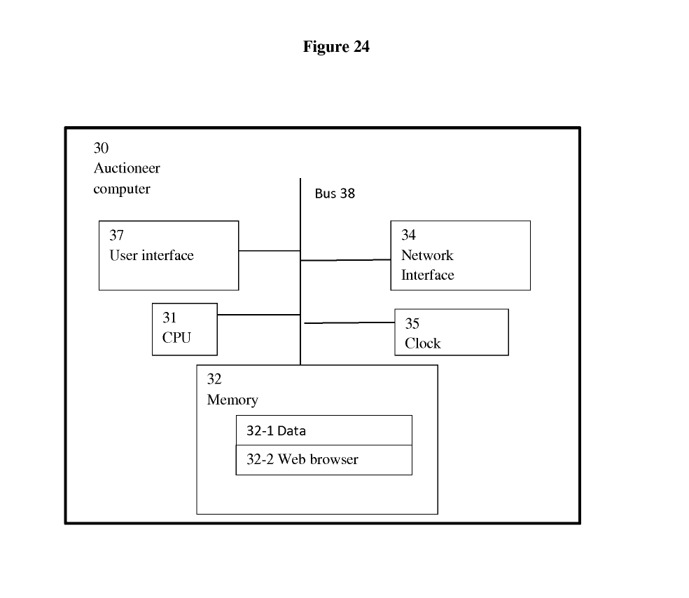

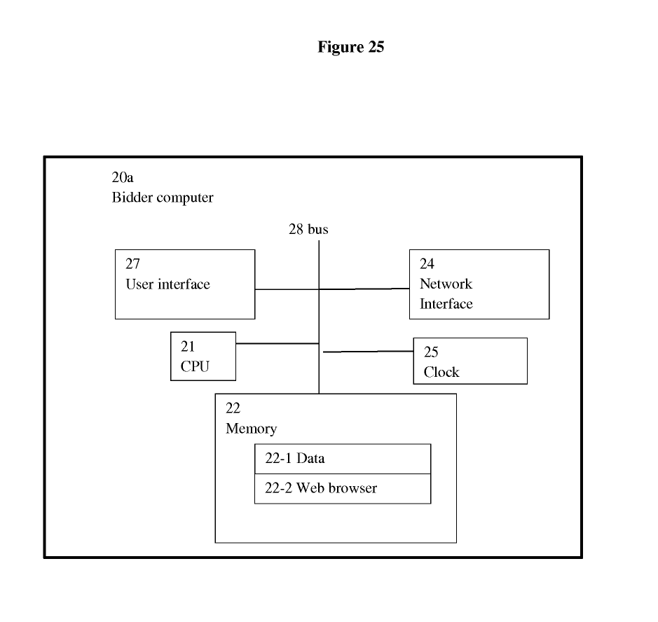

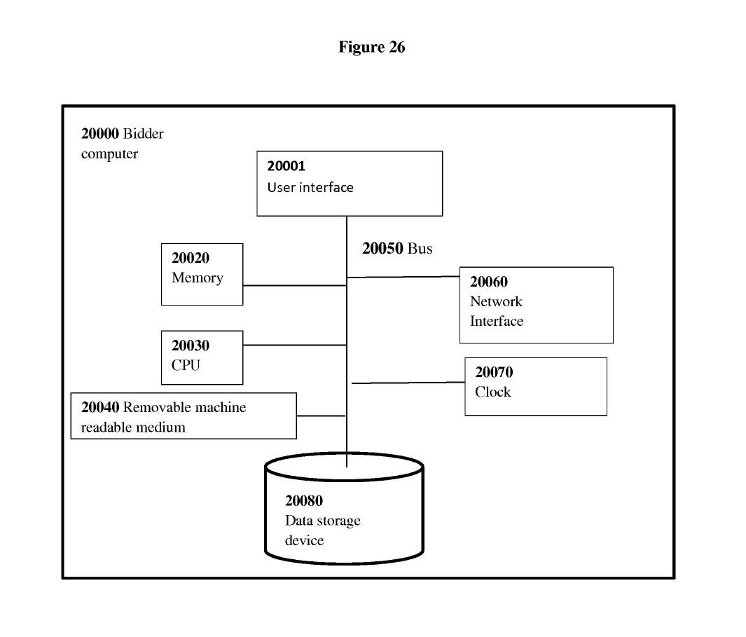

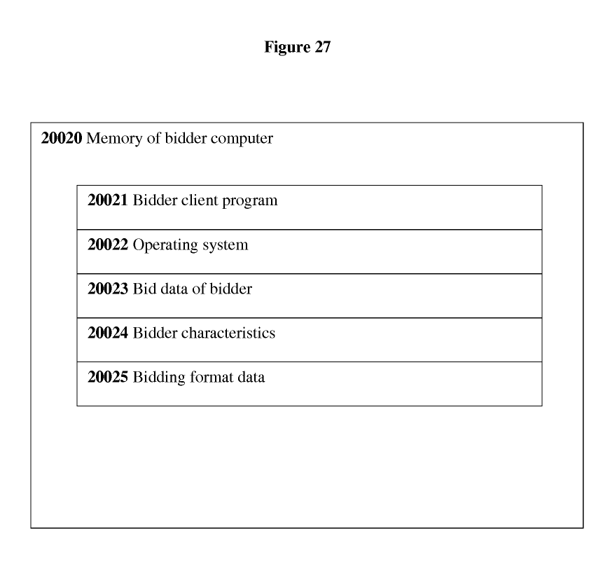

Computers could be of many different types. In FIG. 24 and FIG. 25, the auctioneer computer and bidder computer are thin clients; they have data and a web browser (for example, Internet Explorer or Netscape) in the (non-transitory) memory (such as 32 in FIGS. 24 and 22 in FIG. 25). With such an embodiment all or most of the auction process would be implemented on the auction computer and/or support computer. FIG. 26 presents an embodiment of a more advanced bidder computer with more computer components. In a preferred embodiment the bidder computer is used by one bidder. FIG. 27 presents the memory 20020 of the more advanced bidder computer for an embodiment where a bidder client has been implemented on the bidder computer. The memory for example stores bid data of that bidder 20023 and bidder characteristics 20024 of that bidder. In some embodiments bid data would include flexible bid information. Bidder characteristics could for example include the following: VIP or membership status of the bidder, password of the bidder, financial constraints of the bidder and a measure of the size of the bidder. In the considered embodiment, The memory 20020 has also stored Bidding format data 20025, so that the bidder computer can verify that bids submitted by the bidder satisfy the bidding format. In FIG. 27, an operating system 20022 and a Bidder client program 20021 are fully or partly uploaded in the memory 20020. Thus, the CPU 20030 of the bidder computer 20000, as exemplified in FIG. 26, is ready to run a bidder client (process). As shown in FIG. 20, the bidder client program 70001 can also be stored on a non-transitory, machine readable medium 70000. The machine readable medium could be removable and may correspond to the Removable machine readable medium 20040 in FIG. 26.

With a computer we mean any general purpose device that can be programmed to carry out a set of arithmetic or logical operations. It could for example be a personal computer (portable or stationary), a work station, a desktop, a laptop, a mainframe computer, a supercomputer, a smart phone, a tablet, a terminal, a parallel computer, a quantum computer, a computerized wristwatch or other wearable computers. A computer could be embedded in a machine and it may not have a user interface. The architecture of a computer is not restricted to the schematic architecture in FIG. 16 or other of our presented embodiments. Often computers have multiple CPUs or processing elements, and some or all of them may run in parallel. We use the term CPU system to represent one or more CPUs. In the future some processors in a CPU system could be quantum processors. Generally, a CPU system can be defined as being any hardware that automatically carries out instructions by performing basic arithmetical, logical, and input/output operations. A CPU system could include an integrated circuit (IC), an application-specific integrated circuit (ASIC) or a field-programmable gate array (FPGA). A CPU system could also include neural processors that can learn on their own once they are programmed. With terminal we mean an electronic or electromechanical hardware device that is used for entering data into, and outputting data from, a computing system.

Computers often have several types of memories. With memory we mean any non-transitory, physical device used to store programs (sequences of instructions) or data (e.g. program state information) on a temporary or permanent basis that can interact with a computer, and any combination of such non-transitory, physical devices. The memory could be volatile, i.e. require battery or some other energy source to maintain the stored information, or be non-volatile. Examples of volatile memories that can be used in computers are Static RAM (SRAM), dynamic RAM (DRAM), Z_RAM, TTRAM, A-RAM and ETA RAM. Examples of non-volatile memories include read-only memory (ROM), PROM, EPROM, EEPROM, flash memory, magnetic storage devices (e.g. hard disks, floppy discs and magnetic tape), optical discs, paper tape and punched cards, FeRAM, CBRAM, PRAM, SONOS, RRAM, Racetrack memory, NRAM and Millipede. It is not necessary for our invention, but computers often use a relatively small fast and expensive memory close to the CPU and a slower but larger and cheaper storage farther away from the CPU. The data storage device in FIG. 16 would normally represent the latter type of memory, which is often slower and larger. It could for example be a tape, magnetic disks, flash memory and optical discs (CD-ROM and DVD-ROM). With a non-transitory machine-readable medium we mean any non-transitory memory, including non-transitory data storage devices, and any combination of such memories.

With user interface we broadly speaking mean a system of hardware and/or software that the computer uses to present information (such as graphic, text and sound) to a human operator and to register control sequences (such as keystrokes with the computer keyboard, movements of the computer mouse or other cursor controls, selections with a touchscreen, voice commands, eye movements, gestures) that the user employs to control the program. However, bidders will not necessarily input bids through a user interface. In some cases, bidders may let a computer prepare and submit their bids automatically, perhaps with some human oversight. Bids could be automatically submitted from machines. U.S. Pat. No. 8,335,738 by Ausubel et al. and U.S. Pat. No. 5,394,324 by Clearwater for example discuss an air-conditioning system, where individual offices in the building automatically send bids requesting cooling services based on current reading of the thermostat and desired temperature in the office etc. In our preferred embodiment of the invention, the auctioneer has access to the server when the auction is running, but one can think of embodiments where this would not be necessary for the normal operation of the auction.

The (computer) network is a communications system that allows computers to exchange data. The connections (network links) between nodes in the network are normally established using either cable media (such as electrical cables or optical fibers), wireless media (such as terrestrial microwaves, communication satellites, cellular systems, radio and spread spectrum technologies, infrared communication) or combinations of such technologies. There are many different communication protocols that can be used in a network. Examples are: Ethernet, token-ring, Internet Protocol Suite, Virtual Private Network (VPN), Digital Subscriber Line (DSL), Plain Old Telephone Service (POTS), Integrated Services Digital Network (ISDN), Synchronous optical networking (SONET), Synchronous Digital Hierarchy (SDH), Asynchronous Transfer Mode (ATM), cellular data communication protocols, electronic mail or a facsimile system. The same network can use different protocols in parallel or in different parts of the network. The network can be classified as a local area network or wide area network, or different parts of the network can be local areas or wide areas. Ideally the communication between a bidder and the auction server would be secure, and the communication could be partly encrypted.

With a network interface we mean the system of software and/or hardware that is used to connect a computer to a computer network. A computer sometimes has multiple ways of connecting to the network, such as one type of interface to cable media and one or more types of interfaces to wireless media. In our specification we let the network interface of a computer be an aggregated interface that represents all the ways the computer can be connected to the network.

### DEFINITIONS AND CONVENTIONS

We use the definitions and conventions below when describing aspects of our invention in our claims.

The lists that we mention in the definitions below could for example be lists of permissible prices, permissible quantities, bid prices or bid quantities. In case of an exchange or double auction, we use the convention that there is a separate list for each side of the auction, e.g. one list of permissible prices for bid prices from sellers and another for bid prices from buyers. Lists for the two sides could still be identical, so we do not rule out that sell and buy bids have identical permissible prices. Similarly, in case the same bidder would submit bids (e.g. transaction schedules or limit orders) both as a buyer and seller, then we sort them into one supply schedule or list with sell bids and one demand schedule or list with buy bids.

DEFINITION: A subsequence of a list means a new list that has been derived from the original list by deleting some of its elements without changing the order of the remaining elements.

DEFINITION: A substring of a list means a new list that is a consecutive part of the original list.

DEFINITION: A list with numbers is getting denser if it has at least four elements and it is the case that the absolute difference between two neighboring numbers is always strictly smaller than the absolute difference between two neighboring numbers earlier in the list.

DEFINITION: A list of numbers is partly getting denser if the list has a substring that is getting denser.

We can replace ‘denser’ with ‘sparser’ in the definitions above, to make the corresponding definitions for sparser.

We use the convention that a list of permissible prices or a bidder's list of bid prices are sorted, in reverse order, with respect to the distance to the reservation price, such that the price last in said list is closest to said reservation price. Thus a list of bid prices from a seller are in ascending order, while a list of bid prices from a buyer are in descending order.

We use the convention that a list of permissible quantities and a bidder's list of bid quantities are sorted in ascending order.

Also note that the claims primarily describe the innovative parts of the auction. Bidder Q could be one of many bidders, and in the general case the other bidders could have another bidding format or rationing rules. There could also be additional items in the auction, in addition to the items that the claims discuss, and they may have another bidding format or rationing rules. The auction may have multiple bidding rounds, and the claims may only apply to a subset of them.

DEFINITION: We say that the permissible price levels are used to enhance auction performance in at least one way if at least one of the following statements is true for at least one item:
1) Tick sizes are automatically updated with respect to auction relevant information and at least one tick-size is not administratively motivated in a bidding round where bidders explicitly choose bid prices.
2) Tick sizes are automatically updated with respect to auction relevant information and tick-sizes are non-constant in a multi-bid round.
3) The auction trades multiple units and at least one tick-size is not administratively motivated in a bidding round where bidders explicitly choose bid prices.
4) The list of permissible prices is partly getting sparser in a multi-bid round.
5) The list of permissible prices is partly getting denser in a multi-bid round.
6) Permissible prices are automatically updated with respect to external auction relevant information.
7) Tick sizes are automatically updated with respect to non-bid characteristics of bidders.
8) Permissible prices are updated with short notice with respect to auction relevant information in a multi-bid round.
9) Ex-ante, before a time period shorter than a week starts, permissible prices of an auction have been set to change at least twice during said time period for bidding rounds where bidders explicitly choose bid prices.

DEFINITION: We say that the permissible price levels are used to enhance auction performance in at least two ways if at least two of the nine statements just above are true for at least one item. We can make similar definitions for three, four and five ways etc.

DEFINITION: We say that the permissible quantity levels are used to enhance auction performance in at least one way if at least one of the following statements is true for at least one item:
1) At least one lot size is not administratively motivated.
2) The list of permissible quantities is partly getting sparser.
3) The list of permissible quantities is partly getting denser.
4) Permissible quantities are automatically updated with respect to auction relevant information with short notice.
5) Permissible quantities are automatically updated with respect to external auction relevant information.
6) Permissible quantities are automatically updated with respect to non-bid characteristics of bidders.
7) Ex-ante, before a time period shorter than a week starts, permissible quantities of an auction have been set to change at least twice during said time period.

DEFINITION: We say that the permissible quantity levels are used to enhance auction performance in at least two ways if at least two of the seven statements just above are true for at least one item. We can make similar definitions for three, four and five ways etc.

DEFINITION: We say that non-conventional bid restrictions are used to enhance auction performance if the bidding format restricts the combinations of bid prices and bid quantities that are permissible in a multi-bid round for at least one item.

DEFINITION: We say that the bidding format is used to enhance performance of an auction in at least one way if at least one of the following is true for at least one item:
1) The permissible price levels of said auction are used to enhance auction performance in at least one way.
2) The permissible quantity levels of said auction are used to enhance auction performance in at least one way.
3) Non-conventional bid restrictions are used to enhance auction performance.

DEFINITION: We say that a rationing rule is used to enhance auction performance in at least one way if at least one of the following statements is true for at least one item and at least one side of the auction:
1) Rationing is disproportionate on the margin and marginal bids are accepted monotonically.
2) Rationing is disproportionate on the margin and marginal bids are rejected monotonically.
3) The rationing rule favours small marginal quantity increments of a bidder in an ascending bid auction with at least one of the following three properties: bidders explicitly choose bid prices, the ascending bid auction has a non-truthtelling mechanism, the ascending bid auction has an activity rule.
4) The rationing rule is proven to depend on the marginal price.
5) The rationing rule depends on the marginal price.
6) The aggregated transacted quantity that is chosen by the rationing rule is proven to depend on the marginal price.
7) The rationing rule balances liquidity and competition aspects.
8) Ex-ante, before a time period shorter than a week starts, the rationing rule has been set to change at least twice during said time period.
9) The rationing rule is automatically updated with respect to external auction relevant information.
10) The rationing rule is automatically updated with respect to at least one bid that is no longer active.
11) The rationing rule is automatically updated with respect to the number of bidders that are active in the auction, the number of bidders that has registered for the auction, and/or with respect to predictions of how competitive bidding in the auction will be.
12) The rationing rule is disproportionate and it has been normalized with respect to the size of some bidder at some price.
13) The marginal excess quantity of a bidder is normalized with respect to the size of said bidder in the rationing procedure at some price.
14) Bidders' shares of the total volume of marginal bids accepted/rejected depend on the size of at least one bidder.

DEFINITION: We say that the rationing rule is used to enhance auction performance in at least two ways if at least two of the fourteen statements just above are true for at least one item and at least one side of the auction. We can make similar definitions for three, four, five, six etc. ways.

DEFINITION: We say that characteristics of the auction design are used to enhance auction performance in at least one way if at least one of the following is true for at least one item:
1) The rationing rule of said auction design is used to enhance auction performance in at least one way.
2) The bidding format of said auction design is used to enhance auction performance in at least one way.

The several examples described herein are exemplary of the invention, whose scope is not limited thereby but rather is indicated in the attached claims.

1. A method for enabling a bidder to participate in an auction, where characteristics of the auction enhance auction performance in at least one way, said method implemented in an auction computer system comprising:
i) an auction computer
ii) a bidder computer
iii) a computer network connecting said auction computer and bidder computer, said method comprising
a) receiving bids at said bidder computers such that it is possible for said bidder to enter at least one bid for at least one item in one or more bidding rounds.
b) communicating said at least one bid to said auction computer via said computer network
c) clearing the auction in a process to determine an allocation for said at least one item, such that said at least one bid is considered in the clearing process.

2. A method as recited in claim 1, further including verifying that said at least one bid comply with a bidding format.

3. A method as recited in claim 2, wherein said auction is a multi-unit auction.

4. A method as recited in claim 3, wherein said multi-unit auction has at least one multi-bid round.

5. A method as recited in claim 4, wherein the clearing the auction includes a rationing rule and wherein the rationing rule of said clearing the auction is used to enhance auction performance in at least two ways.

6. A method as recited in claim 2, wherein said bidding format is used to enhance performance of an auction in at least one way and wherein the clearing the auction includes a rationing rule and wherein the rationing rule of said clearing the auction is used to enhance auction performance in at least one way.

7. A machine useful for clearing an auction, comprising:
i) a network interface receiving bid data and submitting information about a determined auction clearing outcome from said machine;
ii) a memory storing one or more sequences of instructions for a clearing process to determine an auction clearing outcome for received bid data, such that the clearing process uses a rationing rule that enhances auction performance in at least one way;
iii) a CPU for executing instructions stored in said memory; and
iv) a bus to transfer information between said network interface, said memory and said CPU.

8. A machine as recited in claim 7, wherein said rationing rule is used to enhance auction performance in at least three ways.

9. A machine as recited in claim 7, wherein said rationing rule is proven to depend on the marginal price.

10. A machine as recited in claim 7, wherein said rationing rule is disproportionate and it has been normalized with respect to the size of some bidder at some price p0.

11. A machine as recited in claim 7, wherein said rationing rule is automatically updated with respect to auction relevant information with short-notice.

12. A machine as recited in claim 11, wherein said rationing rule is automatically updated with respect to external auction data.

13. A machine as recited in claim 7, wherein said rationing rule is such that bidders' shares of the volume of marginal bids accepted/rejected by the auction depends on the size of a bidder.

14. A non-transitory machine readable medium storing one or more sequences of instructions which, when executed in a computer system, comprising of
i) an auction computer,
ii) a bidder computer, and
iii) a computer network connecting said auction computer and bidder computer, implements a bidder client process, said bidder client process comprising:
a) receiving bids, such that it is possible for a bidder to enter at least one bid for at least one item from a bidder computer;
b) verifying that said at least one bid satisfies a bidding format, which is used to enhance auction performance in at least one way; and
c) providing said at least one bid to said auction computer via said computer network.

15. A non-transitory machine readable medium as recited in claim 14, wherein permissible price levels of said bidding format are used to enhance auction performance in at least one way.

16. A non-transitory machine readable medium as recited in claim 14, wherein permissible price levels of said bidding format are used to enhance auction performance in at least two ways.

17. A non-transitory machine readable medium as recited in claim 14, wherein permissible price levels of said bidding format are used to enhance auction performance in at least four ways.

18. A non-transitory machine readable medium as recited in claim 14, wherein permissible quantity levels of said bidding format are used to enhance auction performance in at least one way.

19. A non-transitory machine readable medium as recited in claim 14, wherein permissible quantity levels of said bidding format are used to enhance auction performance in at least three ways.

20. A non-transitory machine readable medium as recited in claim 14, wherein non-conventional bid restrictions are used to enhance auction performance.
